(19) United States
(12) Patent Application Publication
(10) Pub. No.: US 2025/0150770 A1
(43) Pub. Date: May 8, 2025

(54) INFORMATION GENERATION METHOD, ACOUSTIC SIGNAL PROCESSING METHOD, RECORDING MEDIUM, AND INFORMATION GENERATION DEVICE

(71) Applicant: Panasonic Intellectual Property Corporation of America, Torrance, CA (US)

(72) Inventors: Hikaru USAMI, Osaka (JP); Tomokazu Ishikawa, Osaka (JP); Seigo Enomoto, Kyoto (JP); Kota Nakahashi, Osaka (JP); Hiroyuki Ehara, Kanagawa (JP); Mariko Yamada, Hyogo (JP); Shuji Miyasaka, Osaka (JP)

(21) Appl. No.: 19/016,689

(22) Filed: Jan. 10, 2025

Related U.S. Application Data
(63) Continuation of application No. 19/013,465, filed on Jan. 8, 2025.
Application No. 19/013,465 is a continuation of application No. PCT/JP2023/025120, filed on Jul. 6, 2023.
(60) Provisional application No. 63/459,335, filed on Apr. 14, 2023.
(60) Provisional application No. 63/457,495, filed on Apr. 6, 2023.
(60) Provisional application No. 63/417,389, filed on Oct. 19, 2022.
(60) Provisional application No. 63/417,397, filed on Oct. 19, 2022.
(60) Provisional application No. 63/388,740, filed on Jul. 13, 2022.

(51) Int. Cl. H04S 7/00

(52) U.S. Cl. CPC H04S 7/302

(57) ABSTRACT

An information generation method includes: obtaining a second wind direction of a second wind blowing in a virtual space and a second assumed wind speed which is a speed of the second wind; generating fifth object audio information in which the obtained second wind direction and second assumed wind speed are associated; storing aerodynamic sound core information including a representative wind speed and aerodynamic sound data indicating aerodynamic sound generated by wind blowing at the representative wind speed reaching an ear of a listener in the virtual space; and outputting the generated fifth object audio information and the stored aerodynamic sound core information.

### CROSS REFERENCE TO RELATED APPLICATIONS

This is a continuation of U.S. application Ser. No. 19/013,465, filed Jan. 8, 2025, which is a continuation application of PCT International Application No. PCT/JP2023/025120 filed on Jul. 6, 2023, designating the United States of America, which is based on and claims priority of U.S. Provisional Patent Application No. 63/388,740 filed on Jul. 13, 2022, U.S. Provisional Patent Application No. 63/417,389 filed on Oct. 19, 2022, U.S. Provisional Patent Application No. 63/417,397 filed on Oct. 19, 2022, U.S. Provisional Patent Application No. 63/457,495 filed on Apr. 6, 2023, and U.S. Provisional Patent Application No. 63/459,335 filed on Apr. 14, 2023. The entire disclosures of the above-identified applications, including the specifications, drawings, and claims are incorporated herein by reference in their entirety.

### FIELD

The present disclosure relates to an acoustic signal processing method, etc.

### BACKGROUND

Patent Literature (PTL) 1 discloses a technique related to a three-dimensional acoustic calculation method that is an acoustic signal processing method. In this acoustic signal processing method, the loudness (sound pressure) is controlled so as to change inversely proportional to the distance between the sound source and the listener (observer).

### CITATION LIST

### Patent Literature

PTL 1: Japanese Unexamined Patent Application Publication No. 2013-201577
PTL 2: International Patent Application Publication No.

2021/180938

### Non Patent Literature

NPL 1: Akiyoshi Iida, Physics of Aerodynamic Noise 4 Pseudo Sound Waves and Far Field [online], [retrieved on Jun. 21, 2023], Internet (URL: https://fluid.mech.kogakuin.ac.jp/˜iida/Lectures/master/aeroacoustic.pdf)
NPL 2: The Society of Heating, Air-Conditioning and Sanitary Engineers of Japan, Practical Knowledge for Planning and Designing Air Conditioning Systems (4th Revised Edition), Ohmsha, Ltd., Mar. 24, 2017, p 236
NPL 3: Yoshinori Dobashi, et al., Real-time rendering of aerodynamic sound using sound textures based on computational fluid dynamics, ACM Transactions on Graphics, Vol. 22, No. 3, p 732-740

### SUMMARY

### Technical Problem

With the technique disclosed in PTL 1, it may be difficult to provide a sense of realism to the listener.

In view of this, the present disclosure has an object to provide, for instance, an acoustic signal processing method capable of providing a listener with a sense of realism.

### Solution to Problem

An acoustic signal processing method according to one aspect of the present disclosure includes: obtaining object information and second position information, the object information including first position information indicating a position of an object in a virtual space, first sound data indicating a first sound caused by the object, and first identification information indicating a processing method for the first sound data, the second position information indicating a position of a listener of the first sound in the virtual space; calculating a distance between the object and the listener based on the first position information included in the object information obtained and the second position information obtained; determining, based on the first identification information included in the object information obtained, a processing method among a first processing method and a second processing method to use to process the first sound data, the first processing method for processing a loudness according to the distance calculated, the second processing method for processing the loudness according to the distance calculated in a manner different from the first processing method; processing the first sound data using the processing method determined; and outputting the first sound data processed.

An information generation method according to one aspect of the present disclosure includes: obtaining first sound data and first position information, the first sound data indicating a first sound generated at a position related to a position of a listener in a virtual space, the first position information indicating a position of an object in the virtual space; and generating, from the first sound data obtained and the first position information obtained, first object audio information including (i) information related to the object that reproduces the first sound at the position related to the position of the listener due to the object, and (ii) the first position information.

An acoustic signal processing method according to one aspect of the present disclosure includes: obtaining the first object audio information generated by an information generation method described above, the first sound data obtained, and second position information indicating the position of the listener of the first sound; calculating a distance between the object and the listener based on the first position information included in the first object audio information obtained and the second position information obtained; processing the first sound data to attenuate a loudness of the first sound as the distance calculated increases; and outputting the first sound data processed.

An acoustic signal processing method according to one aspect of the present disclosure includes: obtaining the first object audio information generated by an information generation method described above, the first sound data obtained, and second position information indicating the position of the listener of the first sound; calculating a distance between the object that radiates the wind and the listener based on the first position information included in the first object audio information obtained and the second position information obtained; processing the first sound data to attenuate a loudness of the first sound as the distance calculated increases; and outputting the first sound data processed.

An acoustic signal processing method according to one aspect of the present disclosure includes: obtaining the first object audio information generated by an information generation method described above, the first sound data obtained, and second position information indicating the position of the listener of the first sound; calculating a distance between the object that radiates the wind and the listener based on the first position information included in the first object audio information obtained and the second position information obtained; when the distance calculated is greater than the unit distance indicated by the unit distance information included in the first object audio information obtained, processing the first sound data to attenuate a loudness of the first sound according to the distance calculated and the unit distance; and outputting the first sound data processed.

An acoustic signal processing method according to one aspect of the present disclosure includes: obtaining the first object audio information generated by an information generation method described above, the first sound data obtained, and second position information indicating the position of the listener of the first sound; calculating a distance between the object that radiates the wind and the listener, and a direction between two points connecting the object and the listener, based on the first position information included in the first object audio information obtained and the second position information obtained; processing the first sound data to: control a loudness of the first sound based on (i) an angle formed between the forward direction and the direction between two points calculated and (ii) the characteristic indicated by the directivity information; and when the distance calculated is greater than the unit distance indicated by the unit distance information included in the first object audio information obtained, attenuate the loudness of the first sound according to the distance calculated and the unit distance; and outputting the first sound data processed.

An acoustic signal processing method according to one aspect of the present disclosure includes: obtaining the first object audio information generated by an information generation method described above, the first sound data obtained, and second object audio information in which the first position information and second sound data indicating a second sound caused by the object are associated; processing including: not processing a first sound signal that is based on the first sound data obtained with processing to convolve a head-related transfer function that depends on a direction of arrival of sound; and processing a second sound signal that is based on the second sound data indicated by the second object audio information obtained with processing to convolve the head-related transfer function that depends on the direction of arrival of sound; and outputting the first sound signal not processed and the second sound signal processed.

An acoustic signal processing method according to one aspect of the present disclosure includes: obtaining the first object audio information generated by an information generation method described above, the first sound data obtained, and second object audio information in which the first position information and second sound data indicating a second sound caused by the object are associated; processing including: processing a first sound signal that is based on the first sound data obtained with processing dependent on a direction of arrival of wind; and processing a second sound signal that is based on the second sound data indicated by the second object audio information obtained with processing to convolve a head-related transfer function that depends on a direction of arrival of sound; and outputting the first sound signal processed and the second sound signal processed.

An acoustic signal processing method according to one aspect of the present disclosure includes: obtaining the first object audio information generated by an information generation method described above, the first sound data obtained, and third object audio information in which third position information indicating a position of an other object in the virtual space and third sound data indicating a third sound generated at the position of the other object are associated, the other object being different from the object; processing including: processing a first sound signal that is based on the first sound data obtained with processing dependent on a direction of arrival of wind; and processing a third sound signal that is based on the third sound data indicated by the third object audio information obtained with processing to convolve a head-related transfer function that depends on a direction of arrival of sound; and outputting the first sound signal processed and the third sound signal processed.

An information generation method according to one aspect of the present disclosure includes: obtaining a generation position of a first wind blowing in a virtual space, a first wind direction of the first wind, and a first assumed wind speed which is a speed of the first wind; generating fourth object audio information in which the generation position, the first wind direction, and the first assumed wind speed obtained are associated; storing aerodynamic sound core information including a representative wind speed and aerodynamic sound data indicating aerodynamic sound generated by wind blowing at the representative wind speed reaching an ear of a listener in the virtual space; and outputting the fourth object audio information generated and the aerodynamic sound core information stored.

An acoustic signal processing method according to one aspect of the present disclosure includes: obtaining the fourth object audio information and the aerodynamic sound core information output by an information generation method described above, and second position information indicating a position of the listener in the virtual space; calculating, based on the generation position included in the fourth object audio information obtained and the second position information obtained, a distance between the generation position and the listener; processing the aerodynamic sound data to attenuate a loudness of the aerodynamic sound as the distance calculated increases; and outputting the aerodynamic sound data processed.

An acoustic signal processing method according to one aspect of the present disclosure includes: obtaining the fourth object audio information and the aerodynamic sound core information output by an information generation method described above, and second position information indicating a position of the listener in the virtual space, the aerodynamic sound core information including data indicating a distribution of frequency components of the aerodynamic sound; calculating, based on the generation position included in the fourth object audio information obtained and the second position information obtained, a distance between the generation position and the listener; processing the aerodynamic sound data to shift the distribution of the frequency components of the aerodynamic sound toward lower frequencies as the distance calculated increases; and outputting the aerodynamic sound data processed.

An information generation method according to one aspect of the present disclosure includes: obtaining a second wind direction of a second wind blowing in a virtual space and a second assumed wind speed which is a speed of the second wind; generating fifth object audio information in which the second wind direction and the second assumed wind speed obtained are associated; storing aerodynamic sound core information including a representative wind speed and aerodynamic sound data indicating aerodynamic sound generated by wind blowing at the representative wind speed reaching an ear of a listener in the virtual space; and outputting the fifth object audio information generated and the aerodynamic sound core information stored.

An information generation method according to one aspect of the present disclosure includes: obtaining a generation position of a first wind blowing in a virtual space, a first wind direction of the first wind, a first assumed wind speed which is a speed of the first wind, a second wind direction of a second wind blowing in the virtual space, and a second assumed wind speed which is a speed of the second wind; generating fourth object audio information in which the generation position, the first wind direction, and the first assumed wind speed obtained are associated, and generating fifth object audio information in which the second wind direction and the second assumed wind speed obtained are associated; and outputting the fourth object audio information generated and the fifth object audio information generated.

An acoustic signal processing method according to one aspect of the present disclosure includes: obtaining second position information indicating a position of the listener in the virtual space, and the fourth object audio information or the fifth object audio information output by an information generation method described above; when the fourth object audio information is obtained, processing the aerodynamic sound data included in the aerodynamic sound core information based on the position indicated by the second position information obtained, and when the fifth object audio information is obtained, processing the aerodynamic sound data included in the aerodynamic sound core information irrespective of the position indicated by the second position information obtained; and outputting the aerodynamic sound data processed.

A recording medium according to one aspect of the present disclosure is a non-transitory computer-readable recording medium for use in a computer, the recording medium having recorded thereon a computer program for causing the computer to execute an acoustic signal processing method described above.

A recording medium according to one aspect of the present disclosure is a non-transitory computer-readable recording medium for use in a computer, the recording medium having recorded thereon computer program for causing the computer to execute an information generation method described above.

An acoustic signal processing device according to one aspect of the present disclosure includes: a first obtainer that obtains object information and second position information, the object information including first position information indicating a position of an object in a virtual space, first sound data indicating a first sound caused by the object, and first identification information indicating a processing method for the first sound data, the second position information indicating a position of a listener of the first sound in the virtual space; a first calculator that calculates a distance between the object and the listener based on the first position information included in the object information obtained and the second position information obtained; a determiner that determines, based on the first identification information included in the object information obtained, a processing method among a first processing method and a second processing method to use to process the first sound data, the first processing method for processing a loudness according to the distance calculated, the second processing method for processing the loudness according to the distance calculated in a manner different from the first processing method; a first processor that processes the first sound data using the processing method determined; and a first outputter that outputs the first sound data processed.

Note that these general or specific aspects may be implemented using a system, a device, a method, an integrated circuit, a computer program, or a non-transitory computer-readable recording medium such as a CD-ROM, or any combination thereof.

### Advantageous Effects

An acoustic signal processing method according to one aspect of the present disclosure is capable of providing a listener with a sense of realism.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram for explaining a first example of aerodynamic sound (wind noise) generated accompanying the movement (change in position) of an object.

FIG. 2 is a diagram for explaining a second example of aerodynamic sound (wind noise) generated accompanying the movement (change in position) of an object.

FIG. 3 is a diagram for explaining a third example of aerodynamic sound (wind noise) generated accompanying the movement (change in position) of an object.

FIG. 4A is for explaining aerodynamic sound generated by wind radiated from an object reaching the ears of a listener.

FIG. 4B illustrates a method for measuring the attenuation of loudness of second aerodynamic sound according to the distance from the wind source.

FIG. 4C illustrates the measurement results from the experiment described in FIG. 4B, and illustrates the frequency characteristics of the collected sound.

FIG. 4D illustrates the frequency characteristics of the second aerodynamic sound and the motor noise converted to loudness and plotted for each distance.

FIG. 5A illustrates the personal space of a listener.

FIG. 5B illustrates a three-dimensional sound (immersive audio) reproduction system as one example of a system to which the acoustic processing or decoding processing according to the present disclosure is applicable.

FIG. 5C is a functional block diagram illustrating the configuration of one example of an encoding device of the present disclosure.

FIG. 5D is a functional block diagram illustrating the configuration of one example of a decoding device of the present disclosure.

FIG. 5E is a functional block diagram illustrating the configuration of another example of an encoding device of the present disclosure.

FIG. 5F is a functional block diagram illustrating the configuration of another example of a decoding device of the present disclosure.

FIG. 5G is a functional block diagram illustrating the configuration of one example of the decoder in FIG. 5D or FIG. 5F.

FIG. 5H is a functional block diagram illustrating the configuration of another example of the decoder in FIG. 5D or FIG. 5F.

FIG. 5I illustrates one example of a physical configuration of an acoustic signal processing device.

FIG. 5J illustrates one example of a physical configuration of an encoding device.

FIG. 6 is a block diagram illustrating the functional configuration of an acoustic signal processing device according to an embodiment of the present disclosure.

FIG. 7 is a flowchart of Operation Example 1 performed by an acoustic signal processing device according to an embodiment of the present disclosure.

FIG. 8 illustrates a bat, which is an object according to Operation Example 1, and a listener.

FIG. 9 is a block diagram illustrating the functional configuration of an acoustic signal processing device according to Variation 1.

FIG. 10 illustrates four other individuals and a listener according to Variation 1.

FIG. 11 is a flowchart of Operation Example 2 performed by an acoustic signal processing device according to Variation 1.

FIG. 12 is a block diagram illustrating the functional configuration of an acoustic signal processing device according to Variation 2.

FIG. 13 illustrates an object and a plurality of sounds according to Variation 2.

FIG. 14 is a flowchart of Operation Example 3 performed by an acoustic signal processing device according to Variation 2.

FIG. 15 illustrates an example where the object according to Variation 2 is an electric fan.

FIG. 16 illustrates an example where the object according to Variation 2 is a zombie.

FIG. 17 is a block diagram illustrating the functional configurations of an information generation device and an acoustic signal processing device according to Variation 3.

FIG. 18 illustrates an electric fan, which is an object according to Variation 3, and a listener.

FIG. 19 is for illustrating directivity information and unit distance information according to Variation 3.

FIG. 20 is for illustrating processing performed by a second processor according to Variation 3.

FIG. 21 is for illustrating other processing performed by the second processor according to Variation 3.

FIG. 22 is a flowchart of Operation Example 4 performed by an information generation device according to Variation 3.

FIG. 23 is a flowchart of Operation Example 5 performed by an acoustic signal processing device according to Variation 3.

FIG. 24 is a block diagram illustrating the functional configurations of an information generation device and an acoustic signal processing device according to Variation 4.

FIG. 25 is for illustrating processing performed by first sound data according to Variation 4.

FIG. 26 is a flowchart of Operation Example 6 performed by an acoustic signal processing device according to Variation 4.

FIG. 27 is a flowchart of Operation Example 7 performed by an acoustic signal processing device according to Variation 4.

FIG. 28 is a block diagram illustrating the functional configurations of an information generation device and an acoustic signal processing device according to Variation 5.

FIG. 29 is a flowchart of Operation Example 8 performed by an acoustic signal processing device according to Variation 5.

FIG. 30 is a block diagram illustrating the functional configurations of an information generation device and an acoustic signal processing device according to Variation 6.

FIG. 31 is a flowchart of Operation Example 9 performed by an information generation device according to Variation 6.

FIG. 32 is a flowchart of Operation Example 10 performed by an acoustic signal processing device according to Variation 6.

FIG. 33 is a flowchart of Operation Example 11 performed by an acoustic signal processing device according to Variation 6.

FIG. 34 is a block diagram illustrating the functional configurations of an information generation device and an acoustic signal processing device according to Variation 7.

FIG. 35 illustrates one example of an image displayed on a display according to Variation 7.

FIG. 36 is a flowchart of Operation Example 12 performed by an information generation device according to Variation 7.

FIG. 37 is a flowchart of Operation Example 13 performed by an acoustic signal processing device according to Variation 7.

FIG. 38 is a block diagram illustrating the functional configurations of an information generation device and an acoustic signal processing device according to Variation 8.

FIG. 39 is a flowchart of Operation Example 14 performed by an information generation device according to Variation 8.

FIG. 40 illustrates one example of a functional block diagram and steps for explaining a case where the renderers of FIG. 5G and FIG. 5H perform pipeline processing.

### DESCRIPTION OF EMBODIMENTS

### Underlying Knowledge Forming Basis of the Present Disclosure

Acoustic signal processing methods are known in which the loudness (sound pressure) of sound heard by a listener in a virtual space is controlled.

Patent Literature (PTL) 1 discloses a technique related to a three-dimensional acoustic calculation method that is an acoustic signal processing method. In this acoustic signal processing method, the loudness (sound pressure) is controlled so as to change inversely proportional to the distance between the sound source and the listener (observer). More specifically, the loudness is controlled to attenuate inversely proportional with increasing distance. This allows the listener to recognize the distance between the object emitting sound, i.e., the sound source, and the listener themselves.

Such sounds subjected to this control are utilized in applications for reproducing stereophonic sound in a space where a user (listener) is present, such as virtual reality (VR) or augmented reality (AR) space.

In real-world space, examples of sounds are known where the loudness of sound heard by the listener attenuates according to conditions other than being inversely proportional to the distance between the object emitting the sound and the listener themselves.

Two examples of such sounds are given below.

The first example of sound is the aerodynamic sound (also known as wind noise) generated accompanying the movement of the object (see Non Patent Literature (NPL) 1). Aerodynamic sound (wind noise) is a sound based on pressure fluctuations, such as vortex shedding, generated when wind collides with an object or when an object moves through the air.

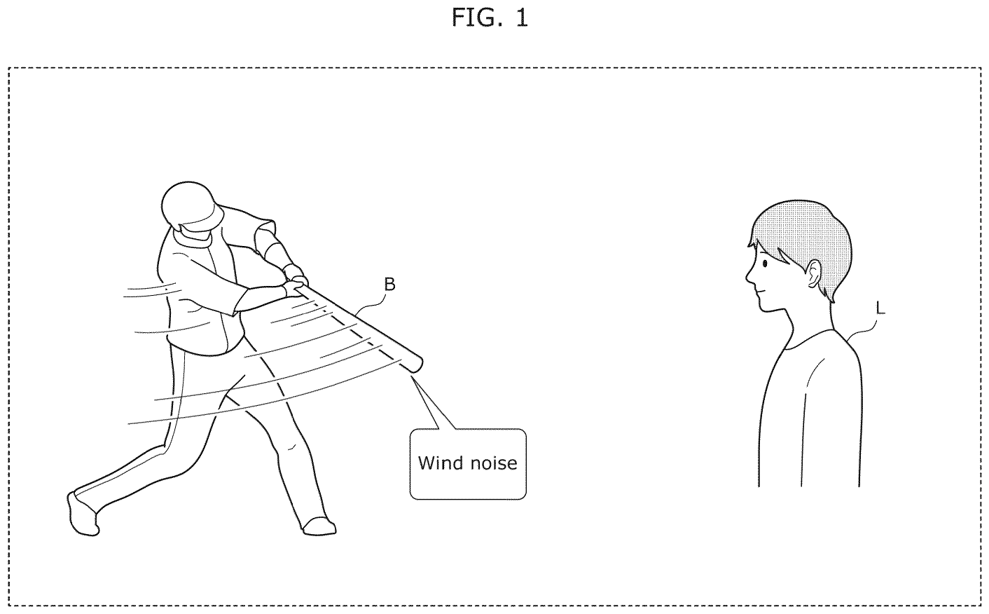

FIG. 1 is a diagram for explaining a first example of aerodynamic sound (wind noise) generated accompanying the movement (change in position) of an object. In FIG. 1, the object is exemplified as baseball bat B. When this object (bat B) moves (changes position), i.e., when bat B is swung, wind noise is generated. Listener L can recognize that bat B has been swung by hearing this wind noise. In a real-world space, the loudness of this wind noise attenuates as the distance between bat B and listener L increases, and more specifically, attenuates with the square of the distance between bat B and listener L.

If the technique disclosed in PTL 1 were applied to such wind noise in a virtual space, listener L would also hear wind noise controlled such that the loudness attenuates inversely proportional to the distance between bat B and listener L. Stated differently, wind noise applied with the technique disclosed in PTL 1 in the virtual space becomes a sound different from the wind noise that listener L hears in a real-world space. In the virtual space, when listener L hears wind noise applied with the technique disclosed in PTL 1, since this wind noise is different from the wind noise that listener L hears in a real-world space, listener L feels a sense of incongruity, making it difficult for listener L to experience a sense of realism. Consequently, there is a demand for an acoustic signal processing method and the like capable of providing listener L with a sense of realism.

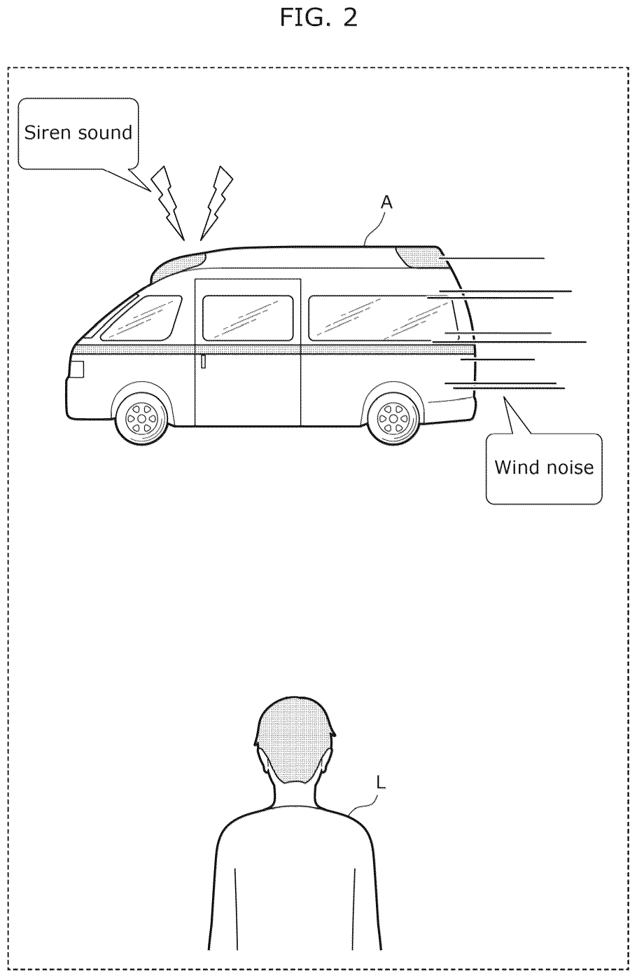

FIG. 2 is a diagram for explaining a second example of aerodynamic sound (wind noise) generated accompanying the movement (change in position) of an object. In FIG. 2, the object is exemplified as ambulance A. When this object (ambulance A) moves (changes position), i.e., when ambulance A is traveling, wind noise is generated. Listener L can recognize that ambulance A is traveling by hearing this wind noise. In a real-world space, similar to the wind noise caused by bat B mentioned above, the loudness of this wind noise attenuates as the distance between ambulance A and listener L increases, and more specifically, attenuates with the square of the distance between ambulance A and listener L.

Moreover, in FIG. 2, ambulance A is also an object that emits a siren sound. In a real-world space, this siren sound attenuates in loudness inversely proportional with increasing distance between ambulance A and listener L.

Consider a case where, in the virtual space, the technique disclosed in PTL 1 is applied to both the wind noise and the siren sound generated by ambulance A.

In this case, listener L would hear the siren sound controlled such that the loudness attenuates inversely proportional to the distance between ambulance A and listener L. Stated differently, siren sound applied with the technique disclosed in PTL 1 in the virtual space becomes similar to the siren sound that listener L hears in a real-world space, making it less likely for listener L to feel a sense of incongruity.

However, in this case, listener L would also hear wind noise controlled such that the loudness attenuates inversely proportional to the distance between ambulance A and listener L. Stated differently, wind noise applied with the technique disclosed in PTL 1 in the virtual space becomes a sound different from the wind noise that listener L hears in a real-world space. In the virtual space, when listener L hears wind noise applied with the technique disclosed in PTL 1, listener L feels a sense of incongruity, making it difficult for listener L to experience a sense of realism. Consequently, there is a demand for an acoustic signal processing method and the like capable of providing listener L with a sense of realism even in such cases.

As described above, ambulance A is an object that generates a plurality of sounds (siren sound and wind noise). Such objects are not limited to ambulance A.

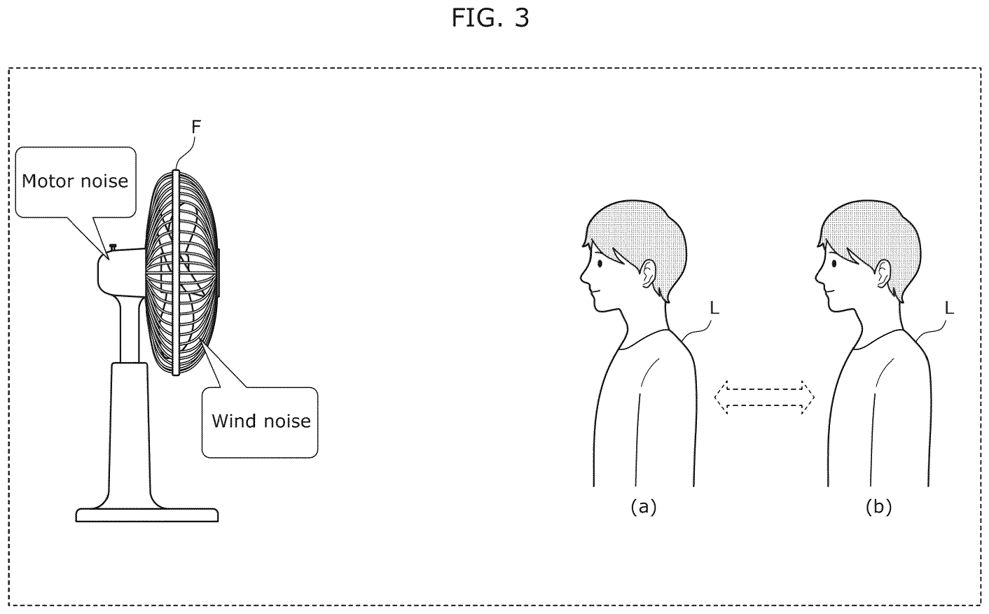

FIG. 3 is a diagram for explaining a third example of aerodynamic sound (wind noise) generated accompanying the movement (change in position) of an object. In FIG. 3, electric fan F is exemplified as such an object.

Wind noise is generated when the blades of electric fan F move (rotate). Similar to the wind noise caused by bat B and ambulance A mentioned above, the loudness of the wind noise caused by electric fan F attenuates as the distance between electric fan F and listener L increases, and more specifically, attenuates with the square of the distance between electric fan F and listener L. Electric fan F is also an object that emits motor noise, which is the sound generated when the motor included in electric fan F operates. In a real-world space, this motor noise attenuates in loudness inversely proportional with increasing distance between electric fan F and listener L.

In this way, electric fan F is also an object that generates a plurality of sounds (motor noise and wind noise).

Accordingly, similar to when the object is ambulance A, if the technique disclosed in PTL 1 is applied to both the wind noise and the motor noise generated by electric fan F in the virtual space, listener L feels a sense of incongruity, making it difficult for listener L to experience a sense of realism. In particular, as illustrated in FIG. 3, when listener L moves from position (a) to position (b), i.e., when the distance between electric fan F and listener L changes, the sense of incongruity becomes greater. Consequently, there is a demand for an acoustic signal processing method and the like capable of providing listener L with a sense of realism.

As described above, the first example of sound is given as wind noise. Next, the second example of sound, which is the aerodynamic sound generated by wind radiated from the object reaching the ears of listener L, will be described (see NPL 2 and NPL 3). Note that “ear” means at least one of the auricle and the outer ear.

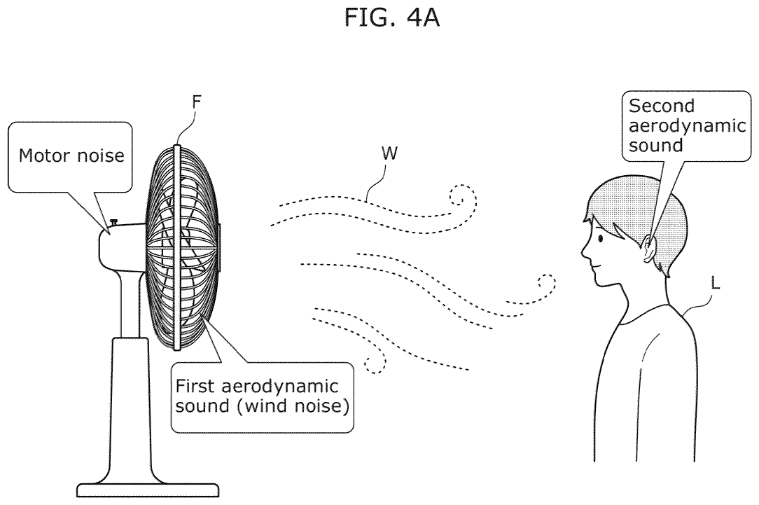

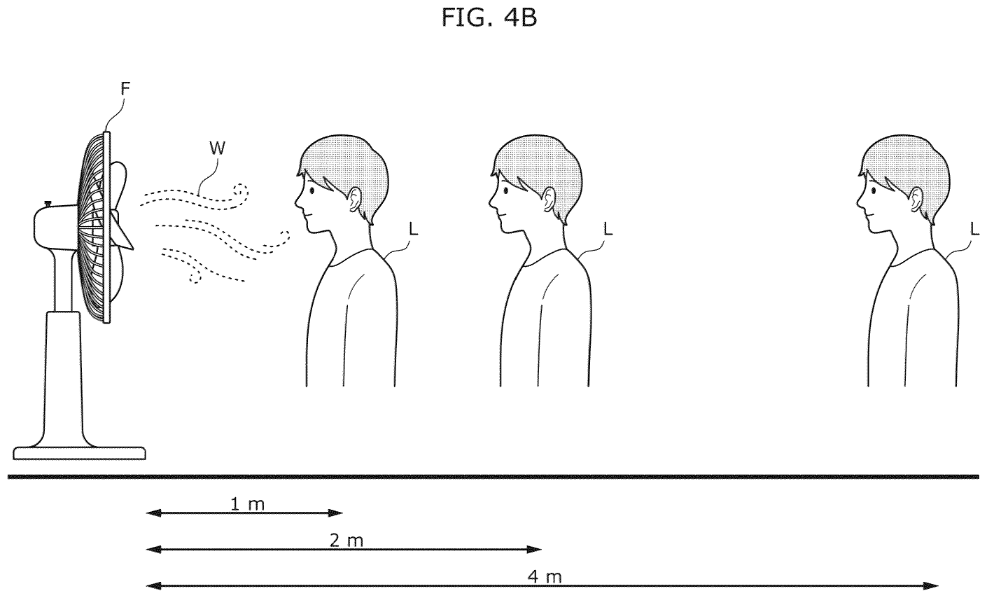

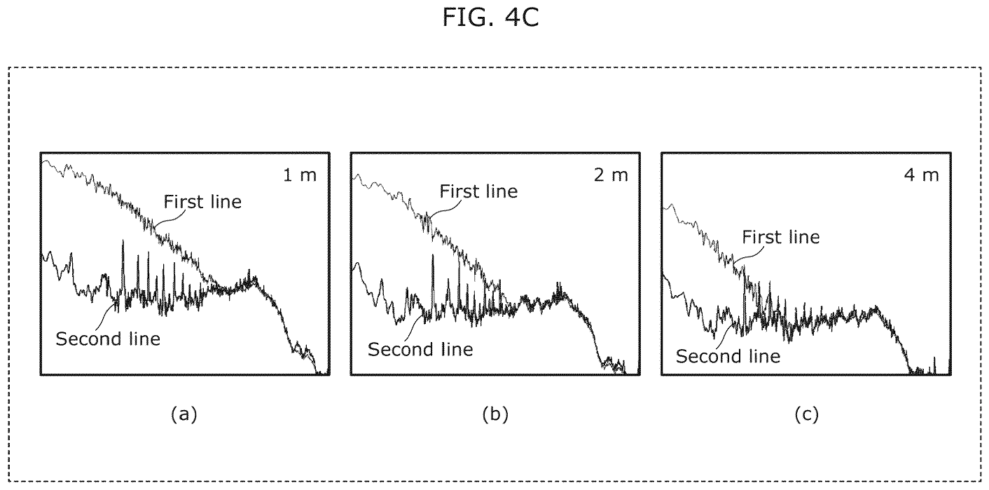

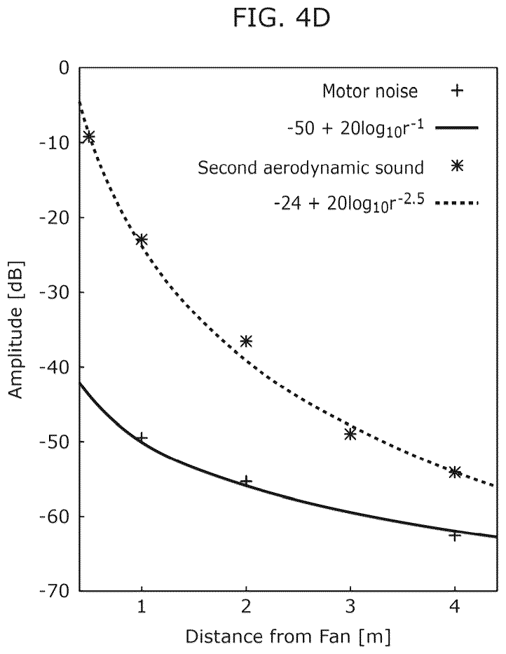

Conventional techniques, including the technique disclosed in PTL 1, use object audio information. Object audio information is, for example, data in which a sound signal (sound data) indicating sound is associated with position information indicating the position where the sound is generated. For example, here, consider the example illustrated in FIG. 4A.

FIG. 4A is for explaining aerodynamic sound generated by wind W radiated from an object reaching the ears of listener L. This second example of sound, i.e., the aerodynamic sound, is a sound generated when wind W caused by the object, electric fan F, reaches listener L, according to, for example, the shape of the ears of listener L. Hereinafter, for distinction, the aerodynamic sound (wind noise) generated accompanying the movement (change in position) of the object may be referred to as the first aerodynamic sound, and the aerodynamic sound generated by wind W from the object that reaches the ears of listener L colliding with the ears of listener L, which is the second example of sound, may be referred to as the second aerodynamic sound.

In FIG. 4A, the sounds caused by the object, i.e., electric fan F, include three sounds: the first aerodynamic sound (wind noise) and motor noise explained with reference to FIG. 3, and additionally the second aerodynamic sound. Here, we focus on the motor noise and the second aerodynamic sound.

For example, when object audio information is used for the motor noise, a sound signal (sound data) indicating the motor noise is associated with position information indicating the position where the motor noise is generated. In the object audio information, the position where the motor noise is generated is the position of electric fan F.

For example, when object audio information is used for the second aerodynamic sound, a sound signal (sound data) indicating the second aerodynamic sound is associated with position information indicating the position where the second aerodynamic sound is generated. In the object audio information, the position where the second aerodynamic sound is generated is the position of listener L.

Here, for the motor noise, the loudness is controlled to attenuate inversely proportional to the distance between electric fan F, which is the position where the motor noise is generated, and listener L, allowing listener L to hear the motor noise without a sense of incongruity.

For the second aerodynamic sound, there is no established theory on how the loudness attenuates based on the distance between electric fan F, which is the position where the wind W is generated, and listener L, unlike for the motor noise or the first aerodynamic sound. However, it is clear from everyday experience that changes in loudness occur according to distance. Therefore, the inventors of the present application conducted experiments using an electric fan and a dummy head microphone to clearly demonstrate the patterns of these increases and decreases.

FIG. 4B illustrates a method for measuring the attenuation of loudness of the second aerodynamic sound according to the distance from the wind source (that is, the position where wind W is generated (i.e., the position of electric fan F)). Sound collection was performed as illustrated in FIG. 4B, with the dummy head microphone (hereinafter referred to as microphone) positioned at various distances such as 1 meter, 2 meters, 4 meters, etc., from the electric fan, and the sound generated when wind W hits the microphone was collected. Since the front grille of the electric fan F was removed, the collected sound includes only the second aerodynamic sound and motor noise, with the first aerodynamic sound caused by the grille being excluded.

FIG. 4C illustrates the measurement results from the experiment described in FIG. 4B, and illustrates the frequency characteristics of the collected sound. More specifically, (a) in FIG. 4C illustrates a case where the microphone is positioned at a distance of 1 meter, (b) in FIG. 4C illustrates a case where the microphone is positioned at a distance of 2 meters, and (c) in FIG. 4C illustrates a case where the microphone is positioned at a distance of 4 meters. The line (first line) with a significant rise in frequency components below 1 kHz indicates the frequency characteristics of the sound collected when wind W hits the microphone directly. Therefore, the first line indicates the frequency characteristics of the sum of the motor noise and the second aerodynamic sound. The other line (second line) indicates the frequency characteristics of the sound collected when wind W does not hit the microphone directly. Therefore, the second line indicates the frequency characteristics of only the motor noise. For both graphs, the first line and the second line overlap for frequency components approximately 1 kHz and above, so the frequency components of the second aerodynamic sound can be represented by the components below 1 kHz in the first line. It goes without saying that the frequency components of the motor noise can be represented by the entire second line.

FIG. 4D illustrates the frequency characteristics of the second aerodynamic sound and the motor noise, identified as described above, converted to loudness and plotted for each distance. Regarding the motor noise, as per the conventional theory, it shows a tendency to attenuate in proportion to the distance (inversely proportional to the first power of the distance). However, regarding the second aerodynamic sound, it can be seen that it shows a tendency to attenuate according to the 2.5th power of the distance (inversely proportional to the 2.5th power of the distance) (in FIG. 4D, observation data at positions of 50 centimeters and 3 meters, which are not illustrated in FIG. 4B, are also plotted). Here, for the second aerodynamic sound, the loudness is controlled to attenuate according to the 2.5th power of the distance between electric fan F, which is the position where wind W is generated, and listener L, allowing listener L to hear the second aerodynamic sound without a sense of incongruity. Alternatively, the distance and the frequency characteristics of the second aerodynamic sound at that distance may be associated, and the frequency characteristics may be obtained using the distance as an index, and the loudness may be controlled accordingly. Of course, it goes without saying that since wind speed is known to attenuate according to distance, the wind speed and the frequency characteristics of the second aerodynamic sound at that wind speed may be associated, and the frequency characteristics may be obtained using the wind speed calculated based on the distance as an index, and the loudness may be controlled accordingly.

The inventors of the present application had predicted that the exponent of distance attenuation for the second aerodynamic sound would be 4 (i.e., inversely proportional to the 4th power of distance). This is because it was thought that the second aerodynamic sound originates from the aerodynamic sound, known as cavity sound, generated when wind hits an object with an uneven surface, and the loudness of cavity sound is said to amplify in proportion to the fourth power of wind speed, while wind speed is inversely proportional to distance. Therefore, it was believed that the second aerodynamic sound would be inversely proportional to the fourth power of distance. However, through experiments such as those described above, the inventors found that the exponent of distance attenuation for the second aerodynamic sound is approximately 2.5. This is thought to be because the ear auricle is not a simple cavity, but rather a cavity with a parabolic shape, which captures wind W more efficiently. However, since there are individual differences in the shape of the ear auricle, the above-mentioned exponent cannot be limited to 2.5. But, since the second aerodynamic sound originates from cavity sound, it is believed that the above-mentioned exponent does not exceed 4.

On the other hand, regarding the second aerodynamic sound, the position where the second aerodynamic sound is generated is the position of the ear of listener L. Therefore, even if listener L moves, the distance between the position where the second aerodynamic sound is generated, i.e., the position of the ear of listener L, and the position of listener L always remains constant. As a result, the loudness of the second aerodynamic sound cannot be controlled to attenuate according to that distance. Therefore, when object audio information according to a conventional technique is used, listener L ends up hearing the second aerodynamic sound with a sense of incongruity. Consequently, there is a demand for an acoustic signal processing method and the like capable of providing listener L with a sense of realism.

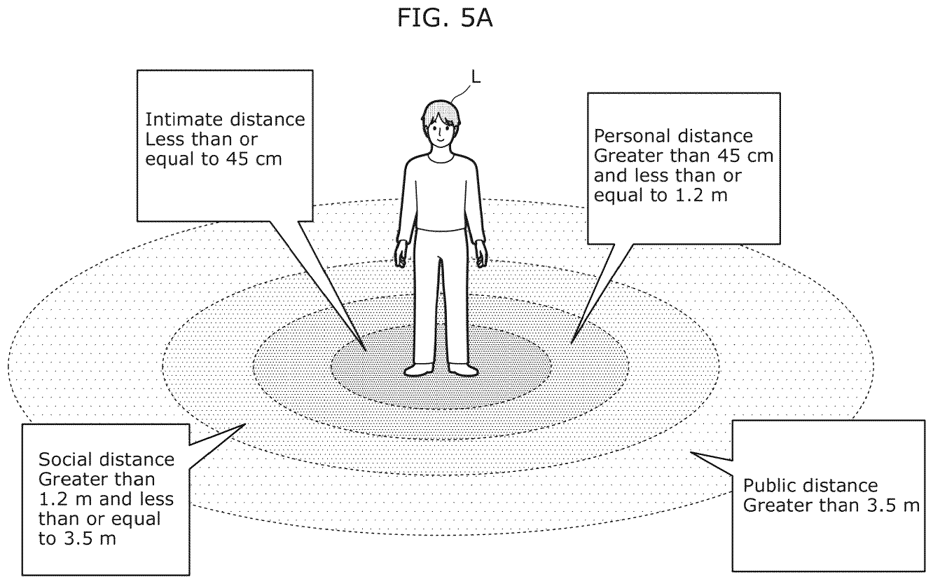

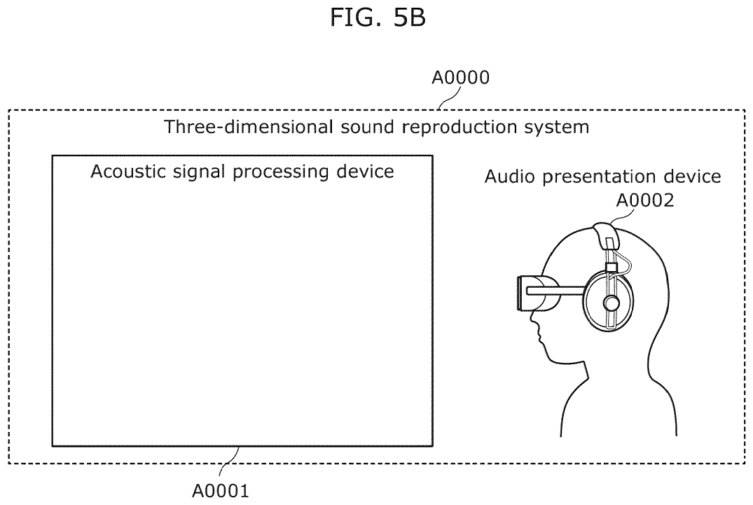

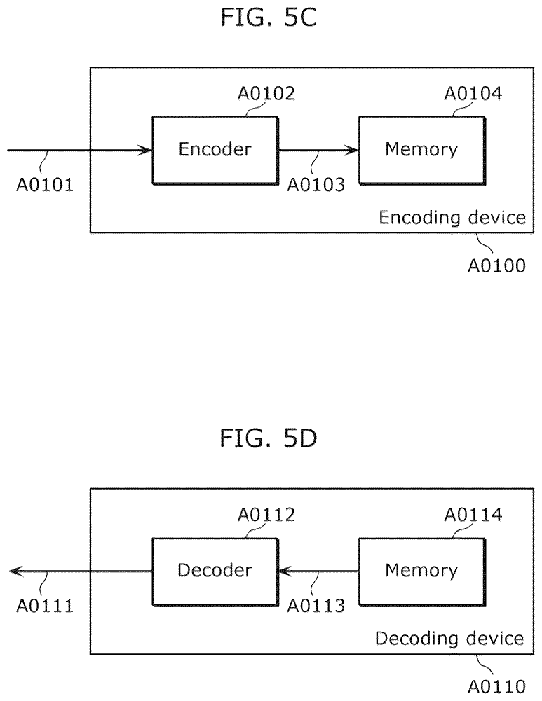

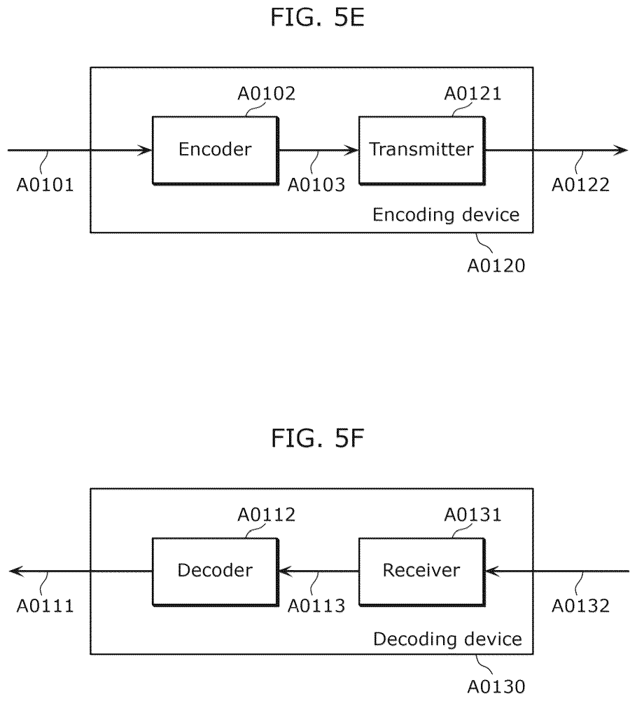

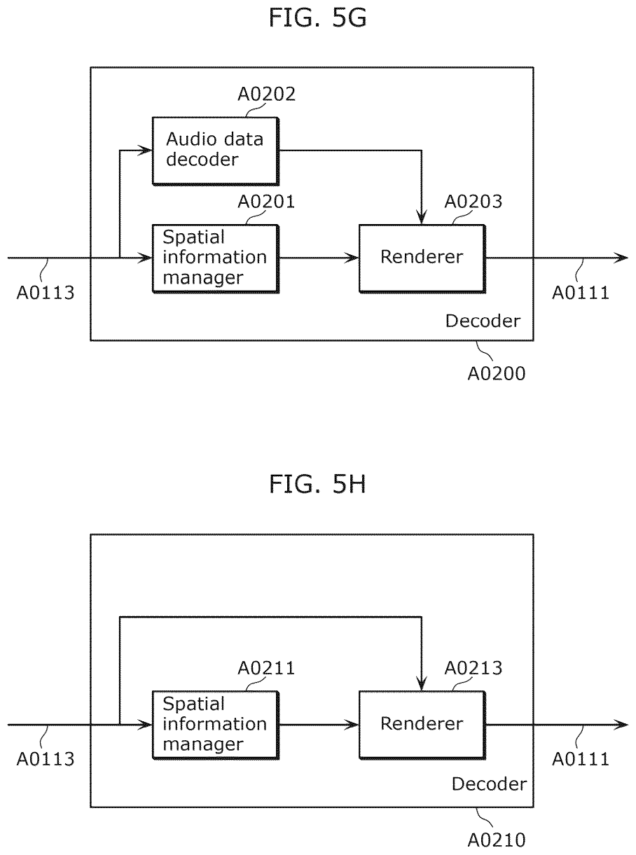

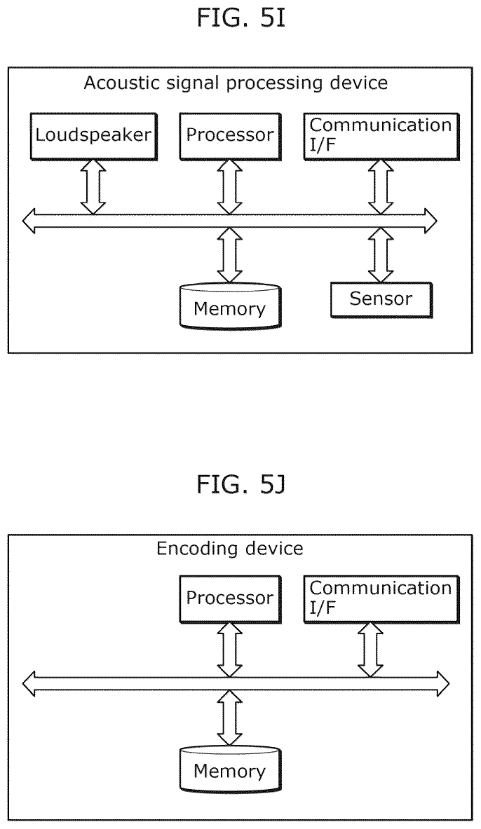

Furthermore, it is known that personal space exists in real-world space. FIG. 5A illustrates the personal space of listener L.

Personal space refers to the range within which one (in this case, listener L) can tolerate others approaching, in other words, a psychological territory. This indicates that for listener L in the virtual space, there is a sense of distance between listener L and each other individual that cannot be expressed by physical distance alone. Personal space is classified into four categories: intimate distance (less than or equal to 45 centimeters), personal distance (greater than 45 centimeters and less than or equal to 120 centimeters), social distance (greater than 120 centimeters and less than or equal to 360 centimeters), and public distance (greater than 360 centimeters).

Consider a case where, when expressing this sense of distance between listener L and other individuals in the virtual space that cannot be expressed by physical distance alone, the technique disclosed in PTL 1 is uniformly applied to the voices of all other individuals.

In this case, listener L would hear voices controlled such that the loudness of the voice of another individual attenuates inversely proportional to the distance between the other individual and listener L, regardless of the relationship between listener L and the other individual. Stated differently, the voice of that other individual is uniformly controlled to attenuate regardless of whether the other individual has a high or low degree of familiarity with listener L.

Therefore, it becomes difficult to express, in the virtual space, the personal space corresponding to listener L and the sense of distance between listener L and other individuals that cannot be expressed by physical distance alone, causing listener L to feel a sense of incongruity and making it difficult for listener L to experience a sense of realism. Consequently, there is a demand for an acoustic signal processing method and the like capable of providing listener L with a sense of realism.

An acoustic signal processing method according to a first aspect of the present disclosure includes: obtaining object information and second position information, the object information including first position information indicating a position of an object in a virtual space, first sound data indicating a first sound caused by the object, and first identification information indicating a processing method for the first sound data, the second position information indicating a position of a listener of the first sound in the virtual space; calculating a distance between the object and the listener based on the first position information included in the object information obtained and the second position information obtained; determining, based on the first identification information included in the object information obtained, a processing method among a first processing method and a second processing method to use to process the first sound data, the first processing method for processing a loudness according to the distance calculated, the second processing method for processing the loudness according to the distance calculated in a manner different from the first processing method; processing the first sound data using the processing method determined; and outputting the first sound data processed.

Accordingly, since the processing method for the loudness of the first sound can be changed according to the first identification information, the first sound that the listener hears in the virtual space becomes similar to the first sound that the listener hears in the real-world space, and more specifically, becomes a sound that reproduces the first sound in the real-world space. Therefore, the listener is less likely to feel a sense of incongruity and can experience a sense of realism. Stated differently, the acoustic signal processing method is capable of providing the listener with a sense of realism.

For example, the acoustic signal processing method according to a second aspect of the present disclosure is the acoustic signal processing method according to the first aspect, wherein the first processing method is for processing the first sound data to attenuate the loudness inversely proportional with respect to an increase in the distance calculated, and the second processing method is for processing the first sound data to increase or decrease the loudness in a manner different from the first processing method as the distance calculated increases.

Accordingly, since either the first processing method for processing the first sound data such that the loudness attenuates inversely proportional with increasing distance, or the second processing method for processing the first sound data such that the loudness increases or decreases in a manner different from the first processing method as distance increases, is used according to the first identification information, the first sound that the listener hears in the virtual space becomes more similar to the first sound that the listener hears in the real-world space. Therefore, the listener is even less likely to feel a sense of incongruity and can experience an even greater sense of realism. Stated differently, the acoustic signal processing method is capable of providing the listener with a greater sense of realism.

For example, an acoustic signal processing method according to a third aspect of the present disclosure is the acoustic signal processing method according to the first or second aspect, wherein the object information obtained includes: second sound data indicating a second sound that is caused by the object and different from the first sound; and second identification information indicating a processing method for the second sound data, the determining includes determining, based on the second identification information included in the object information obtained, a processing method among the first processing method and the second processing method to use to process the second sound data, the processing includes processing the second sound data using the processing method determined, the outputting includes outputting the second sound data processed, and the object is an object associated with a plurality of items of sound data including the first sound data and the second sound data.

Accordingly, since the processing method for the loudness of the second sound can be changed according to the second identification information, the second sound that the listener hears in the virtual space also becomes similar to the second sound that the listener hears in the real-world space, and more specifically, the loudness balance between the first sound and the second sound fluctuates like the loudness balance does in the real-world space according to the calculated distance. Therefore, the listener is even less likely to feel a sense of incongruity and can experience an even greater sense of realism. Stated differently, the acoustic signal processing method is capable of providing the listener with a greater sense of realism.

For example, the acoustic signal processing method according to a fourth aspect of the present disclosure is the acoustic signal processing method according to the second aspect, wherein the second processing method is for processing the first sound data to attenuate the loudness according to an x-th power of the distance, where x≠1.

With this, in the processing, the second processing method for processing the first sound data such that the loudness attenuates according to the x-th power of the distance can be used.

For example, the acoustic signal processing method according to a fifth aspect of the present disclosure is the acoustic signal processing method according to the fourth aspect, wherein the first identification information indicates that the processing method for the first sound data is the second processing method, and indicates a value of x.

With this, the first identification information can indicate that the processing method is the second processing method, and in the processing, the first sound data can be processed according to the value of x indicated by the first identification information.

For example, the acoustic signal processing method according to a sixth aspect of the present disclosure is the acoustic signal processing method according to the fourth aspect, wherein when the first sound is an aerodynamic sound generated accompanying movement of the object, the first identification information indicates that the processing method for the first sound data is the second processing method, and that x is α, where α is a real number and α>1.

With this, in the processing, when the first sound is an aerodynamic sound (first aerodynamic sound), the first sound data can be processed according to α, which is the value of x indicated by the first identification information.

For example, the acoustic signal processing method according to a seventh aspect of the present disclosure is the acoustic signal processing method according to the sixth aspect, wherein when the first sound is an aerodynamic sound generated by wind radiated from the object reaching an ear of the listener, the first identification information indicates that the processing method for the first sound data is the second processing method, and that x is β, where β is a real number and β>2.

With this, in the processing, when the first sound is an aerodynamic sound (second aerodynamic sound) generated by wind radiated from the object reaching the ear of the listener, the first sound data can be processed according to β, which is the value of x indicated by the first identification information.

For example, the acoustic signal processing method according to an eighth aspect of the present disclosure is the acoustic signal processing method according to the seventh aspect, wherein α<β.

With this, in the processing, the first sound data can be processed using α or β that satisfies α<β.

For example, the acoustic signal processing method according to a ninth aspect of the present disclosure is the acoustic signal processing method according to the seventh or eighth aspect, further including: receiving an operation from a user specifying a value of α or β.

With this, in the processing, the first sound data can be processed using the value of α or β specified by the user.

For example, the acoustic signal processing method according to a tenth aspect of the present disclosure is the acoustic signal processing method according to the second aspect, wherein the first identification information indicates whether to execute the first processing method, the determining includes: determining whether to execute the first processing method based on the first identification information obtained; and determining to execute the second processing method regardless of whether the first processing method is to be executed, and the second processing method is for processing the first sound data to bring the loudness to a predetermined value when the distance calculated is within a predetermined threshold.

With this, in the processing, the second processing method can be used that processes the first sound data such that the loudness becomes a predetermined value only when the distance is within a predetermined threshold, thereby creating a surreal effect, while also imparting a natural distance attenuation effect that occurs realistically.

For example, the acoustic signal processing method according to an eleventh aspect of the present disclosure is the acoustic signal processing method according to the tenth aspect, wherein the predetermined threshold is a value dependent on personal space.

With this, in the processing, the first sound data can be processed using a predetermined threshold value that corresponds to personal space, thereby enabling the expression of a psychological sense of distance that cannot be represented by the distance attenuation effect based on physical distance.

For example, the acoustic signal processing method according to a twelfth aspect of the present disclosure is the acoustic signal processing method according to the tenth or eleventh aspect, further including: receiving an operation from a user specifying that the predetermined threshold is a first specified value.

With this, in the processing, the first sound data can be processed using the first specified value specified by the user.

For example, an information generation method according to a thirteenth aspect of the present disclosure includes: obtaining first sound data and first position information, the first sound data indicating a first sound generated at a position related to a position of a listener in a virtual space, the first position information indicating a position of an object in the virtual space; and generating, from the first sound data obtained and the first position information obtained, first object audio information including (i) information related to the object that reproduces the first sound at the position related to the position of the listener due to the object, and (ii) the first position information.

With this, first object audio information in which first sound data indicating first sound generated at a position related to the position of the listener due to the object is associated with the position of the object can be generated. When this first object audio information is used in the acoustic signal processing method, as the first sound data is processed such that the loudness of the first sound attenuates as the distance between the object and the listener increases, the first sound that the listener hears in the virtual space becomes similar to the first sound that the listener hears in the real-world space, and more specifically, becomes a sound that reproduces the first sound in the real-world space. Therefore, the listener is less likely to feel a sense of incongruity and can experience a sense of realism. Stated differently, the information generation method is capable of providing the listener with a sense of realism.

For example, the information generation method according to a fourteenth aspect of the present disclosure is the information generation method according to the thirteenth aspect, wherein the object radiates wind, the listener is exposed to the wind radiated, and the first sound is an aerodynamic sound generated by the wind radiated from the object reaching an ear of the listener.

With this, an information generation method is realized that can make the first sound an aerodynamic sound (second aerodynamic sound) that is generated by wind radiated from the object reaching the ears of the listener.

For example, the information generation method according to a fifteenth aspect of the present disclosure is the information generation method according to the fourteenth aspect, wherein the generating includes generating the first object audio information further including unit distance information, and the unit distance information includes a unit distance serving as a reference distance, and aerodynamic sound data indicating the aerodynamic sound at a position separated by the unit distance from the position of the object.

With this, first object audio information including unit distance information can be generated. When this first object audio information is used in the acoustic signal processing method, the first sound (second aerodynamic sound) that the listener hears in the virtual space becomes more similar to the first sound (second aerodynamic sound) that the listener hears in the real-world space, based on the unit distance and aerodynamic sound data. Therefore, the listener is even less likely to feel a sense of incongruity and can experience an even greater sense of realism. Stated differently, the information generation method is capable of providing the listener with a greater sense of realism.

For example, the information generation method according to a sixteenth aspect of the present disclosure is the information generation method according to the fifteenth aspect, wherein the generating includes generating the first object audio information further including directivity information, the directivity information indicates a characteristic according to a direction of the wind radiated, and the aerodynamic sound data indicated in the unit distance information is data indicating the aerodynamic sound at a position separated by the unit distance from the position of the object, in a forward direction in which the object radiates the wind as indicated in the directivity information.

With this, first object audio information including directivity information can be generated. When this first object audio information is used in the acoustic signal processing method, the first sound (second aerodynamic sound) that the listener hears in the virtual space becomes more similar to the first sound (second aerodynamic sound) that the listener hears in the real-world space, based on the unit distance, aerodynamic sound data, and directivity information. Therefore, the listener is even less likely to feel a sense of incongruity and can experience an even greater sense of realism. Stated differently, the information generation method is capable of providing the listener with a greater sense of realism.

For example, the information generation method according to a seventeenth aspect of the present disclosure is the information generation method according to any one of the thirteenth to sixteenth aspects, wherein the generating includes generating the first object audio information further including flag information indicating whether to, when reproducing the first sound, perform processing to convolve a head-related transfer function that depends on a direction of arrival of sound, on a first sound signal that is based on the first sound data indicating the first sound generated from the object.

With this, first object audio information including flag information can be generated. When this first object audio information is used in the acoustic signal processing method, the first sound that the listener hears in the virtual space becomes more similar to the first sound that the listener hears in the real-world space, because a head-related transfer function may be convolved with the first sound signal based on the first sound data. Therefore, the listener is even less likely to feel a sense of incongruity and can experience an even greater sense of realism. Stated differently, the information generation method is capable of providing the listener with a greater sense of realism.

For example, an acoustic signal processing method according to an eighteenth aspect of the present disclosure includes: obtaining the first object audio information generated by the information generation method according to the thirteenth aspect, the first sound data obtained, and second position information indicating the position of the listener of the first sound; calculating a distance between the object and the listener based on the first position information included in the first object audio information obtained and the second position information obtained; processing the first sound data to attenuate a loudness of the first sound as the distance calculated increases; and outputting the first sound data processed.

With this, in the obtaining, first object audio information in which first sound data indicating first sound generated at a position related to the position of the listener due to the object is associated with the position of the object can be obtained. Accordingly, as the first sound data is processed such that the loudness of the first sound attenuates as the distance between the object and the listener increases, the first sound that the listener hears in the virtual space becomes similar to the first sound that the listener hears in the real-world space, and more specifically, becomes a sound that reproduces the first sound in the real-world space. Therefore, the listener is less likely to feel a sense of incongruity and can experience a sense of realism. Stated differently, the acoustic signal processing method is capable of providing the listener with a sense of realism.

For example, an acoustic signal processing method according to a nineteenth aspect of the present disclosure includes: obtaining the first object audio information generated by the information generation method according to the fourteenth aspect, the first sound data obtained, and second position information indicating the position of the listener of the first sound; calculating a distance between the object that radiates the wind and the listener based on the first position information included in the first object audio information obtained and the second position information obtained; processing the first sound data to attenuate a loudness of the first sound as the distance calculated increases; and outputting the first sound data processed.

With this, an acoustic signal processing method is realized that can make the first sound an aerodynamic sound (second aerodynamic sound) that is generated by wind radiated from the object reaching the ears of the listener.

For example, an acoustic signal processing method according to a twentieth aspect of the present disclosure includes: obtaining the first object audio information generated by the information generation method according to the fifteenth aspect, the first sound data obtained, and second position information indicating the position of the listener of the first sound; calculating a distance between the object that radiates the wind and the listener based on the first position information included in the first object audio information obtained and the second position information obtained; when the distance calculated is greater than the unit distance indicated by the unit distance information included in the first object audio information obtained, processing the first sound data to attenuate a loudness of the first sound according to the distance calculated and the unit distance; and outputting the first sound data processed.

With this, in the obtaining, first object audio information including unit distance information can be obtained. Therefore, the first sound (second aerodynamic sound) that the listener hears in the virtual space becomes more similar to the first sound (second aerodynamic sound) that the listener hears in the real-world space, based on the unit distance and aerodynamic sound data. Therefore, the listener is even less likely to feel a sense of incongruity and can experience an even greater sense of realism. Stated differently, the acoustic signal processing method is capable of providing the listener with a greater sense of realism.

For example, an acoustic signal processing method according to a twenty-first aspect of the present disclosure includes: obtaining the first object audio information generated by the information generation method according to the sixteenth aspect, the first sound data obtained, and second position information indicating the position of the listener of the first sound; calculating a distance between the object that radiates the wind and the listener, and a direction between two points connecting the object and the listener, based on the first position information included in the first object audio information obtained and the second position information obtained; processing the first sound data to: control a loudness of the first sound based on (i) an angle formed between the forward direction and the direction between two points calculated and (ii) the characteristic indicated by the directivity information; and when the distance calculated is greater than the unit distance indicated by the unit distance information included in the first object audio information obtained, attenuate the loudness of the first sound according to the distance calculated and the unit distance; and outputting the first sound data processed.

With this, in the obtaining, first object audio information including directivity information can be obtained. Therefore, the first sound (second aerodynamic sound) that the listener hears in the virtual space becomes more similar to the first sound (second aerodynamic sound) that the listener hears in the real-world space, based on the unit distance, aerodynamic sound data, and directivity information. Therefore, the listener is even less likely to feel a sense of incongruity and can experience an even greater sense of realism. Stated differently, the acoustic signal processing method is capable of providing the listener with a greater sense of realism.

For example, an acoustic signal processing method according to a twenty-second aspect of the present disclosure includes: obtaining the first object audio information generated by an information generation method according to any one of the thirteenth to sixteenth aspects, the first sound data obtained, and second object audio information in which the first position information and second sound data indicating a second sound caused by the object are associated; processing including: not processing a first sound signal that is based on the first sound data obtained with processing to convolve a head-related transfer function that depends on a direction of arrival of sound; and processing a second sound signal that is based on the second sound data indicated by the second object audio information obtained with processing to convolve the head-related transfer function that depends on the direction of arrival of sound; and outputting the first sound signal not processed and the second sound signal processed.

Accordingly, the second sound that the listener hears in the virtual space becomes similar to the second sound that the listener hears in the real-world space, because a head-related transfer function is convolved with the second sound signal based on the second sound data, and more specifically, becomes a sound that reproduces the second sound in the real-world space. Therefore, the listener is even less likely to feel a sense of incongruity and can experience an even greater sense of realism. Stated differently, the acoustic signal processing method is capable of providing the listener with a greater sense of realism.

For example, an acoustic signal processing method according to a twenty-third aspect of the present disclosure includes: obtaining the first object audio information generated by an information generation method according to any one of the fourteenth to sixteenth aspects, the first sound data obtained, and second object audio information in which the first position information and second sound data indicating a second sound caused by the object are associated; processing including: processing a first sound signal that is based on the first sound data obtained with processing dependent on a direction of arrival of wind; and processing a second sound signal that is based on the second sound data indicated by the second object audio information obtained with processing to convolve a head-related transfer function that depends on a direction of arrival of sound; and outputting the first sound signal processed and the second sound signal processed.

Accordingly, the first sound (second aerodynamic sound) that the listener hears in the virtual space becomes similar to the first sound (second aerodynamic sound) that the listener hears in the real-world space, because processing dependent on the direction of arrival of wind is performed on the first sound signal based on the first sound data, and more specifically, becomes a sound that reproduces the first sound (second aerodynamic sound) in the real-world space. Furthermore, the second sound that the listener hears in the virtual space becomes similar to the second sound that the listener hears in the real-world space, because a head-related transfer function is convolved with the second sound signal based on the second sound data, and more specifically, becomes a sound that reproduces the second sound in the real-world space. Therefore, the listener is even less likely to feel a sense of incongruity and can experience an even greater sense of realism. Stated differently, the acoustic signal processing method is capable of providing the listener with a greater sense of realism.

For example, an acoustic signal processing method according to a twenty-fourth aspect of the present disclosure includes: obtaining the first object audio information generated by an information generation method according to any one of the fourteenth to sixteenth aspects, the first sound data obtained, and third object audio information in which third position information indicating a position of an other object in the virtual space and third sound data indicating a third sound generated at the position of the other object are associated, the other object being different from the object; processing including: processing a first sound signal that is based on the first sound data obtained with processing dependent on a direction of arrival of wind; and processing a third sound signal that is based on the third sound data indicated by the third object audio information obtained with processing to convolve a head-related transfer function that depends on a direction of arrival of sound; and outputting the first sound signal processed and the third sound signal processed.

Accordingly, when a plurality of objects including the object and the other object are provided in the virtual space, the first sound (second aerodynamic sound) and the third sound that the listener hears in the virtual space become similar to the first sound (second aerodynamic sound) and the third sound, respectively, that the listener hears in the real-world space. Therefore, the listener is even less likely to feel a sense of incongruity and can experience an even greater sense of realism. Stated differently, the acoustic signal processing method is capable of providing the listener with a greater sense of realism.

An information generation method according to a twenty-fifth aspect of the present disclosure includes: obtaining a generation position of a first wind blowing in a virtual space, a first wind direction of the first wind, and a first assumed wind speed which is a speed of the first wind; generating fourth object audio information in which the generation position, the first wind direction, and the first assumed wind speed obtained are associated; storing aerodynamic sound core information including a representative wind speed and aerodynamic sound data indicating aerodynamic sound generated by wind blowing at the representative wind speed reaching an ear of a listener in the virtual space; and outputting the fourth object audio information generated and the aerodynamic sound core information stored.

With this, fourth object audio information in which the generation position, the first wind direction, and the first assumed wind speed are associated can be generated. When this fourth object audio information is used in the acoustic signal processing method, as the aerodynamic sound data is processed such that the loudness of the aerodynamic sound (second aerodynamic sound) attenuates as the distance between the object and the listener increases, the aerodynamic sound (second aerodynamic sound) that the listener hears in the virtual space becomes similar to the aerodynamic sound (second aerodynamic sound) that the listener hears in the real-world space, and more specifically, becomes a sound that reproduces the aerodynamic sound (second aerodynamic sound) in the real-world space. Therefore, the listener is less likely to feel a sense of incongruity and can experience a sense of realism. Stated differently, the information generation method is capable of providing the listener with a sense of realism.

For example, the information generation method according to a twenty-sixth aspect of the present disclosure is the information generation method according to the twenty-fifth aspect, wherein the first assumed wind speed is a speed of the first wind at a position separated by a unit distance, serving as a reference distance, from the generation position in the first wind direction.

With this, the speed of the first wind at a position separated by the unit distance can be used as the first assumed wind speed.

For example, the information generation method according to a twenty-seventh aspect of the present disclosure is the information generation method according to the twenty-sixth aspect, further including: receiving an operation from a user specifying that the unit distance is a second specified value.

With this, fourth object audio information can be generated using the unit distance, which is the second specified value specified by the user.

For example, the information generation method according to a twenty-eighth aspect of the present disclosure is the information generation method according to the twenty-sixth or twenty-seventh aspect, further including receiving an operation from a user specifying directivity information indicating a characteristic according to a direction of the first wind, wherein the generating includes generating the fourth object audio information in which the generation position, the first wind direction, and the first assumed wind speed obtained are associated with the directivity information indicated by the operation received.

With this, fourth object audio information in which the generation position, the first wind direction, the first assumed wind speed, and directivity information specified by the user are associated can be generated.

For example, an acoustic signal processing method according to a twenty-ninth aspect of the present disclosure includes: obtaining the fourth object audio information and the aerodynamic sound core information output by an information generation method according to any one of the twenty-sixth to twenty-eighth aspects, and second position information indicating a position of the listener in the virtual space; calculating, based on the generation position included in the fourth object audio information obtained and the second position information obtained, a distance between the generation position and the listener; processing the aerodynamic sound data to attenuate a loudness of the aerodynamic sound as the distance calculated increases; and outputting the aerodynamic sound data processed.

With this, in the obtaining, fourth object audio information in which the generation position, the first wind direction, and the first assumed wind speed are associated can be obtained. Accordingly, as the aerodynamic sound data is processed such that the loudness of the aerodynamic sound (second aerodynamic sound) attenuates as the distance between the object and the listener increases, the aerodynamic sound (second aerodynamic sound) that the listener hears in the virtual space becomes similar to the aerodynamic sound (second aerodynamic sound) that the listener hears in the real-world space, and more specifically, becomes a sound that reproduces the aerodynamic sound (second aerodynamic sound) in the real-world space. Therefore, the listener is less likely to feel a sense of incongruity and can experience a sense of realism. Stated differently, the acoustic signal processing method is capable of providing the listener with a sense of realism.

For example, the acoustic signal processing method according to a thirtieth aspect of the present disclosure is the acoustic signal processing method according to the twenty-ninth aspect, wherein the processing includes processing the aerodynamic sound data based on an ear-reaching wind speed, the ear-reaching wind speed being a speed of the first wind upon reaching the ear of the listener, and the ear-reaching wind speed decreases as the distance calculated increases.

Accordingly, since the aerodynamic sound data is processed based on the ear-reaching wind speed, the aerodynamic sound (second aerodynamic sound) that the listener hears in the virtual space becomes more similar to the aerodynamic sound (second aerodynamic sound) that the listener hears in the real-world space. Therefore, the listener is even less likely to feel a sense of incongruity and can experience an even greater sense of realism. Stated differently, the acoustic signal processing method is capable of providing the listener with a greater sense of realism.

For example, the acoustic signal processing method according to a thirty-first aspect of the present disclosure is the acoustic signal processing method according to the thirtieth aspect, wherein the ear-reaching wind speed is a value that attenuates according to a z-th power of a value obtained by dividing the distance calculated by the unit distance.

Accordingly, since a more accurate ear-reaching wind speed is calculated, the aerodynamic sound (second aerodynamic sound) that the listener hears in the virtual space becomes more similar to the aerodynamic sound (second aerodynamic sound) that the listener hears in the real-world space. Therefore, the listener is even less likely to feel a sense of incongruity and can experience an even greater sense of realism. Stated differently, the acoustic signal processing method is capable of providing the listener with a greater sense of realism.

For example, the acoustic signal processing method according to a thirty-second aspect of the present disclosure is the acoustic signal processing method according to the thirty-first aspect, wherein z=1.

Accordingly, since a more accurate ear-reaching wind speed is calculated, the aerodynamic sound (second aerodynamic sound) that the listener hears in the virtual space becomes more similar to the aerodynamic sound (second aerodynamic sound) that the listener hears in the real-world space. Therefore, the listener is even less likely to feel a sense of incongruity and can experience an even greater sense of realism. Stated differently, the acoustic signal processing method is capable of providing the listener with a greater sense of realism.

For example, the acoustic signal processing method according to a thirty-third aspect of the present disclosure is the acoustic signal processing method according to the thirty-first aspect, wherein the processing includes processing the aerodynamic sound data to attenuate the loudness of the aerodynamic sound according to a y-th power of a value obtained by dividing the representative wind speed by the ear-reaching wind speed.

Accordingly, since the aerodynamic sound data is processed so that the loudness of the aerodynamic sound (second aerodynamic sound) becomes more accurate, the aerodynamic sound (second aerodynamic sound) that the listener hears in the virtual space becomes more similar to the aerodynamic sound (second aerodynamic sound) that the listener hears in the real-world space. Therefore, the listener is even less likely to feel a sense of incongruity and can experience an even greater sense of realism. Stated differently, the acoustic signal processing method is capable of providing the listener with a greater sense of realism.

For example, the acoustic signal processing method according to a thirty-fourth aspect of the present disclosure is the acoustic signal processing method according to the thirty-third aspect, wherein γ×z<4.

Accordingly, since a more accurate ear-reaching wind speed is calculated, the aerodynamic sound (second aerodynamic sound) that the listener hears in the virtual space becomes more similar to the aerodynamic sound (second aerodynamic sound) that the listener hears in the real-world space. Therefore, the listener is even less likely to feel a sense of incongruity and can experience an even greater sense of realism. Stated differently, the acoustic signal processing method is capable of providing the listener with a greater sense of realism.

For example, an acoustic signal processing method according to a thirty-fifth aspect of the present disclosure includes: obtaining the fourth object audio information and the aerodynamic sound core information output by an information generation method according to any one of the twenty-sixth to twenty-eighth aspects, and second position information indicating a position of the listener in the virtual space, the aerodynamic sound core information including data indicating a distribution of frequency components of the aerodynamic sound; calculating, based on the generation position included in the fourth object audio information obtained and the second position information obtained, a distance between the generation position and the listener; processing the aerodynamic sound data to shift the distribution of the frequency components of the aerodynamic sound toward lower frequencies as the distance calculated increases; and outputting the aerodynamic sound data processed.

With this, in the obtaining, fourth object audio information in which the generation position, the first wind direction, and the first assumed wind speed are associated can be obtained. Accordingly, as the aerodynamic sound data is processed such that the distribution of frequency components of the aerodynamic sound (second aerodynamic sound) shifts toward lower frequencies as the distance between the object and the listener increases, the aerodynamic sound (second aerodynamic sound) that the listener hears in the virtual space becomes similar to the aerodynamic sound (second aerodynamic sound) that the listener hears in the real-world space, and more specifically, becomes a sound that reproduces the aerodynamic sound (second aerodynamic sound) in the real-world space. Therefore, the listener is less likely to feel a sense of incongruity and can experience a sense of realism. Stated differently, the acoustic signal processing method is capable of providing the listener with a sense of realism.

For example, the acoustic signal processing method according to a thirty-sixth aspect of the present disclosure is the acoustic signal processing method according to the thirty-fifth aspect, wherein the processing includes processing the aerodynamic sound data based on an ear-reaching wind speed, the ear-reaching wind speed being a speed of the first wind upon reaching the ear of the listener, and the ear-reaching wind speed decreases as the distance calculated increases.

Accordingly, since the aerodynamic sound data is processed based on the ear-reaching wind speed, the aerodynamic sound (second aerodynamic sound) that the listener hears in the virtual space becomes more similar to the aerodynamic sound (second aerodynamic sound) that the listener hears in the real-world space. Therefore, the listener is even less likely to feel a sense of incongruity and can experience an even greater sense of realism. Stated differently, the acoustic signal processing method is capable of providing the listener with a greater sense of realism.

For example, the acoustic signal processing method according to a thirty-seventh aspect of the present disclosure is the acoustic signal processing method according to the thirty-sixth aspect, wherein the ear-reaching wind speed is a value that attenuates according to a z-th power of a value obtained by dividing the distance calculated by the unit distance.

Accordingly, since a more accurate ear-reaching wind speed is calculated, the aerodynamic sound (second aerodynamic sound) that the listener hears in the virtual space becomes more similar to the aerodynamic sound (second aerodynamic sound) that the listener hears in the real-world space. Therefore, the listener is even less likely to feel a sense of incongruity and can experience an even greater sense of realism. Stated differently, the acoustic signal processing method is capable of providing the listener with a greater sense of realism.

For example, the acoustic signal processing method according to a thirty-eighth aspect of the present disclosure is the acoustic signal processing method according to the thirty-seventh aspect, wherein z=1.

Accordingly, since a more accurate ear-reaching wind speed is calculated, the aerodynamic sound (second aerodynamic sound) that the listener hears in the virtual space becomes more similar to the aerodynamic sound (second aerodynamic sound) that the listener hears in the real-world space. Therefore, the listener is even less likely to feel a sense of incongruity and can experience an even greater sense of realism. Stated differently, the acoustic signal processing method is capable of providing the listener with a greater sense of realism.

For example, the acoustic signal processing method according to a thirty-ninth aspect of the present disclosure is the acoustic signal processing method according to any one of the thirty-sixth to thirty-eighth aspects, wherein the processing includes processing the aerodynamic sound data to shift the distribution of the frequency components of the aerodynamic sound to a frequency scaled by a reciprocal of a value obtained by dividing the representative wind speed by the ear-reaching wind speed.

Accordingly, since a more accurate ear-reaching wind speed is calculated, the aerodynamic sound (second aerodynamic sound) that the listener hears in the virtual space becomes more similar to the aerodynamic sound (second aerodynamic sound) that the listener hears in the real-world space. Therefore, the listener is even less likely to feel a sense of incongruity and can experience an even greater sense of realism. Stated differently, the acoustic signal processing method is capable of providing the listener with a greater sense of realism.

An information generation method according to a fortieth aspect of the present disclosure includes: obtaining a second wind direction of a second wind blowing in a virtual space and a second assumed wind speed which is a speed of the second wind; generating fifth object audio information in which the second wind direction and the second assumed wind speed obtained are associated; storing aerodynamic sound core information including a representative wind speed and aerodynamic sound data indicating aerodynamic sound generated by wind blowing at the representative wind speed reaching an ear of a listener in the virtual space; and outputting the fifth object audio information generated and the aerodynamic sound core information stored.

With this, fifth object audio information in which the second wind direction and the second assumed wind speed are associated can be generated. When this fifth object audio information is used in the acoustic signal processing method, it can reproduce wind (natural wind blowing outdoors) whose source is not fixed, and as the aerodynamic sound data is processed irrespective of the position indicated by the second position information, the aerodynamic sound (second aerodynamic sound) caused by the second wind that the listener hears in the virtual space becomes similar to the aerodynamic sound (second aerodynamic sound) caused by the second wind that the listener hears in the real-world space, and more specifically, becomes a sound that reproduces the aerodynamic sound (second aerodynamic sound) caused by the second wind in the real-world space. Therefore, the listener is less likely to feel a sense of incongruity and can experience a sense of realism. Stated differently, the information generation method is capable of providing the listener with a sense of realism.

An information generation method according to a forty-first aspect of the present disclosure includes: obtaining a generation position of a first wind blowing in a virtual space, a first wind direction of the first wind, a first assumed wind speed which is a speed of the first wind, a second wind direction of a second wind blowing in the virtual space, and a second assumed wind speed which is a speed of the second wind; generating fourth object audio information in which the generation position, the first wind direction, and the first assumed wind speed obtained are associated, and generating fifth object audio information in which the second wind direction and the second assumed wind speed obtained are associated; and outputting the fourth object audio information generated and the fifth object audio information generated.

With this, fourth object audio information in which the generation position, the first wind direction, and the first assumed wind speed are associated, and fifth object audio information in which the second wind direction and the second assumed wind speed are associated can be generated, thereby enabling the generation of two types of wind in the same virtual space: wind whose source can be identified (such as electric fans, exhaust vents, wind holes, etc.) and wind whose source cannot be identified (such as naturally occurring breezes, storms, etc.). Furthermore, when this fourth object audio information is used in the acoustic signal processing method, as the aerodynamic sound data is processed based on the position indicated by the second position information, the aerodynamic sound (second aerodynamic sound) caused by the first wind that the listener hears in the virtual space becomes similar to the aerodynamic sound (second aerodynamic sound) caused by the first wind that the listener hears in the real-world space, and more specifically, becomes a sound that reproduces the aerodynamic sound (second aerodynamic sound) caused by the first wind in the real-world space. Furthermore, when this fifth object audio information is used in the acoustic signal processing method, as the aerodynamic sound data is processed irrespective of the position indicated by the second position information, the aerodynamic sound (second aerodynamic sound) caused by the second wind that the listener hears in the virtual space becomes similar to the aerodynamic sound (second aerodynamic sound) caused by the second wind that the listener hears in the real-world space, and more specifically, becomes a sound that reproduces the aerodynamic sound (second aerodynamic sound) caused by the second wind in the real-world space. Therefore, the listener is less likely to feel a sense of incongruity and can experience a sense of realism. Stated differently, the information generation method is capable of providing the listener with a sense of realism.

For example, the information generation method according to a forty-second aspect of the present disclosure is the information generation method according to the forty-first aspect, wherein in the outputting, the fourth object audio information generated is output when the generation position of the first wind is in the virtual space.

With this, the information generation method can determine whether or not to output the fourth object audio information based on the generation position.

For example, the information generation method according to a forty-third aspect of the present disclosure is the information generation method according to the forty-second aspect, wherein in the outputting, the fifth object audio information generated is output when the generation position of the first wind is not in the virtual space.

With this, the information generation method can determine whether or not to output the fifth object audio information based on the generation position.

For example, the information generation method according to a forty-fourth aspect of the present disclosure is the information generation method according to the forty-third aspect, further including: storing aerodynamic sound core information including a representative wind speed and aerodynamic sound data indicating aerodynamic sound generated by wind blowing at the representative wind speed reaching an ear of a listener in the virtual space, wherein the outputting includes outputting the aerodynamic sound core information stored.

Accordingly, when the aerodynamic sound data included in the output aerodynamic sound core information is used in the acoustic signal processing method, the aerodynamic sound core information can be commonly applied to the first wind and the second wind, thereby reducing the memory footprint for storing the aerodynamic sound core information. Moreover, the aerodynamic sound (second aerodynamic sound) caused by the first wind that the listener hears in the virtual space becomes similar to the aerodynamic sound (second aerodynamic sound) caused by the first wind that the listener hears in the real-world space, and the aerodynamic sound (second aerodynamic sound) caused by the second wind that the listener hears in the virtual space becomes similar to the aerodynamic sound (second aerodynamic sound) caused by the second wind that the listener hears in the real-world space. Therefore, the listener is less likely to feel a sense of incongruity and can experience a sense of realism. Stated differently, the information generation method is capable of providing the listener with a sense of realism.

For example, the information generation method according to a forty-fifth aspect of the present disclosure is the information generation method according to the forty-fourth aspect, further including: displaying an image in which wind speeds are associated with words expressing the wind speeds; and receiving, as the first assumed wind speed, a first operation specifying a wind speed included in the wind speeds indicated in the image displayed, and receiving, as the second assumed wind speed, a second operation specifying a wind speed included in the wind speeds indicated in the image displayed.

With this, the wind speed specified by the user can be utilized as the first assumed wind speed, and the wind speed specified by the user can be utilized as the second assumed wind speed.

For example, an acoustic signal processing method according to a forty-sixth aspect of the present disclosure includes: obtaining second position information indicating a position of the listener in the virtual space, and the fourth object audio information or the fifth object audio information output by an information generation method according to the forty-fourth aspect; when the fourth object audio information is obtained, processing the aerodynamic sound data included in the aerodynamic sound core information based on the position indicated by the second position information obtained, and when the fifth object audio information is obtained, processing the aerodynamic sound data included in the aerodynamic sound core information irrespective of the position indicated by the second position information obtained; and outputting the aerodynamic sound data processed.

With this, in the obtaining, fourth object audio information or fifth object audio information can be obtained. Accordingly, as the aerodynamic sound data is processed based on the position indicated by the second position information, the aerodynamic sound (second aerodynamic sound) caused by the first wind that the listener hears in the virtual space becomes similar to the aerodynamic sound (second aerodynamic sound) caused by the first wind that the listener hears in the real-world space, and more specifically, becomes a sound that reproduces the aerodynamic sound (second aerodynamic sound) caused by the first wind in the real-world space. Furthermore, as the aerodynamic sound data is processed irrespective of the position indicated by the second position information, the aerodynamic sound (second aerodynamic sound) caused by the second wind that the listener hears in the virtual space becomes similar to the aerodynamic sound (second aerodynamic sound) caused by the second wind that the listener hears in the real-world space, and more specifically, becomes a sound that reproduces the aerodynamic sound (second aerodynamic sound) caused by the second wind in the real-world space. Therefore, the listener is less likely to feel a sense of incongruity and can experience a sense of realism. Stated differently, the acoustic signal processing method is capable of providing the listener with a sense of realism.

A recording medium according to a forty-seventh aspect of the present disclosure is a non-transitory computer-readable recording medium for use in a computer, the recording medium having recorded thereon a program for causing the computer to execute an acoustic signal processing method described above.

Accordingly, the computer can execute the acoustic signal processing method described above in accordance with the computer program.

A recording medium according to a forty-eighth aspect of the present disclosure is a non-transitory computer-readable recording medium for use in a computer, the recording medium having recorded thereon a program for causing the computer to execute an information generation method described above.

Accordingly, the computer can execute the information generation method described above in accordance with the computer program.

An acoustic signal processing device according to a forty-ninth aspect of the present disclosure includes: a first obtainer that obtains object information and second position information, the object information including first position information indicating a position of an object in a virtual space, first sound data indicating a first sound caused by the object, and first identification information indicating a processing method for the first sound data, the second position information indicating a position of a listener of the first sound in the virtual space; a first calculator that calculates a distance between the object and the listener based on the first position information included in the object information obtained and the second position information obtained; a determiner that determines, based on the first identification information included in the object information obtained, a processing method among a first processing method and a second processing method to use to process the first sound data, the first processing method for processing a loudness according to the distance calculated, the second processing method for processing the loudness according to the distance calculated in a manner different from the first processing method; a first processor that processes the first sound data using the processing method determined; and a first outputter that outputs the first sound data processed.

Accordingly, since the processing method for the loudness of the first sound can be changed according to the first identification information, the first sound that the listener hears in the virtual space becomes similar to the first sound that the listener hears in the real-world space, and more specifically, becomes a sound that reproduces the first sound in the real-world space. Therefore, the listener is less likely to feel a sense of incongruity and can experience a sense of realism. Stated differently, the acoustic signal processing device is capable of providing the listener with a sense of realism.

Furthermore, these general or specific aspects may be implemented using a system, a device, a method, an integrated circuit, a computer program, or a non-transitory computer-readable recording medium such as a CD-ROM, or any combination thereof.

Hereinafter, embodiments will be described with reference to the drawings.

The embodiments described below each show a general or specific example. The numerical values, shapes, materials, elements, the arrangement and connection of the elements, steps, and the processing order of the steps, etc., described in the following embodiments are mere examples, and are therefore not intended to limit the scope of the claims.

In the following description, ordinal numbers such as first and second may be given to elements. These ordinal numbers are given to elements in order to distinguish between the elements, and thus do not necessarily correspond to an order that has intended meaning. Such ordinal numbers may be switched as appropriate, new ordinal numbers may be given, or the ordinal numbers may be removed.

The drawings are schematic diagrams, and are not necessarily precise depictions. Accordingly, scaling is not necessarily consistent throughout the drawings. In the drawings, the same reference numerals are given to substantially similar configurations, and repeated description thereof may be omitted or simplified.

In the present specification, terms indicating relationships between elements such as “perpendicular” or numerical ranges include, in addition to their exact meanings, substantially equivalent ranges, for example, with differences of about several percent.

### Embodiment

Examples of Devices to which an Acoustic Processing Technique or Encoding/Decoding Technique of the Present Disclosure can be Applied

### Three-Dimensional Sound Reproduction System

FIG. 5B illustrates three-dimensional sound (immersive audio) reproduction system A0000 as one example of a system to which the acoustic processing or decoding processing according to the present disclosure is applicable. Three-dimensional sound reproduction system A0000 includes acoustic signal processing device A0001 and audio presentation device A0002.

Acoustic signal processing device A0001 applies acoustic processing to an audio signal emitted by a virtual sound source to generate an acoustic-processed audio signal to be presented to a listener. The audio signal is not limited to speech and may be any audible sound. Acoustic processing is, for example, signal processing applied to the audio signal to reproduce one or a plurality of sound-related effects that sound generated from a sound source undergoes during the period from when the sound is emitted until the listener hears it. Acoustic signal processing device A0001 performs acoustic processing based on information describing factors that cause the aforementioned sound-related effects. The spatial information includes, for example, information indicating the positions of the sound source, listener, and surrounding objects, information indicating the shape of the space, and parameters related to sound propagation. Acoustic signal processing device A0001 is, for example, a personal computer (PC), smartphone, tablet, or game console.

The acoustic-processed signal is presented to the listener (user) from audio presentation device A0002. Audio presentation device A0002 is connected to acoustic signal processing device A0001 via wireless or wired communication. The acoustic-processed audio signal generated by acoustic signal processing device A0001 is transmitted to audio presentation device A0002 via wireless or wired communication. When audio presentation device A0002 is configured as a plurality of devices, such as a device for the right ear and a device for the left ear, the plurality of devices present sound in n synchronization by communicating between the plurality of devices or between each of the plurality of devices and acoustic signal processing device A0001. Audio presentation device A0002 is, for example, headphones worn on the listener's head, earphones, a head-mounted display, or surround speakers configured with a plurality of fixed loudspeakers.

Three-dimensional sound reproduction system A0000 may be used in combination with an image presentation device or stereoscopic image presentation device that provides an Extended Reality (ER) experience, including AR/VR, visually.

Although FIG. 5B illustrates a system configuration example in which acoustic signal processing device A0001 and audio presentation device A0002 are separate devices, the three-dimensional sound reproduction system to which the acoustic signal processing method or decoding method according to the present disclosure is applicable is not limited to the configuration of FIG. 5B. For example, acoustic signal processing device A0001 may be included in audio presentation device A0002, and audio presentation device A0002 may perform both acoustic processing and sound presentation. The acoustic processing described in the present disclosure may be divided between acoustic signal processing device A0001 and audio presentation device A0002 and performed, or a server connected via a network to acoustic signal processing device A0001 or audio presentation device A0002 may perform part or all of the acoustic processing described in the present disclosure.

Although the naming “acoustic signal processing device” A0001 is used in the above description, when acoustic signal processing device A0001 performs acoustic processing by decoding a bitstream generated by encoding at least a portion of data of an audio signal or spatial information used for acoustic processing, acoustic signal processing device A0001 may be called a decoding device.

### Encoding Device Example

FIG. 5C is a functional block diagram illustrating the configuration of encoding device A0100, which is one example of an encoding device of the present disclosure.

Input data A0101 is data to be encoded that includes spatial information and/or an audio signal to be input to encoder A0102. Spatial information will be described in detail later.

Encoder A0102 encodes input data A0101 to generate encoded data A0103. Encoded data A0103 is, for example, a bitstream generated by the encoding process.

Memory A0104 stores encoded data A0103. Memory A0104 may be, for example, a hard disk or a solid-state drive (SSD), or may be any other type of memory.

Although a bitstream generated by the encoding process was given as one example of encoded data A0103 stored in memory A0104 in the above description, encoded data A0103 may be data other than a bitstream. For example, encoding device A0100 may store, in memory A0104, converted data generated by converting the bitstream into a predetermined data format. The converted data may be, for example, a file storing one or a plurality of bitstreams or a multiplexed stream. Here, the file is, for example, a file having a file format such as ISO Base Media File Format (ISOBMFF). Encoded data A0103 may be in the form of a plurality of packets generated by dividing the above-mentioned bitstream or file. When the bitstream generated by encoder A0102 is to be converted into data different from the bitstream, encoding device A0100 may include a converter not shown in the figure, or may perform the conversion process using a central processing unit (CPU).

### Decoding Device Example

FIG. 5D is a functional block diagram illustrating the configuration of decoding device A0110, which is one example of a decoding device of the present disclosure.

Memory A0114 stores, for example, the same data as encoded data A0103 generated by encoding device A0100. Memory A0114 reads the stored data and inputs it as input data A0113 to decoder A0112. Input data A0113 is, for example, a bitstream to be decoded. Memory A0114 may be, for example, a hard disk or a SSD, or may be any other type of memory.

Decoding device A0110 may use, as input data A0113, converted data generated by converting the data read from memory A0114, rather than directly using the data stored in memory A0114 as input data A0113. The data before conversion may be, for example, multiplexed data storing one or a plurality of bitstreams. Here, the multiplexed data may be, for example, a file having a file format such as ISOBMFF. The data before conversion may be in the form of a plurality of packets generated by dividing the above-mentioned bitstream or file. When converting data different from the bitstream read from memory A0114 into a bitstream, decoding device A0110 may include a converter not shown in the figure, or may perform the conversion process using a CPU.

Decoder A0112 decodes input data A0113 to generate audio signal A0111 to be presented to a listener.

### Another Example of Encoding Device

FIG. 5E is a functional block diagram illustrating the configuration of encoding device A0120, which is another example of an encoding device of the present disclosure. In FIG. 5E, configurations having the same functions as those in FIG. 5C are given the same reference numerals as in FIG. 5C, and explanations of these configurations are omitted.

Encoding device A0120 differs from encoding device A0100 in that while encoding device A0100 stored encoded data A0103 in memory A0104, encoding device A0120 includes transmitter A0121 that transmits encoded data A0103 to an external destination.

Transmitter A0121 transmits transmission signal A0122 to another device or server based on encoded data A0103 or data in another data format generated by converting encoded data A0103. The data used for generating transmission signal A0122 is, for example, the bitstream, multiplexed data, file, or packet explained in regard to encoding device A0100.

### Another Example of Decoding Device

FIG. 5F is a functional block diagram illustrating the configuration of decoding device A0130, which is another example of a decoding device of the present disclosure. In FIG. 5F, configurations having the same functions as those in FIG. 5D are given the same reference numerals as in FIG. 5D, and explanations of these configurations are omitted.

Decoding device A0130 differs from decoding device A0110 in that while decoding device A0110 read input data A0113 from memory A0114, decoding device A0130 includes receiver A0131 that receives input data A0113 from an external source.

Receiver A0131 receives reception signal A0132 thereby obtaining reception data, and outputs input data A0113 to be input to decoder A0112. The reception data may be the same as input data A0113 input to decoder A0112, or may be data in a data format different from input data A0113. When the reception data is data in a data format different from input data A0113, receiver A0131 may convert the reception data to input data A0113, or a converter not shown in the figure or a CPU included in decoding device A0130 may convert the reception data to input data A0113. The reception data is, for example, the bitstream, multiplexed data, file, or packet explained in regard to encoding device A0120.

### Explanation of Functions of Decoder

FIG. 5G is a functional block diagram illustrating the configuration of decoder A0200, which is one example of decoder A0112 in FIG. 5D or FIG. 5F.

Input data A0113 is an encoded bitstream and includes encoded audio data, which is an encoded audio signal, and metadata used for acoustic processing.

Spatial information manager A0201 obtains metadata included in input data A0113, and analyzes the metadata. The metadata includes information describing elements that act on sounds arranged in a sound space. Spatial information manager A0201 manages spatial information necessary for acoustic processing obtained by analyzing the metadata, and provides the spatial information to renderer A0203. Note that in the present disclosure, information used for acoustic processing is referred to as spatial information, but it may be referred to by other names. The information used for said acoustic processing may be referred to as, for example, sound space information or scene information used for acoustic processing. When the information used for acoustic processing changes over time, the spatial information input to renderer A0203 may be referred to as a spatial state, a sound space state, a scene state, or the like.

The spatial information may be managed for each sound space or for each scene. For example, when expressing different rooms as virtual spaces, each room may be managed as a scene of a different sound space, or even for the same space, spatial information may be managed as different scenes according to the scene being expressed. In the management of spatial information, an identifier for identifying each item of spatial information may be assigned. The spatial information data may be included in a bitstream, which is a form of input data, or the bitstream may include an identifier of the spatial information, and the spatial information data may be obtained from somewhere other than from the bitstream. When the bitstream includes only the identifier of the spatial information, at the time of rendering, the spatial information data stored in the memory of acoustic signal processing device A0001 or in an external server may be obtained as input data using the identifier of the spatial information.

Note that the information managed by spatial information manager A0201 is not limited to information included in the bitstream. For example, input data A0113 may include data indicating characteristics or structure of a space obtained from a VR or AR software application or server as data not included in the bitstream. For example, input data A0113 may include data indicating characteristics or a position of a listener or object as data not included in the bitstream. Input data A0113 may include information obtained by a sensor included in a terminal that includes the decoding device as information indicating the position of the listener, or information indicating the position of the terminal estimated based on information obtained by the sensor. That is, spatial information manager A0201 may communicate with an external system or server and obtain spatial information and the position of the listener. Spatial information manager A0201 may obtain clock synchronization information from an external system and execute a process to synchronize with the clock of renderer A0203. The space in the above explanation may be a virtually formed space, that is, a VR space, or it may be a real-world space (i.e., an actual space) or a virtual space corresponding to a real-world space, that is, an AR space or a mixed reality (MR) space. The virtual space may also be called a sound field or sound space. The information indicating position in the above explanation may be information such as coordinate values indicating a position in space, information indicating a relative position with respect to a predetermined reference position, or information indicating movement or acceleration of a position in space.

Audio data decoder A0202 decodes encoded audio data included in input data A0113 to obtain an audio signal.

The encoded audio data obtained by three-dimensional sound reproduction system A0000 is, for example, a bitstream encoded in a predetermined format such as MPEG-H 3D Audio (ISO/IEC 23008-3). Note that MPEG-H 3D Audio is merely one example of an encoding method that can be used when generating encoded audio data to be included in the bitstream, and the bitstream may include encoded audio data encoded using other encoding methods. For example, the encoding method used may be a lossy codec such as MPEG-1 Audio Layer-3 (MP3), Advanced Audio Coding (AAC), Windows Media Audio (WMA), Audio Codec-3 (AC3), or Vorbis, or a lossless codec such as Apple Lossless Audio Codec (ALAC) or Free Lossless Audio Codec (FLAC), or any other arbitrary encoding method not mentioned above. For example, pulse code modulation (PCM) data may be considered as a type of encoded audio data. In such cases, the decoding process may, for example, when the number of quantization bits of the PCM data is N, convert the N-bit binary number into a numerical format (for example, floating-point format) that can be processed by renderer A0203.

Renderer A0203 receives an audio signal and spatial information as inputs, applies acoustic processing to the audio signal using the spatial information, and outputs acoustic-processed audio signal A0111.

Before starting rendering, spatial information manager A0201 reads metadata of the input signal, detects rendering items such as objects or sounds specified by the spatial information, and transmits the detected rendering items to renderer A0203. After rendering starts, spatial information manager A0201 obtains the temporal changes in the spatial information and the listener's position, and updates and manages the spatial information. Spatial information manager A0201 then transmits the updated spatial information to renderer A0203. Renderer A0203 generates and outputs an audio signal with acoustic processing added based on the audio signal included in the input data and the spatial information received from spatial information manager A0201.

The update processing of the spatial information and the output processing of the audio signal added with acoustic processing may be executed in the same thread, or spatial information manager A0201 and renderer A0203 may be allocated to respective independent threads. When the update processing of the spatial information and the output processing of the audio signal added with acoustic processing are processed in different threads, the activation frequency of the threads may be set individually, or the processing may be executed in parallel.

By executing processing in different independent threads for spatial information manager A0201 and renderer A0203, computational resources can be preferentially allocated to renderer A0203, allowing for safe implementation even in cases of sound output processing where even slight delays cannot be tolerated, for example, sound output processing where a popping noise occurs if there is a delay of even one sample (0.02 msec). In this case, allocation of computational resources to spatial information manager A0201 is restricted. However, the update of spatial information (for example, a process such as updating the direction of the listener's face) is a process that is performed at a low frequency compared to the output processing of the audio signal. Therefore, since responding instantaneously is not necessarily required unlike the output processing of the audio signal, restricting the allocation of computational resources does not significantly affect the acoustic quality provided to the listener.

The update of spatial information may be executed periodically at predetermined times or intervals, or may be executed when predetermined conditions are met. The update of spatial information may be executed manually by the listener or the manager of the sound space, or execution may be triggered by changes in an external system. For example, when the listener operates a controller to instantly warp the position of their avatar, rapidly advance or rewind time, or when the manager of the virtual space suddenly changes the environment of the scene as a production effect, the thread in which spatial information manager A0201 is arranged may be activated as a one-time interrupt process in addition to periodic activation.

The role of the information update thread that executes the update processing of spatial information includes, for example, processing to update the position or orientation of the listener's avatar in the virtual space based on the position or orientation of the VR goggles worn by the listener, and updating the position of objects moving within the virtual space, and is handled within a processing thread that activates at a relatively low frequency of approximately several tens of Hz. Such processing that reflects the nature of direct sound may be performed in processing threads with low occurrence frequency. This is because the frequency at which the nature of direct sound changes is lower than the frequency of occurrence of audio processing frames for audio output. By doing so, the computational load of the processing can be relatively reduced, and the risk of pulsive noise occurring due to unnecessarily frequent information updates can be avoided.

FIG. 5H is a functional block diagram illustrating the configuration of decoder A0210, which is another example of decoder A0112 in FIG. 5D or FIG. 5F.

FIG. 5H differs from FIG. 5G in that input data A0113 includes an unencoded audio signal rather than encoded audio data. Input data A0113 includes an audio signal and a bitstream including metadata.

Spatial information manager A0211 is the same as spatial information manager A0201 in FIG. 5G, so repeated explanation is omitted.

Renderer A0213 is the same as renderer A0203 in FIG. 5G, so repeated explanation is omitted.

Note that while the configuration in FIG. 5H is referred to as a decoder in the above description, it may also be called an acoustic processor that performs acoustic processing. A device including an acoustic processor may be called an acoustic processing device rather than a decoding device. Acoustic signal processing device A0001 may be called an acoustic processing device.

### Physical Configuration of Acoustic Signal Processing Device

FIG. 5I illustrates one example of a physical configuration of an acoustic signal processing device. The acoustic signal processing device in FIG. 5I may be a decoding device. A portion of the configuration described here may be included in audio presentation device A0002. The acoustic signal processing device illustrated in FIG. 5I is one example of the above-mentioned acoustic signal processing device A0001.

The acoustic signal processing device in FIG. 5I includes a processor, memory, a communication I/F, a sensor, and a loudspeaker.

The processor is, for example, a central processing unit (CPU) or digital signal processor (DSP) or graphics processing unit (GPU), and the acoustic processing or decoding processing of the present disclosure may be performed by the CPU or DSP or GPU executing a program stored in the memory. The processor may be a dedicated circuit that performs signal processing on audio signals, including the acoustic processing of the present disclosure.

The memory includes, for example, random access memory (RAM) or read-only memory (ROM). The memory may include magnetic storage media such as a hard disks or semiconductor memories such as solid state drives (SSDs). The memory may include internal memory incorporated in the CPU or GPU.

The communication interface (I/F) is, for example, a communication module that supports a communication method such as Bluetooth (registered trademark) or WiGig (registered trademark). The acoustic signal processing device illustrated in FIG. 5I includes a function to communicate with other communication devices via the communication I/F, and obtains a bitstream to be decoded. The obtained bitstream is, for example, stored in the memory.

The communication module includes, for example, a signal processing circuit that supports the communication method, and an antenna. In the above example, Bluetooth (registered trademark) or WiGig (registered trademark) were given as examples of the communication method, but the supported communication method may be Long Term Evolution (LTE), New Radio (NR), or Wi-Fi (registered trademark). The communication I/F may also be a wired communication method such as Ethernet (registered trademark), Universal Serial Bus (USB), or High-Definition Multimedia Interface (HDMI) (registered trademark), rather than the wireless communication methods described above.

The sensor performs sensing to estimate the position or orientation of the listener. More specifically, the sensor estimates the position and/or orientation of the listener based on one or more detection results of one or more of the position, orientation, movement, velocity, angular velocity, or acceleration of a part or all of the listener's body, such as the listener's head, and generates position information indicating the position and/or orientation of the listener. The position information may be information indicating the position and/or orientation of the listener in real-world space, or may be information indicating the displacement of the position and/or orientation of the listener with respect to the position and/or orientation of the listener at a predetermined time point. The position information may be information indicating a position and/or orientation relative to the three-dimensional sound reproduction system or an external device including the sensor.

The sensor may be, for example, an imaging device such as a camera or a distance measuring device such as a light detection and ranging (LIDAR) distance measuring device, and may capture an image of the movement of the listener's head and detect the movement of the listener's head by processing the captured image. As the sensor, a device that performs position estimation using radio waves in any given frequency band such as millimeter waves may be used.

The acoustic signal processing device illustrated in FIG. 5I may obtain position information via the communication I/F from an external device including a sensor. In such cases, the acoustic signal processing device need not include a sensor. Here, an external device refers to, for example, audio presentation device A0002 described in FIG. 5B, or a stereoscopic image reproduction device worn on the listener's head. In this case, the sensor is configured as a combination of various sensors, such as a gyro sensor and an acceleration sensor, for example.

As the speed of the movement of the listener's head, the sensor may detect, for example, the angular speed of rotation about at least one of three mutually orthogonal axes in the sound space as the axis of rotation or the acceleration of displacement in at least one of the three axes as the direction of displacement.

As the amount of the movement of the listener's head, the sensor may detect, for example, the amount of rotation about at least one of three mutually orthogonal axes in the sound space as the axis of rotation or the amount of displacement in at least one of the three axes as the direction of displacement. More specifically, sensor detects 6DoF (position (x, y, z) and angle (yaw, pitch, roll)) as the position of the listener. The sensor is configured as a combination of various sensors used for detecting movement, such as a gyro sensor and an acceleration sensor.

A sensor may be implemented by any device, such as a camera or a Global Positioning System (GPS) receiver, as long as it can detect the position of the listener. Position information obtained by performing self-localization estimation using laser imaging detection and ranging (LiDAR) or the like may be used. For example, when the audio signal reproduction system is implemented by a smartphone, the sensor is included in the smartphone.

The sensor may include a temperature sensor such as a thermocouple that detects the temperature of the acoustic signal processing device illustrated in FIG. 5I, and a sensor that detects the remaining level of a battery included in or connected to the acoustic signal processing device.

The loudspeaker includes, for example, a diaphragm, a driving mechanism such as a magnet or voice coil, and an amplifier, and presents the acoustic-processed audio signal as sound to the listener. The loudspeaker operates the driving mechanism according to the audio signal (more specifically, a waveform signal indicating the waveform of the sound) amplified via the amplifier, and vibrates the diaphragm by means of the driving mechanism. In this way, the diaphragm vibrating according to the audio signal generates sound waves, which propagate through the air and are transmitted to the listener's ears, allowing the listener to perceive the sound.

Although in this example, the acoustic signal processing device illustrated in FIG. 5I includes a loudspeaker and provides the acoustic-processed audio signal via the loudspeaker, the means for providing the audio signal is not limited to the this configuration. For example, the acoustic-processed audio signal may be output to external audio presentation device A0002 connected via a communication module. The communication performed by the communication module may be wired or wireless. As another example, the acoustic signal processing device illustrated in FIG. 5I may include a terminal that outputs an analog audio signal, and may present the audio signal from earphones or the like by connecting the earphone cable to the terminal. In this case, audio presentation device A0002, such as headphones, earphones, a head-mounted display, neck speakers, wearable speakers worn on the listener's head or a part of the body, or surround speakers configured with a plurality of fixed speakers, reproduces the audio signal.

### Physical Configuration of Encoding Device

FIG. 5J illustrates one example of a physical configuration of an encoding device. The encoding device illustrated in FIG. 5J is one example of the above-mentioned encoding devices A0100 and A0120.

The encoding device in FIG. 5J includes a processor, memory, and a communication I/F.

The processor is, for example, a central processing unit (CPU) or digital signal processor (DSP), and the encoding processing of the present disclosure may be performed by the CPU or DSP executing a program stored in the memory. The processor may be a dedicated circuit that performs signal processing on audio signals, including the encoding processing of the present disclosure.

The memory includes, for example, random access memory (RAM) or read-only memory (ROM). The memory may include magnetic storage media such as a hard disks or semiconductor memories such as solid state drives (SSDs). The memory may include internal memory incorporated in the CPU or GPU.

The communication interface (I/F) is, for example, a communication module that supports a communication method such as Bluetooth (registered trademark) or WiGig (registered trademark). The encoding device includes a function to communicate with other communication devices via the communication I/F, and transmits an encoded bitstream.

The communication module includes, for example, a signal processing circuit that supports the communication method, and an antenna. In the above example, Bluetooth (registered trademark) or WiGig (registered trademark) were given as examples of the communication method, but the supported communication method may be Long Term Evolution (LTE), New Radio (NR), or Wi-Fi (registered trademark). The communication I/F may also be a wired communication method such as Ethernet (registered trademark), Universal Serial Bus (USB), or High-Definition Multimedia Interface (HDMI) (registered trademark), rather than the wireless communication methods described above.

### Configuration

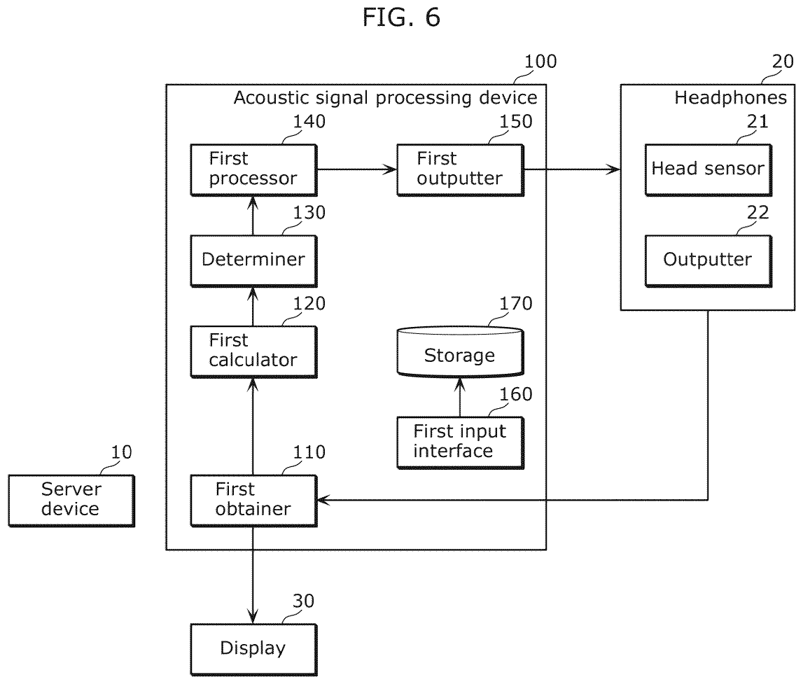

First, a configuration of acoustic signal processing device 100 according to an embodiment of the present disclosure will be described. FIG. 6 is a block diagram illustrating the functional configuration of acoustic signal processing device 100 according to the present embodiment.

Acoustic signal processing device 100 according to the present embodiment is for processing and outputting first sound data indicating a first sound caused by an object in a virtual space (sound reproduction space). Acoustic signal processing device 100 according to the present embodiment is for various applications in a virtual space, such as virtual reality or augmented reality (VR/AR) applications.

The “object in a virtual space” is not particularly limited; it is sufficient if it is included in content to be displayed on display 30 that displays content (video in this example) executed in the virtual space. The object is a moving object, examples of which include an animal, a plant, and an artificial or natural object. Examples of objects representing artificial objects include vehicles, bicycles, and aircraft. Examples of the artificial object include sports equipment, such as a baseball bat and a tennis racket; furniture, such as a desk, a chair, an electric fan, and a wall clock; and a building, such as an apartment complex and a commercial facility. Note that the object is, as an example, at least one that can move or one that can be moved in the content, but is not limited thereto. Note that electric fan F illustrated in FIG. 3 and FIG. 4A is placed on the floor, and even if electric fan F itself does not move, the blades of electric fan F move (rotate). Such electric fan F is also included in the object.

The first sound is a sound caused by the object. For example, the first sound is a sound generated by the object. The first sound will be described in greater detail hereinafter.

One example of the first sound according to the present embodiment is an aerodynamic sound (wind noise) generated accompanying the movement of the object in a virtual space, and is a first aerodynamic sound. Wind noise is a sound indicating vortex shedding generated when wind W collides with the object.

One example of the first sound according to the present embodiment is an aerodynamic sound (second aerodynamic sound) generated by wind W radiated from the object in a virtual space reaching an ear of listener L. The second aerodynamic sound is a sound generated when wind W caused by the object, electric fan F, reaches listener L, according to, for example, the shape of the ears of listener L. More specifically, the second aerodynamic sound is the sound caused by wind W generated by the movement of air due to the movement of the object.

Acoustic signal processing device 100 generates first sound data indicating a first sound in a virtual space, and outputs the first sound data to headphones 20.

Next, headphones 20 will be described.

Headphones 20 serve as a device that reproduces the first sound, that is, an audio output device. More specifically, headphones 20 reproduce the first sound based on the first sound data output by acoustic signal processing device 100. This allows listener L to listen to the first sound. Instead of headphones 20, another output channel, such as a loudspeaker, may be used.

As illustrated in FIG. 6, headphones 20 include head sensor 21 and outputter 22.

Head sensor 21 senses the position of listener L determined by coordinates on a horizontal plane and the height in the vertical direction in the virtual space, and outputs, to acoustic signal processing device 100, second position information indicating the position of listener L for the first sound in the virtual space.

Head sensor 21 may sense information of six degrees of freedom (6DoF) of the head of listener L. For example, head sensor 21 may be an inertial measurement unit (IMU), an accelerometer, a gyroscope, or a magnetic sensor, or a combination of these.

Outputter 22 is a device that reproduces a sound that reaches listener L in a sound reproduction space. More specifically, outputter 22 reproduces the first sound based on first sound data indicating the first sound processed by acoustic signal processing device 100 and output from acoustic signal processing device 100.

Next, display 30 will be described.

Display 30 is a display device that displays content (e.g., a video) including an object in a virtual space. The process for display 30 to display the content will be described later. Display 30 is, for example, a display panel, such as a liquid crystal panel or an organic electroluminescence (EL) panel.

Further, acoustic signal processing device 100 illustrated in FIG. 6 will be described.

As illustrated in FIG. 6, acoustic signal processing device 100 includes first obtainer 110, first calculator 120, determiner 130, first processor 140, first outputter 150, first input interface 160, and storage 170.

First obtainer 110 obtains object information and second position information. The object information is information related to the object, which includes first position information indicating the position of the object in the virtual space, first sound data indicating a first sound caused by the object, and first identification information indicating a processing method for the first sound data. Note that the object information may include geometry information indicating the shape of the object. The second position information indicates, as described above, the position of listener L in a virtual space. First obtainer 110 may obtain, for example, object information and second position information from an input signal, or may obtain object information and second position information from a source other than the input signal. The input signal will be described below.

The input signal includes, for example, spatial information, sensor information, and sound data (audio signal). The above information and sound data may be included in one input signal, or the above-mentioned information and sound data may be included in a plurality of separate signals. The input signal may include a bitstream including sound data and metadata (control information), and in such cases, the metadata may include spatial information and information for identifying the sound data.

The first position information, second position information, geometry information, and flag information explained above may be included in the input signal. More specifically, the first information, geometry information, and flag information may be included in the spatial information, and the second information may be generated based on information obtained from sensor information. The sensor information may be obtained from head sensor 21, or may be obtained from another external device.

The spatial information is information related to the sound space (three-dimensional sound field) created by the three-dimensional sound reproduction system, and includes information about objects included in the sound space and information about the listener. The objects include sound source objects that emit t sound and become sound sources, and non-sound-emitting objects that do not emit sound. The non-sound-emitting object functions as an obstacle object that reflects sound emitted by the sound source object, but a sound source object may also function as an obstacle object that reflects sound emitted by another sound source object. The obstacle object may also be called a reflection object.

Information commonly assigned to both sound source objects and non-sound-emitting objects includes position information, geometry information, and attenuation rate of loudness when the object reflects sound.

The position information is represented by coordinate values of three axes, for example, the X-axis, the Y-axis, and the Z-axis of Euclidean space, but it does not necessarily have to be three-dimensional information. The position information may be, for example, two-dimensional information represented by coordinate values of two axes, the X-axis and the Y-axis. The position information of the object is defined by a representative position of the shape expressed by a mesh or voxel.

The geometry information may include information about the material of the surface.

The attenuation rate may be expressed as a real number less than or equal to 1 and greater than or equal to 0, or may be expressed as a negative decibel value. Since loudness does not increase from reflection in real-world space, the attenuation rate is set to a negative decibel value. However, for example, to create an eerie atmosphere in a non-realistic space, an attenuation rate greater than or equal to 1, that is, a positive decibel value, may be intentionally set. The attenuation rate may be set to different values for each of a plurality of frequency bands, or may be set independently for each frequency band. In cases where the attenuation rate is set for each type of material of the object surface, a value of the corresponding attenuation rate may be used based on information about the surface material.

Information commonly assigned to both sound source objects and non-sound-emitting objects may include information indicating whether the object belongs to an animate thing or information indicating whether the object is a mobile body. When the object is a mobile body, the position information may move over time, and the changed position information or the amount of change is transmitted to renderers A0203 and A0213.

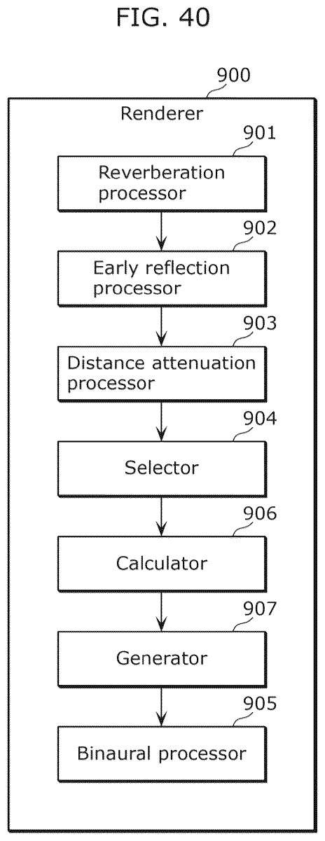

Information related to the sound source object includes, in addition to the information commonly assigned to both sound source objects and non-sound-emitting objects mentioned above, sound data and information necessary for radiating the sound data into the sound space. The sound data is data representing sound perceived by the listener, indicating information such as the frequency and intensity of the sound. The sound data is typically a PCM signal, but may also be data compressed using an encoding method such as MP3. In such cases, since the signal needs to be decoded at least before reaching the generator (generator 907 to be described later with reference to FIG. 40), renderers A0203 and A0213 may include a decoder (not illustrated). Alternatively, the signal may be decoded in audio data decoder A0202.

At least one item of sound data may be set for one sound source object, and a plurality of items of sound data may be set. Identification information for identifying each item of sound data may be assigned, and as information related to the sound source object, the identification information of the sound data may be retained as metadata.

As information necessary for radiating sound data into the sound space, for example, information on a reference loudness that serves as a standard when reproducing the sound data, information related to the position of the sound source object, information related to the orientation of the sound source object, and information related to the directivity of the sound emitted by the sound source object may be included.

The information on the reference loudness may be, for example, the root mean square value of the amplitude of the sound data at the sound source position when radiating the sound data into the sound space, and may be expressed as a floating-point decibel (dB) value. For example, when the reference loudness is 0 dB, the information on the reference loudness may indicate that the sound is to be radiated into the sound space from the position indicated by the above-mentioned position information at the same loudness, without increasing or decreasing it, of the signal level indicated by the sound data. The information on the reference loudness may indicate that, when it is −6 dB, the sound is to be radiated into the sound space from the position indicated by the above-mentioned position information at approximately half the loudness of the signal level indicated by the sound data. The information on the reference loudness may be assigned to a single item of sound data or collectively to a plurality of items of sound data.

For example, information indicating time-series variations in the loudness of the sound source may be included as information on loudness included in the information necessary for radiating sound data into the sound space. For example, when the sound space is a virtual conference room and the sound source is a speaker, the loudness transitions intermittently over short periods of time. Expressing it even more simply, it can also be said that sound portions and silent portions occur alternately. When the sound space is a concert hall and the sound source is a performer, the loudness is maintained for a certain duration of time. When the sound space is a battlefield and the sound source is an explosive, the loudness of the explosion sound becomes large for only an instant and then continues to be silent thereafter. In this way, the loudness information of the sound source includes not only information on the magnitude of sound but also information on the transition of sound magnitude, and such information may be used as information indicating the characteristics of the sound data.

Here, the information on the transition of sound magnitude may be data showing frequency characteristics in chronological order. The information on the transition of sound magnitude may be data indicating the duration of a sound interval. The information on the transition of sound magnitude may be data indicating the chronological sequence of durations of sound intervals and silent intervals. The information on the transition of sound magnitude may be data that enumerates, in chronological order, a plurality of sets of data including a duration during which the amplitude of the sound signal can be considered stationary (can be considered approximately constant) and the amplitude value of said signal during that duration. The information on the transition of sound magnitude may be data of a duration during which the frequency characteristics of the sound signal can be considered stationary. The information on the transition of sound magnitude may be data that enumerates, in chronological order, a plurality of sets of data including a duration during which the frequency characteristics of the sound signal can be considered stationary and the frequency characteristic data during that duration. The information on the transition of sound magnitude may be in the format of, for example, data indicating the general shape of a spectrogram. The loudness that serves as the standard for the above-mentioned frequency characteristics may be used as the reference loudness. The information indicating the reference loudness and the information indicating the characteristics of the sound data may be used not only to calculate the loudness of direct sound or reflected sound to be perceived by the listener, but also for selection processing for selecting whether or not to make the listener perceive the sound.

Information regarding orientation is typically expressed in terms of yaw, pitch, and roll. Alternatively, the orientation information may be expressed in terms of azimuth (yaw) and elevation (pitch), omitting the rotation of roll. The orientation information may change over time, and when changed, it is transmitted to renderers A0203 and A0213.

Information related to the listener is information regarding the position information and orientation of the listener in the sound space. The position information is represented by the position on the X, Y, and Z-axes of Euclidean space, but it does not necessarily have to be three-dimensional information and may be two-dimensional information. Information regarding orientation is typically expressed in terms of yaw, pitch, and roll. Alternatively, the orientation information may be expressed in terms of azimuth (yaw) and elevation (pitch), omitting the rotation of roll. The position information and orientation information may change over time, and when changed, they are transmitted to renderers A0203 and A0213.

The sensor information includes the rotation amount or displacement amount detected by the sensor worn by the listener, and the position and orientation of the listener. The sensor information is transmitted to renderers A0203 and A0213, and renderers A0203 and A0213 update the information on the position and orientation of the listener based on the sensor information. The sensor information may use position information obtained by performing self-localization estimation by a mobile terminal using the global positioning system (GPS), a camera, or laser imaging detection and ranging (LIDAR), for example. Information obtained from outside through a communication module, other than from a sensor, may also be detected as sensor information. Information indicating the temperature of acoustic signal processing device 100, and information indicating the remaining level of the battery may be obtained as sensor information from the sensor. Information indicating the computational resources (CPU capability, memory resources, PC performance) of acoustic signal processing device 100 or audio presentation device A0002 may be obtained in real time as sensor information.

In the present embodiment, first obtainer 110 obtains the object information from storage 170, but first obtainer 110 is not limited to this example. For example, first obtainer 110 may obtain the object information from a device (for example, server device 10, such as a cloud server) other than acoustic signal processing device 100. First obtainer 110 also obtains the second position information from headphones 20 (head sensor 21, more specifically). The source is however not limited thereto.

Next, the information included in the object information will be described.

First, the first position information will be described.

As described above, an “object in a virtual space” is included in “content (e.g. a video) to be displayed on display 30” and is at least one of an object that can move or an object that can be moved in the content. For example, the object in the virtual space is bat B illustrated in FIG. 1.

The first position information indicates where in the virtual space bat B is located at a certain time point. In the virtual space, bat B may move as a result of being swung. To address this, first obtainer 110 obtains the first position information continuously. First obtainer 110, for example, obtains the first position information each time the spatial information is updated by spatial information managers A0201 and A0211.

Further, the first sound data indicating the first sound will be described.

The sound data including the first sound data described in the present specification may be, but is not limited to, a sound signal such as pulse code modulation (PCM) data; the sound data may be any information indicating the characteristics of sound.

As one example, assuming the sound signal is a noise signal with a loudness of X decibels, the sound data related to that sound data may be the PCM data itself indicating that sound signal, or may be data consisting of information indicating that the component is a noise signal and information indicating that the loudness is X decibels. As another example, assuming the sound signal is a noise signal with a predetermined characteristic of Peak/Dip in frequency components, the sound data related to that sound data may be the PCM data itself indicating that sound signal, or may be data consisting of information indicating that the component is a noise signal and information indicating Peak/Dip of the frequency components.

Note that in the present specification, a sound signal based on sound data means PCM data indicating that sound data.

Next, the first identification information will be described.

The first identification information indicates a processing method for the first sound data. Stated differently, according to the present embodiment, a first processing method and a second processing method are provided as processing methods for the first sound data. The first processing method and the second processing method are both methods for processing the loudness of the first sound indicated by the first sound data, and they process the first sound data in mutually different manners. The first identification information indicates that the processing method for the first sound data is the first processing method, the second processing method, or both the first processing method and the second processing method.

The processing method indicated by the first identification information is determined in advance in accordance with the object indicated by the first identification information. For example, what processing method the first identification information indicates is determined in advance by a creator of the content (i.e., the video) displayed on display 30.

Next, the geometry information will be described.

The geometry information indicates the shape of the object (for example, bat B) in the virtual space. The geometry information indicates the shape of the object, more specifically, the three-dimensional shape of the object as a rigid body. The shape of the object is, for example, represented by a sphere, a rectangular parallelepiped, a cube, a polyhedron, a cone, a pyramid, a cylinder, or a prism alone or in combination. Note that the geometry information may be expressed, for example, by mesh data, or by voxels, point groups in three dimensions, or a set of planes formed of vertices with three-dimensional coordinates.

Note that the first position information includes object identification information for identifying the object. The first identification information also includes object identification information for identifying the object. The geometry information also includes object identification information for identifying the object.

Assume that first obtainer 110 obtains the first position information, first sound data, first identification information, and geometry information independently from each other. Even in this case, the object identification information included in each of the first position information, first sound data, first identification information, and geometry information is referred to so as to identify the objects indicated by the first position information, first sound data, first identification information, and geometry information. For example, the objects indicated by each of the first position information, first sound data, first identification information, and geometry information can be here easily identified as the same bat B. That is, four sets of object identification information of the first position information, first sound data, first identification information, and geometry information obtained by first obtainer 110 are referred to so as to clarify that the first position information, first sound data, first identification information, and geometry information are related to bat B. Accordingly, the first position information, first sound data, first identification information, and geometry information are associated as information indicating bat B.

Next, the second position information will be described.

Listener L can move in the virtual space. The second position information indicates where in the virtual space listener L is located at a certain time point. Note that since listener L can move in the virtual space, first obtainer 110 obtains the second position information continuously. First obtainer 110, for example, obtains the first position information each time the spatial information is updated by spatial information managers A0201 and A0211.

The first position information, first sound data, first identification information, and geometry information may be included in metadata, control information, or header information included in the input signal. When the first sound data is a sound signal (PCM data), information identifying the sound signal may be included in metadata, control information, or header information, and the sound signal may be included elsewhere other than in the metadata, control information, or header information. That is, acoustic signal processing device 100 (more specifically, first obtainer 110) may obtain metadata, control information, or header information included in the input signal, and perform acoustic processing based on the metadata, control information, or header information. It is sufficient so long as acoustic signal processing device 100 (more specifically, first obtainer 110) obtains the first position information, first sound data, first identification information, and geometry information; the source from which they are obtained is not limited to the input signal. The first sound data and metadata may be stored in a single input signal or may be separately stored in plural input signals.

Sound signals other than the first sound data may be stored as audio content information in the input signal. The audio content information may be subjected to encoding processing such as MPEG-H 3D Audio (ISO/IEC 23008-3) (hereinafter, referred to as MPEG-H 3D Audio). The encoding processing technology is not limited to MPEG-H 3D Audio; other known technologies may be used. Information such as the first position information, first sound data, first identification information, and geometry information may be subjected to encoding processing.

That is, acoustic signal processing device 100 obtains the sound signal and metadata included in the encoded bitstream. In acoustic signal processing device 100, audio content information is obtained and decoded. In the present embodiment, acoustic signal processing device 100 functions as a decoder included in a decoding device, and more specifically, functions as renderers A0203 and A0213 included in the decoder. Note that the term “audio content information” in the present disclosure should be interpreted as the sound signal itself, or as information including first position information, first sound data, first identification information, and geometry information, in accordance with the technical content.

The second position information may also be subjected to an encoding process. That is, first obtainer 110 obtains and decodes the second position information.

First obtainer 110 outputs the obtained object information and second position information to first calculator 120 and determiner 130.

First calculator 120 calculates the distance between the object (for example, bat B) and listener L based on the first position information included in the object information obtained by first obtainer 110, and the obtained second position information. As described above, first obtainer 110 obtains the first position information and the second position information in the virtual space each time the spatial information is updated by spatial information managers A0201 and A0211. First calculator 120 calculates the distance between the object and listener L in the virtual space based on a plurality of items of first position information and a plurality of items of second position information obtained each time the spatial information is updated. First calculator 120 outputs the calculated distance between the object and listener L to determiner 130.

Determiner 130 determines, based on the first identification information included in the object information obtained by first obtainer 110, which processing method among the first processing method and the second processing method to use to process the first sound data. The first processing method is a processing method for processing the loudness according to the distance calculated by first calculator 120. The second processing method is a processing method for processing the loudness according to the distance calculated by first calculator 120 in a manner different from the first processing method.

As described above, the first identification information indicates the processing method for the first sound data, and determiner 130 determines the processing method for processing the first sound data according to the processing method indicated by the first identification information. For example, when the first identification information indicates the first processing method as the processing method for the first sound data, determiner 130 determines that the processing method for processing the first sound data is the first processing method.

First processor 140 according to the present variation processes the first sound data using the processing method determined by determiner 130. For example, when determiner 130 determines that the processing method for processing the first sound data is the first processing method, first processor 140 processes the first sound data using the first processing method.

First outputter 150 outputs the first sound data processed by first processor 140. Here, first outputter 150 outputs the first sound data to headphones 20. This allows headphones 20 to reproduce the first sound indicated by the output first sound data.

First input interface 160 receives operations from a user of the acoustic signal processing device 100 (for example, a creator of content executed in the virtual space). First input interface 160 is specifically implemented by hardware buttons, but may also be implemented by a touch panel or the like. The operation may include an operation of specifying a file name, and the file may be a file, formatted according to a predetermined rule, of object information containing the above-mentioned first position information, first sound data, first identification information, and geometry information. First input interface 160 may receive the object information by deformatting the file. This applies not only to first input interface 160, but also to input interface 41, second input interface 51, and third input interface 61 to be described later.

Storage 170 is a storage device that stores computer programs to be executed by first obtainer 110, first calculator 120, determiner 130, first processor 140, first outputter 150, and first input interface 160, as well as stores object information.

Here, the geometry information according to the present embodiment will be described again. The geometry information indicates the shape of the object (i.e., bat B), and is used for generating a video of the object in the virtual space. That is, the geometry information is also used for generating a content (for example, a video) to be displayed on display 30.

First obtainer 110 outputs the obtained geometry information to display 30 as well. Display 30 obtains the geometry information output by first obtainer 110. Display 30 further obtains attribute information indicating an attribute (for example, the color), other than the shape, of the object (i.e., bat B) in the virtual space. Display 30 may directly obtain the attribute information from a device (e.g., server device 10) other than acoustic signal processing device 100, or may obtain the attribute information from acoustic signal processing device 100. Display 30 generates content (for example, a video) based on the obtained geometry information and attribute information, and displays the content.

The first processing method and the second processing method will be described again.

The first processing method is a processing method for processing the first sound data such that the loudness attenuates inversely proportional with increasing distance calculated by first calculator 120.

When the distance is denoted as D and the loudness of the first sound processed by the first processing method is denoted as V1, V1 is represented by Equation 1.

$$V 1 ∝ ( 1 / D ) \qquad ( Equation 1 )$$

The second processing method is a processing method for processing the first sound data such that the loudness increases or decreases in a manner different from the first processing method as the distance calculated by first calculator 120 increases. As one example, the second processing method is a processing method for processing the first sound data such that the loudness attenuates according to the x-th power of the distance (where x≠1). When the loudness of the first sound processed by the second processing method is denoted as V2, V2 is represented by Equation 2. Note that “\hat{ }” in Equation 2 represents the exponentiation operator.

$$V 2 ∝ ( 1 / D ) \hat{} x \qquad ( Equation 2 )$$

In the present embodiment, the first identification information indicates that the processing method for the first sound data is the second processing method, and also indicates the value of x. More specifically, when the first sound is the aerodynamic sound generated accompanying the movement of the object, that is, the first aerodynamic sound (wind noise), the first identification information indicates that the processing method for the first sound data is the second processing method, and that x is α, where α is a real number and satisfies (Equation 3).

$$α > 1 \qquad ( Equation 3 )$$

Note that first input interface 160 receives an operation from a user of acoustic signal processing device 100 for specifying the value of α. As a result, for example, x indicated by the first identification information included in the object information stored in storage 170 becomes α. That is, x indicated by the first identification information is updated to become α.

Furthermore, although it is explained here that processing is applied to the first sound data according to Equation 1 as the first processing method and according to Equation 2 as the second processing method, this example is non-limiting. For example, V3 calculated as V3=f(d\hat{ }r) (where r is a real number greater than or equal to 1) using function f with argument d, which is the distance calculated by first calculator 120, may be used as the loudness. Although a monotonically decreasing function such as an inverse proportional function is often used for this function f, a function different from a monotonically decreasing function may be used in consideration of the balance between realism in real-world space and special effects (for example, immersion and entertainment value) in virtual space. The function to be used is set in advance by the system designer. Additionally, a plurality of functions may be prepared in advance, and which of these functions is used may be switched based on parameters such as object information or position of the object, or state or position of the listener.

Furthermore, instead of using function f, a structure that includes a table of loudnesses V4 corresponding to distances d may be used. The system designer can design the table with a high degree of freedom, considering the balance between realism in real-world space and special effects (for example, immersion and entertainment value) in virtual space. The table to be used is set in advance by the system designer. Additionally, a plurality of tables may be prepared in advance, and which of these tables is used may be switched based on parameters such as object information or position of the object, or state or position of the listener.

Next, Operation Example 1 of an acoustic signal processing method performed by acoustic signal processing device 100 will be described.

### Operation Example 1

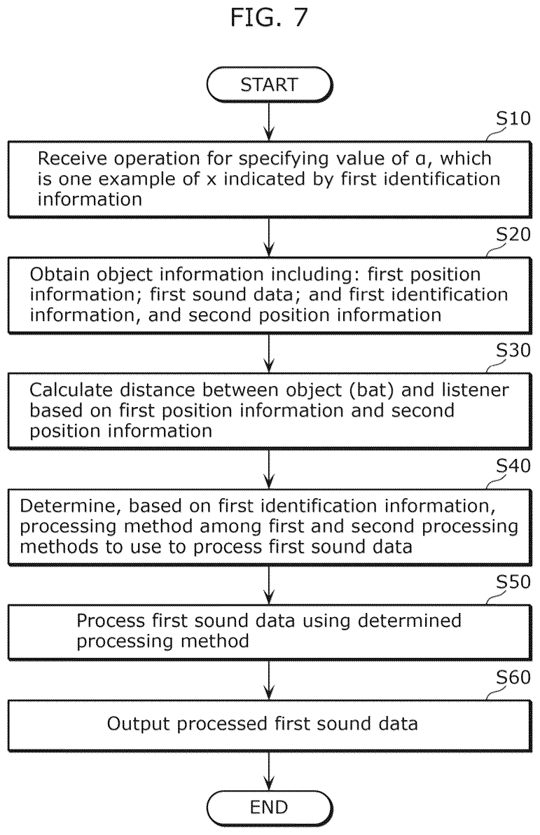

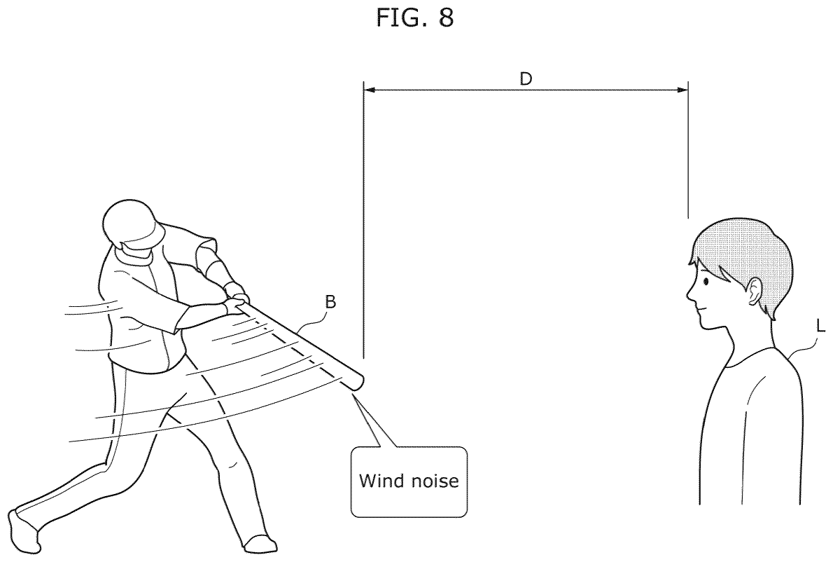

FIG. 7 is a flowchart of Operation Example 1 performed by acoustic signal processing device 100 according to the present embodiment. FIG. 8 illustrates bat B, which is an object according to Operation Example 1, and listener L.

In this operation example, the first sound is a sound caused by bat B, which is the object, and is the first aerodynamic sound (wind noise) generated accompanying the movement of bat B.

As illustrated in FIG. 7, first, first input interface 160 receives an operation for specifying the value of a, which is one example of x indicated by the first identification information (S10). This step S10 corresponds to the receiving step.

As a result, x indicated by the first identification information included in the object information stored in storage 170 becomes a.

Furthermore, first obtainer 110 obtains object information including: first position information; first sound data; and first identification information, and second position information (S20). This step S20 corresponds to the obtaining step.

Next, first calculator 120 calculates distance D between the object and listener L based on the first position information included in the object information obtained by first obtainer 110, and the second position information obtained by first obtainer 110 (S30). That is, here, first calculator 120 calculates distance D between bat B and listener L. This step S30 corresponds to the calculating step.

Next, determiner 130 determines, based on the first identification information included in the object information obtained by first obtainer 110, which processing method among the first processing method and the second processing method to use to process the first sound data (S40). This step S40 corresponds to the determining step.

Next, first processor 140 processes the first sound data using the processing method determined by determiner 130 (S50). This step S50 corresponds to the processing step.

For example, when the processing method is determined to be the first processing method in step S40, first processor 140 processes the first sound data using the first processing method. For example, when the processing method is determined to be the second processing method in step S40, first processor 140 processes the first sound data using the second processing method. Here, the processing method is determined to be the second processing method in step S40, and the second processing method is a processing method for processing the first sound data such that the loudness attenuates according to the x-th power of distance D. From step S10, since x is α, when the loudness of the first sound processed by the second processing method is denoted as V2, V2 is represented by Equation 4.

$$V 2 ∝ ( 1 / D ) \hat{} α \qquad ( Equation 4 )$$

Note that, for example, α is 2.

First outputter 150 outputs the first sound data processed by first processor 140 (S60). This step S60 corresponds to the outputting step.

In the present embodiment, since the processing method for the loudness of the first sound can be changed according to the first identification information, the first sound that listener L hears in the virtual space becomes similar to the first sound that listener L hears in the real-world space, and more specifically, becomes a sound that reproduces the first sound in the real-world space. Therefore, listener L is less likely to feel a sense of incongruity and can experience a sense of realism.

Furthermore, in the present embodiment, the first sound is the first aerodynamic sound (wind noise). According to the first identification information, either the first processing method for processing the first sound data such that the loudness attenuates inversely proportional with increasing distance D, or the second processing method for processing the first sound data such that the loudness increases or decreases in a manner different from the first processing method as distance D increases, is used. Therefore, the first sound (wind noise) that listener L hears in the virtual space becomes more similar to the first sound (wind noise) that listener L hears in the real-world space. Accordingly, listener L is even less likely to feel a sense of incongruity and can experience an even greater sense of realism.

### Variation 1 of Embodiment

Hereinafter, Variation 1 of the embodiment will be described. The following description will focus on the differences from the embodiment, and description of points in common will be omitted or simplified.

### Configuration

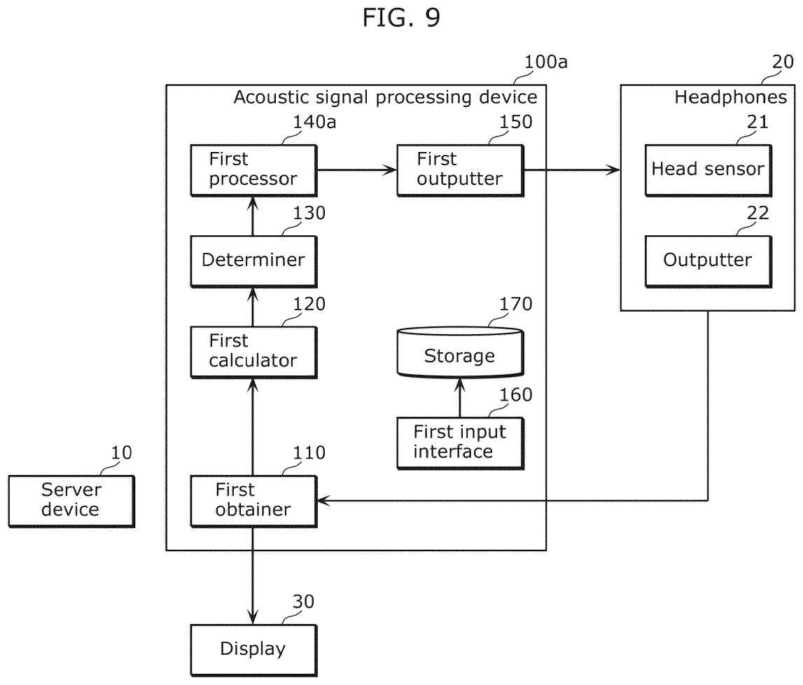

First, a configuration of acoustic signal processing device 100a according to Variation 1 of the present embodiment will be described. FIG. 9 is a block diagram illustrating the functional configuration of acoustic signal processing device 100a according to the present variation.

Acoustic signal processing device 100a according to the present variation can express, in the virtual space, the personal space corresponding to listener L and the sense of distance between listener L and other individuals that cannot be expressed by physical distance alone. Acoustic signal processing device 100a has the same configuration as acoustic signal processing device 100 according to the embodiment, except that it includes first processor 140a instead of first processor 140.

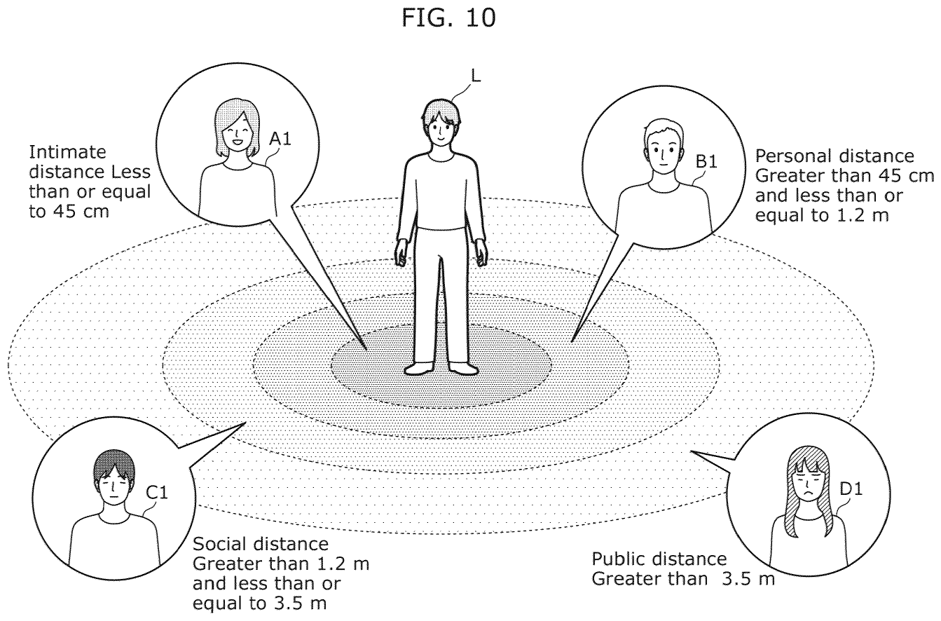

In the present variation, the object in the virtual space is an individual other than listener L. FIG. 10 illustrates four other individuals A1 to D1 and listener L according to the present variation. In FIG. 10, each of the four other individuals A1 to D1 is classified into one of the four categories of personal space: intimate distance, personal distance, social distance, and public distance.

For example, the degree of familiarity with listener L decreases in the order of individual A1, individual B1, individual C1, and individual D1. Listener L can tolerate individual A1 approaching up to the intimate distance, individual B1 approaching up to the personal distance, individual C1 approaching up to the social distance, and individual D1 approaching up to the public distance.

In the present variation, when the object is individual A1, the first sound is the voice of individual A1. Similarly, when the object is individual B1, the first sound is the voice of individual B1, when the object is individual C1, the first sound is the voice of individual C1, and when the object is individual D1, the first sound is the voice of individual D1.

First obtainer 110 included in acoustic signal processing device 100a obtains object information corresponding to an individual that is as an object, and second position information. Object information corresponding to each of the four individuals A1 to D1 is available, and the object information corresponding to individual A1 may be referred to as object information A1. Similarly, the object information corresponding to individual B1 may be referred to as object information B1, the object information corresponding to individual C1 may be referred to as object information C1, and the object information corresponding to individual D1 may be referred to as object information D1. Note that when it is not necessary to distinguish between object information A1 to D1, it may simply be referred to as object information.

First processor 140a according to the present variation processes the first sound data using the processing method determined by determiner 130. Here, the processing methods of the first example, second example, and third example performed by first processor 140a will be described.

### First Example

First, the processing method of the first example will be described.

In the first example, the second processing method according to the present variation is a processing method for processing the first sound data such that the loudness becomes a predetermined value when distance D calculated by first calculator 120 is within a predetermined threshold. This predetermined threshold is a value dependent on personal space.

Stated differently, the second processing method processes the first sound data such that the loudness heard by listener L becomes a predetermined value according to distance D. The predetermined value indicates, for example, value VH representing a larger loudness and value VL representing a smaller loudness than VH. More specifically, VH is a loudness high enough that listener L feels it is unpleasant when an individual approaches listener L, and VL is a loudness to the extent that listener L perceives that an individual has approached.

First, in the present variation, the second processing method will be described in a case in which the object is an individual classified into the category of intimate distance, such as individual A1. Listener L is familiar with individual A1, and allows individual A1 to approach up to an intimate distance (45 cm or less). Therefore, the second processing method is a processing method for processing the first sound data such that the loudness of individual A1's voice becomes VL when distance D is less than or equal to 45 cm, and attenuates as distance D increases when distance D is greater than 45 cm.

Next, the second processing method will be described in a case in which the object is an individual classified into the category of personal distance, such as individual B1. Listener L is somewhat familiar with individual B1, and allows individual B1 to approach up to a personal distance (greater than 45 cm and less than or equal to 120 cm). Therefore, the second processing method is a processing method for processing the first sound data such that the loudness of individual B1's voice becomes VH when distance D is less than or equal to 45 cm, becomes VL when distance D is greater than 45 cm and less than or equal to 120 cm, and attenuates as distance D increases when distance D is greater than 120 cm.

Next, the second processing method will be described in a case in which the object is an individual classified into the category of social distance, such as individual C1. Listener L is not somewhat familiar with individual C1, and allows individual C1 to approach up to a social distance (greater than 120 cm and less than or equal to 350 cm). Therefore, the second processing method is a processing method for processing the first sound data such that the loudness of individual C1's voice becomes VH when distance D is less than or equal to 120 cm, becomes VL when distance D is greater than 120 cm and less than or equal to 350 cm, and attenuates as distance D increases when distance D is greater than 350 cm.

Next, the second processing method will be described in a case in which the object is an individual classified into the category of public distance, such as individual D1. Listener L is not familiar with individual D1, and allows individual D1 to approach up to a public distance (350 cm). Therefore, the second processing method is a processing method for processing the first sound data such that the loudness of individual D1's voice becomes VH when distance D is less than or equal to 350 cm, and attenuates as distance D increases when distance D is greater than 350 cm.

Note that which category of personal space each of individuals A1 to D1 is classified into may be indicated in the first identification information included in the corresponding object information A1 to D1.

Also, as described above, the predetermined threshold is a value dependent on personal space, but for example, first input interface 160 may receive an operation from a user specifying that the predetermined threshold is a first specified value, and the first specified value specified by the received operation may be used as the predetermined threshold.

### Second Example

Next, the processing method of the second example will be described.

In the second example, before the processing of first processor 140a is performed, determiner 130 determines whether to execute the first processing method based on the first identification information obtained by first obtainer 110, and decides to execute the second processing method regardless of whether the first processing method is executed or not. Note that in the second example, the first identification information indicates whether or not to execute the first processing method, and does not indicate whether or not to execute the second processing method.

That is, first processor 140a executes the first processing method on the first sound data when determiner 130 determines to execute the first processing method, and does not execute the first processing method on the first sound data when determiner 130 determines not to execute the first processing method. Furthermore, regardless of whether the first processing method has been executed on the first sound data or not, first processor 140a executes the second processing method on the first sound data.

In the second example as well, the second processing method according to the present variation is a processing method for processing the first sound data such that the loudness becomes a predetermined value when distance D calculated by first calculator 120 is within a predetermined threshold. This predetermined threshold is a value dependent on personal space.

The following describes an example in which both the first processing method and the second processing method are executed on the first sound data.

First, by executing the first processing method, the first sound data is processed such that it attenuates inversely proportional with increasing distance D, regardless of whether distance D between the object (for example, individual B1) and listener L is within a predetermined threshold or not. Furthermore, the second processing method is executed on the first sound data processed by the first processing method. The second processing method according to the second example is a processing method for processing the first sound data such that the loudness of individual B1's voice becomes VH when distance D is 45 cm, and becomes VL when distance D is 120 cm.

Therefore, the first sound data processed by executing both the first processing method and the second processing method attenuates inversely proportional with increasing distance D, and indicates that the loudness of individual B1's voice is VH when distance D is 45 cm, and the loudness of individual B1's voice is VL when distance D is 120 cm.

The second processing method according to the second example is a processing method for processing the first sound data such that, when the object is individual A1, the loudness of individual A1's voice becomes VL when distance D is 45 cm.

The second processing method according to the second example is a processing method for processing the first sound data such that, when the object is individual C1, the loudness of individual C1's voice becomes VH when distance D is 120 cm, and becomes VL when distance D is 350 cm.

The second processing method according to the second example is a processing method for processing the first sound data such that, when the object is individual D1, the loudness of individual D1's voice becomes VH when distance D is 350 cm.

### Third Example

Next, the processing method of the third example will be described.

In the third example, the second processing method according to the present variation is a processing method for processing the first sound data such that the loudness attenuates according to the x-th power of distance D (where x≠1). The higher the degree of familiarity between listener L and an individual, the smaller the value of x corresponding to that individual becomes.

For example, when the object is an individual classified into the category of intimate distance, such as individual A1, the value of x is 0.9, and when the object is an individual classified into the category of personal distance, such as individual B1, the value of x is 1.5. For example, when the object is an individual classified into the category of social distance, such as individual C1, the value of x is 2.0, and when the object is an individual classified into the category of public distance, such as individual D1, the value of x is 3.0.

In the first example to the third example described above, various parameters are set such that when an unfamiliar individual approaches, their voice becomes a high loudness that feels unpleasant. Conversely, the parameters may be set to produce a low loudness, since one may not want to hear an unpleasant voice. Stated differently, while the first processing method is intended to reproduce physical phenomena, the second processing method may be used to express an increase or decrease in loudness based on psychological distance that cannot be expressed by physical distance.

Next, Operation Example 2 of an acoustic signal processing method performed by acoustic signal processing device 100a will be described.

### Operation Example 2

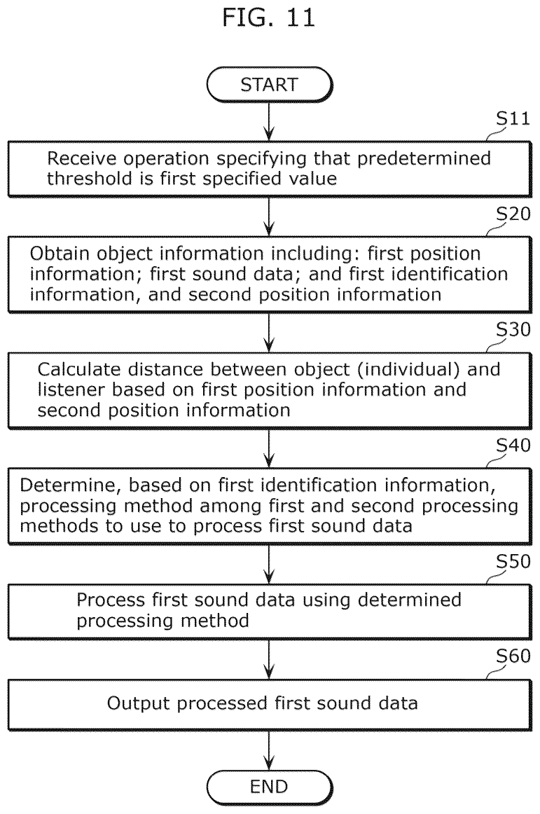

FIG. 11 is a flowchart of Operation Example 2 performed by acoustic signal processing device 100a according to the present variation.

As illustrated in FIG. 11, first, first input interface 160 receives an operation from a user specifying that a predetermined threshold is a first specified value (S11). As one example, the predetermined threshold is a value dependent on personal space. In the case of the third example described above, this step S11 need not be performed.

Furthermore, first obtainer 110 obtains object information including: first position information; first sound data; and first identification information, and second position information (S20). The object information obtained in step S20 is at least one of the four items of object information A1 to D1.

Next, first calculator 120 calculates distance D between the object (another individual) and listener L based on the first position information included in the object information obtained by first obtainer 110, and the second position information obtained by first obtainer 110 (S30).

Next, determiner 130 determines, based on the first identification information included in the object information obtained by first obtainer 110, which processing method among the first processing method and the second processing method to use to process the first sound data (S40).

Next, first processor 140a processes the first sound data using the processing method determined by determiner 130 (S50). As described above, the first sound data is processed using any of the methods of the first example to the third example.

First outputter 150 outputs the first sound data processed by first processor 140a (S60).

For example, in the present variation, when individual D1, who is not familiar with listener L, approaches to within 350 cm, listener L would hear the voice of individual D1 at unpleasantly loud VH loudness. However, when individual A1, who is familiar with listener L, approaches to within 45 cm, listener L would hear the voice of individual A1 at VL loudness, which is sufficient to perceive that individual A1 has approached. In other words, the loudness of the voice of individual D1, who is not familiar, is controlled to be unpleasantly loud, while the loudness of the voice of individual A1, who is familiar, is controlled to be audible. Therefore, in the present variation, it is possible to express, in the virtual space, the personal space corresponding to listener L and the sense of distance between listener L and other individuals that cannot be expressed by physical distance alone.

To summarize, in the present variation, in the processing, when distance D is within a predetermined threshold, the second processing method for processing the first sound data such that the loudness becomes a predetermined value can be used. Furthermore, in the processing, the first sound data can be processed using a predetermined threshold value that corresponds to personal space. Accordingly, acoustic signal processing device 100a according to the present variation can express, in the virtual space, the personal space corresponding to listener L and the sense of distance between listener L and other individuals that cannot be expressed by physical distance alone, by executing a second processing method in which a predetermined value differs for each object that is another individual.

### Variation 2 of Embodiment

Hereinafter, Variation 2 of the embodiment will be described. The following description will focus on the differences from the embodiment, and description of points in common will be omitted or simplified.

### Configuration

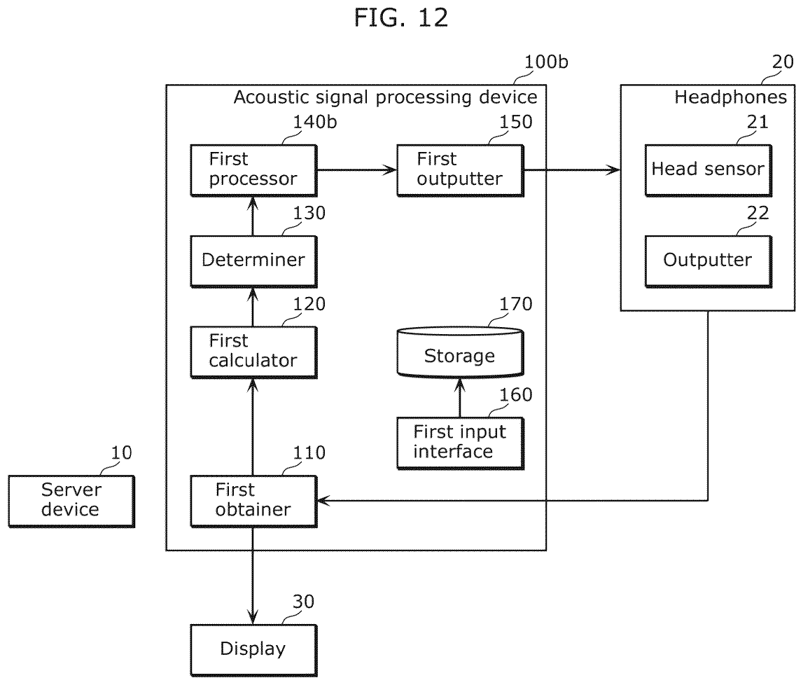

First, a configuration of acoustic signal processing device 100b according to Variation 2 of the present embodiment will be described. FIG. 12 is a block diagram illustrating the functional configuration of acoustic signal processing device 100b according to the present variation.

Acoustic signal processing device 100b according to the present variation is capable of processing a plurality of items of sound data. Acoustic signal processing device 100b has the same configuration as acoustic signal processing device 100 according to the embodiment, except that it includes first processor 140b instead of first processor 140.

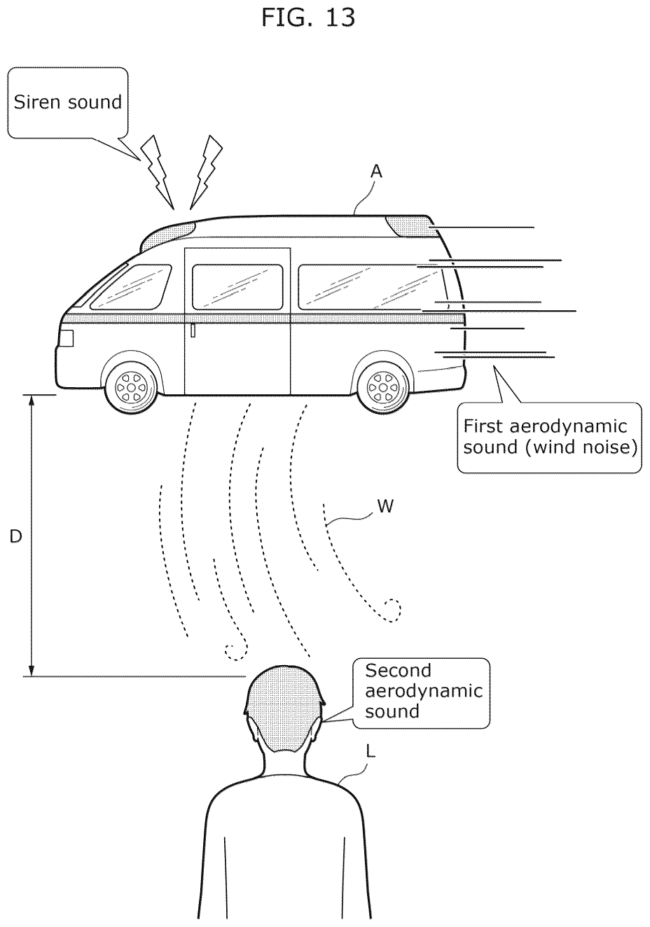

FIG. 13 illustrates an object and a plurality of sounds according to the present variation. In the present variation, the object in the virtual space is ambulance A. The plurality of sounds includes three sounds, and more specifically, includes two first sounds and one second sound.

The two first sounds and one second sound are sounds caused by the object, ambulance A. For distinction, the two first sounds are referred to as first sound A2 and first sound B2.

First sound A2 is the aerodynamic sound (first aerodynamic sound) generated accompanying the movement of the object (ambulance A), i.e., wind noise. First sound B2 is the aerodynamic sound, i.e., the second aerodynamic sound, generated by wind W radiated from the object (ambulance A) reaching the ears of listener L. Stated differently, wind W radiated from the object includes wind stirred up by the movement of an object such as a moving object (ambulance A), as illustrated in FIG. 13.

The second sound is a sound different from the two first sounds, and more specifically, is the siren sound emitted from ambulance A. In this way, ambulance A is an object that generates a plurality of sounds including wind noise (first aerodynamic sound), second aerodynamic sound, and siren sound.

In the present variation, the object information obtained by first obtainer 110 includes first position information, first sound data indicating the first sound, first identification information, second sound data indicating the second sound, and second identification information indicating a processing method for the second sound data. Note that the first sound data includes first sound data A2 indicating first sound A2 and first sound data B2 indicating first sound B2. The first identification information includes first identification information A2 indicating a processing method for first sound data A2 and first identification information B2 indicating a processing method for first sound data B2.

In the object information according to the present variation, first sound data B2 indicating first sound B2 (the second aerodynamic sound) generated at a position related to the position of listener L due to the object is associated with the position of the object (ambulance A) indicated by the first position information. Furthermore, in the real-world space, the second aerodynamic sound is generated at the ears of listener L, but here it is treated as if the position of ambulance A in the virtual space is the position of the sound source.

Stated differently, ambulance A is an object associated with a plurality of items of sound data including first sound data and second sound data (in this case, two items of sound data).

In the present variation, determiner 130 determines the processing method for processing first sound data A2 based on first identification information A2, determines the processing method for processing first sound data B2 based on first identification information B2, and determines the processing method for processing the second sound data based on the second identification information.

In the present variation, first processor 140b processes first sound data A2 using the processing method determined based on first identification information A2, processes first sound data B2 using the processing method determined based on first identification information B2, and processes the second sound data using the processing method determined based on the second identification information.

Also, as in the embodiment, the second processing method is a processing method for processing the first sound data such that the loudness attenuates according to the x-th power of distance D (where x≠1). Since first sound A2 is the first aerodynamic sound, first identification information A2 indicates that the processing method for first sound data A2 is the second processing method, and that x is α, where α is a real number and satisfies (Equation 5).

$$α > 1 \qquad ( Equation 5 )$$

Since first sound B2 is the second aerodynamic sound, first identification information B2 indicates that the processing method for first sound data B2 is the second processing method, and that x is β, where β is a real number and satisfies (Equation 6).

$$β > 2 \qquad ( Equation 6 )$$

Note that α and β satisfy (Equation 7).

$$α < β \qquad ( Equation 7 )$$

For example, α is 2 and β is 2.5.

First sound B2 will be further described. As described above, in the object information, first sound data B2 indicating first sound B2 (the second aerodynamic sound) is associated with the position of the object (ambulance A). Therefore, first processor 140b processes first sound data B2 such that the loudness of first sound B2 attenuates as distance D increases, whereby first sound B2 (second aerodynamic sound) that listener L hears in the virtual space can be made similar to first sound B2 (second aerodynamic sound) that listener L hears in the real-world space.

Next, Operation Example 3 of an acoustic signal processing method performed by acoustic signal processing device 100b will be described.

### Operation Example 3

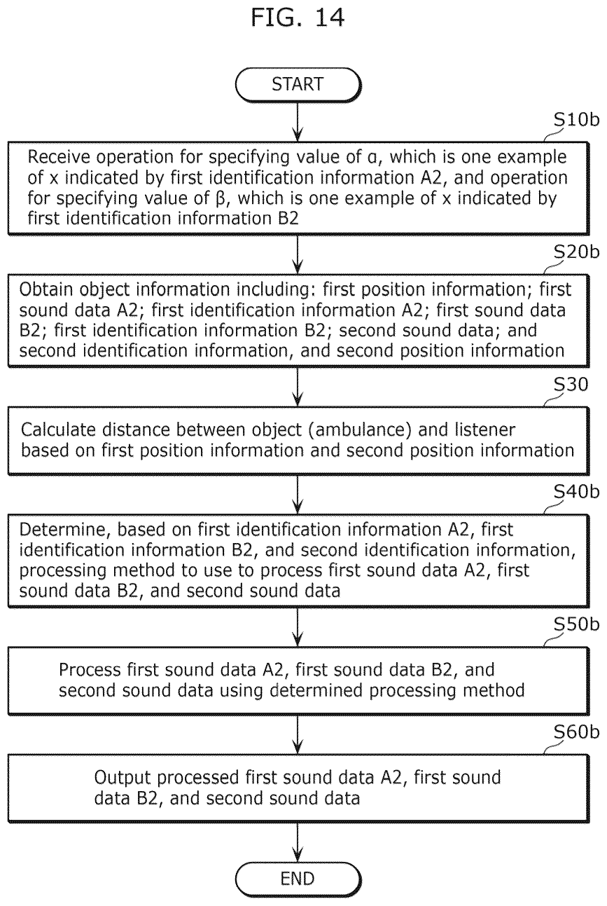

FIG. 14 is a flowchart of Operation Example 3 performed by acoustic signal processing device 100b according to the present variation.

As illustrated in FIG. 14, first, first input interface 160 receives an operation for specifying the value of a, which is one example of x indicated by first identification information A2, and an operation for specifying the value of β, which is one example of x indicated by first identification information B2 (S10b). This step S10b corresponds to the receiving step.

As a result, x indicated by first identification information A2 included in the object information stored in storage 170 becomes α, and x indicated by first identification information B2 becomes β.

Furthermore, first obtainer 110 obtains object information including: first position information; first sound data A2; first identification information A2; first sound data B2; first identification information B2; second sound data; and second identification information, and second position information (S20b). This step S20b corresponds to the obtaining step.

Next, first calculator 120 calculates distance D between the object (ambulance A) and listener L based on the first position information included in the object information obtained by first obtainer 110, and the second position information obtained by first obtainer 110 (S30).

Next, determiner 130 determines, based on first identification information A2, first identification information B2, and second identification information included in the object information obtained by first obtainer 110, the processing method to use to process first sound data A2, first sound data B2, and the second sound data (S40b). This step S40b corresponds to the determining step.

Next, first processor 140b processes first sound data A2, first sound data B2, and the second sound data using the processing method determined by determiner 130 (S50b). This step S50b corresponds to the processing step.

First outputter 150 outputs first sound data A2, first sound data B2, and the second sound data processed by first processor 140b (S60b). This step S60b corresponds to the outputting step.

In the present variation, the processing method for the loudness of the first sound can be changed according to the first identification information, and the processing method for the loudness of the second sound can be changed according to the second identification information. Therefore, the first sound and the second sound that listener L hears in the virtual space become similar to the first sound and the second sound, respectively, that listener L hears in the real-world space. Furthermore, since first sound A2 is the first aerodynamic sound and first sound B2 is the second aerodynamic sound, the second processing method is executed on each of first sound data A2 and first sound data B2 with different values of x. Therefore, first sound A2 (first aerodynamic sound) and first sound B2 (second aerodynamic sound) that listener L hears in the virtual space become similar to first sound A2 (first aerodynamic sound) and first sound B2 (second aerodynamic sound), respectively, that listener L hears in the real-world space. From the above, listener L is even less likely to feel a sense of incongruity and can experience an even greater sense of realism.

In the above explanation of the present variation, the object is exemplified as, but not limited to ambulance A.

When the object is an object that generates multiple sounds, that is, when it is an object associated with a plurality of items of sound data including first sound data and second sound data (two items of sound data in the above case), processing similar to the present variation is performed. A first example and a second example of objects for which such similar processing is performed will be described below.

### First Example

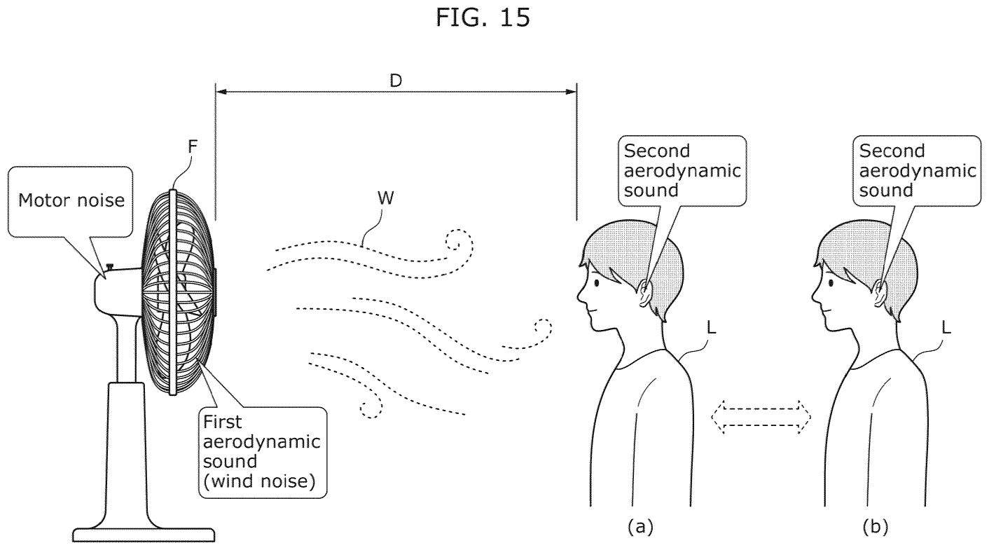

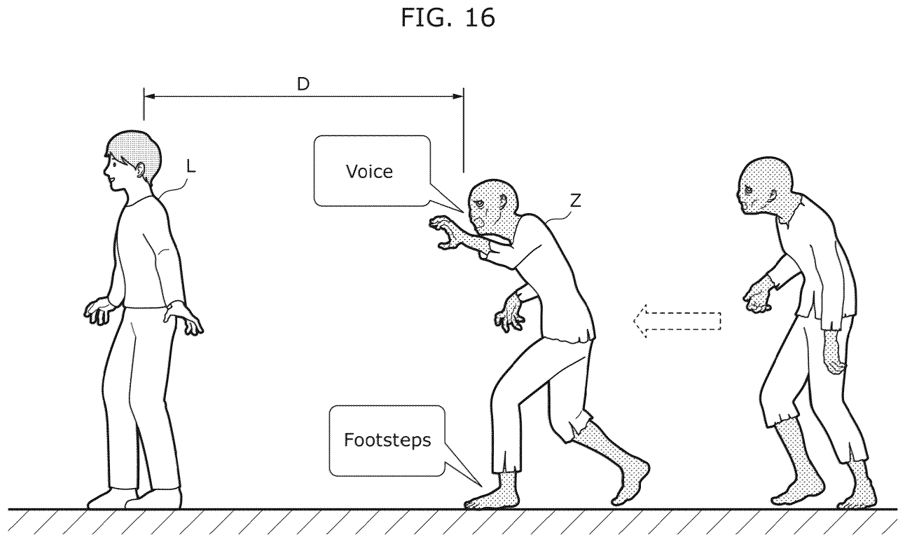

In the first example, the object is electric fan F. FIG. 15 illustrates an example where the object according to the present variation is electric fan F. In such cases, first sound A2 is the first aerodynamic sound, i.e., wind noise, generated accompanying the movement of electric fan F, which is the object, more specifically, the rotation of the blades of electric fan F. First sound B2 is the second aerodynamic sound, which is generated by wind W radiated from the object (electric fan F) reaching the ears of listener L. The second sound is the motor noise of electric fan F.

In this first example as well, the first sound and the second sound that listener L hears in the virtual space become similar to the first sound and the second sound, respectively, that listener L hears in the real-world space. Therefore, listener L is even less likely to feel a sense of incongruity and can experience an even greater sense of realism.

In this first example of Variation 2 as well, the second processing method for processing the first sound data such that the loudness differs depending on whether distance D is within a predetermined threshold or not, as shown in the first example and second example of Variation 1 of the embodiment, may be used.

In the first example and second example of Variation 1 of the embodiment, the second processing method was exemplified as, but is not limited to, a processing method for processing the first sound data such that the loudness becomes a predetermined value when distance D is within a predetermined threshold. In the first example of Variation 2, the second processing method may be the following processing method. The second processing method of the first example of Variation 2 may be, for example, a processing method for processing the first sound data such that the value of x when distance D is within a predetermined threshold becomes larger than the value of x when distance D is outside the predetermined threshold.

### Second Example

In the second example, the object is zombie Z appearing in content displayed on display 30. FIG. 16 illustrates an example where the object according to the present variation is zombie Z. The object, which is zombie Z, generates one first sound and one second sound. For example, the first sound is a groan emitted by zombie Z, and the second sound is the sound of footsteps caused by zombie Z walking. In this case, the second processing method is a processing method for processing the first sound data such that the loudness attenuates according to the x-th power of distance D (where x≠1), and x is preferably a value greater than 1.

In step S50b illustrated in FIG. 14, for example, first processor 140b processes the first sound data using the second processing method, and processes the second sound data using the first processing method.

In a real-world space, the human voice (groaning) attenuates in loudness inversely proportional with increasing distance D between the living being and listener L. Stated differently, if the first sound data representing the first sound, which is the groan of zombie Z, is processed using the first processing method, listener L hears the same voice (groan) as in a real-world space. However, by intentionally processing the first sound data using the second processing method, i.e., by processing it so that a groan different from that in a real-world space is heard, listener L can experience the eeriness of the imaginary creature zombie Z.

In this second example of Variation 2, as in the first example of Variation 2, the second processing method may be, for example, a processing method for processing the first sound data such that the value of x when distance D is within a predetermined threshold becomes larger than the value of x when distance D is outside the predetermined threshold.

### Variation 3 of Embodiment

Hereinafter, Variation 3 of the embodiment will be described. The following description will focus on the differences from the embodiment, and description of points in common will be omitted or simplified.

### Configuration

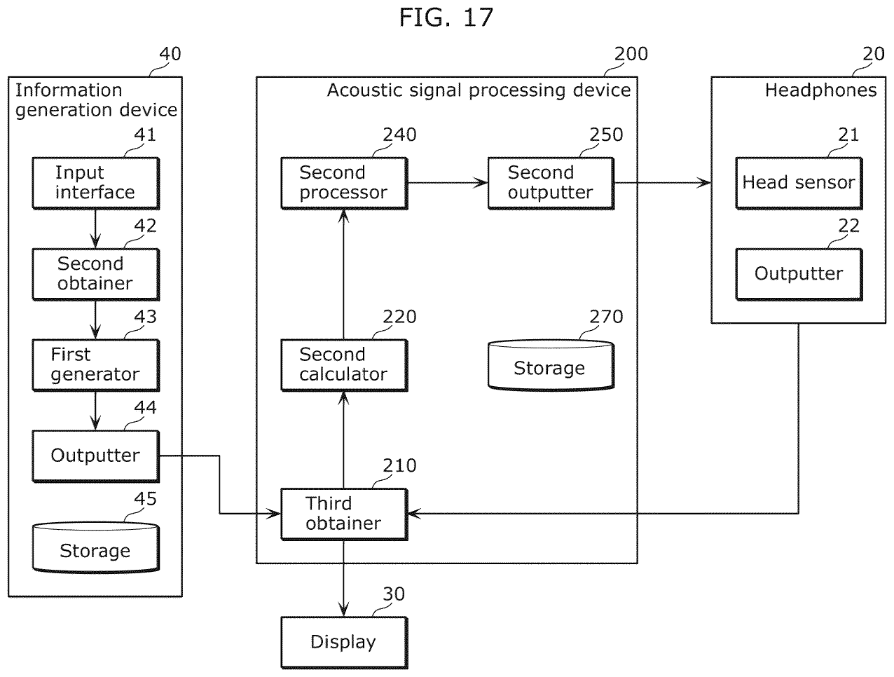

First, configurations of information generation device 40 and acoustic signal processing device 200 according to Variation 3 of the present embodiment will be described. FIG. 17 is a block diagram illustrating the functional configurations of information generation device 40 and acoustic signal processing device 200 according to the present variation.

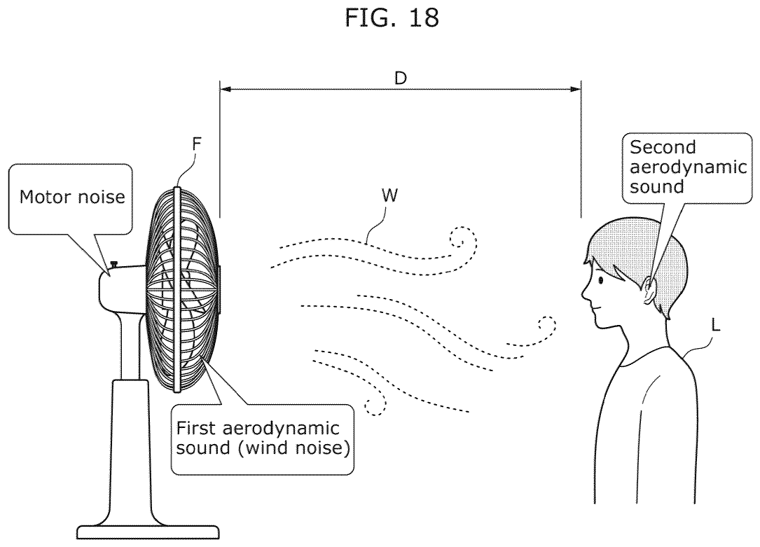

Information generation device 40 and acoustic signal processing device 200 according to the present variation can inhibit the occurrence of the problem explained in the Underlying Knowledge Forming Basis of the Present Disclosure section, where listener L ends up hearing the second aerodynamic sound with a sense of incongruity. FIG. 18 illustrates electric fan F, which is an object according to the present variation, and listener L.

Information generation device 40 is a device that generates and outputs first object audio information to acoustic signal processing device 200. Acoustic signal processing device 200 is a device that obtains the output first object audio information, and outputs sound data to headphones 20 based on the obtained first object audio information.

First, information generation device 40 illustrated in FIG. 17 will be described.

Information generation device 40 includes input interface 41, second obtainer 42, first generator 43, outputter 44, and storage 45.

Input interface 41 receives operations from a user of information generation device 40 (for example, a creator of content executed in the virtual space). Input interface 41 is specifically implemented by hardware buttons, but may also be implemented by a touch panel or the like.

Second obtainer 42 obtains first sound data indicating a first sound generated at a position related to the position of listener L in the virtual space, and first position information indicating the position of an object in the virtual space. In the present variation, the object is an object that radiates wind W, and is electric fan F as illustrated in FIG. 18. In the virtual space, listener L is positioned to be exposed to wind W radiated from electric fan F. The first sound is a sound generated at a position related to the position of listener L, and here, the position related to the position of listener L is the position of an ear of listener L. Stated differently, the first sound is a sound generated at a position related to the position of listener L (that is, the position of an ear of listener L) due to the object. More specifically, the first sound according to the present variation is the aerodynamic sound (second aerodynamic sound) generated by wind W radiated from the object, which is electric fan F, reaching the ears of listener L.

Note that in the present variation, input interface 41 receives an operation from a user indicating first sound data and first position information. Stated differently, the user inputs the first sound data and the first position information by operating input interface 41, and second obtainer 42 obtains the input first sound data and first position information.

First generator 43 generates first object audio information including information related to an object that reproduces the first sound at a position related to the position of listener L due to the object, and the first position information, from the first sound data and the first position information obtained by second obtainer 42.

The information related to the above-mentioned object indicates that the object is electric fan F, and that the object reproduces the first sound due to itself.

In the first object audio information according to the present variation, first sound data indicating the first sound (the second aerodynamic sound) generated at a position related to the position of listener L due to the object is associated with the position of the object (electric fan F) indicated by the first position information. Furthermore, in the real-world space, the second aerodynamic sound is generated at the ears of listener L, but here it is treated as if the position of electric fan F in the virtual space is the position of the sound source.

Note that first generator 43 may generate first object audio information including directivity information and unit distance information.

The directivity information indicates characteristics according to the direction of wind W radiated from electric fan F. The directivity information is, for example, a database stored in Spatially Oriented Format for Acoustics (SOFA) format containing wind speed for each direction in which wind W is radiated, or the attenuation rate of the loudness of the second aerodynamic sound.

The unit distance information includes a unit distance, which is a reference distance, and aerodynamic sound data indicating aerodynamic sound at a position separated by the unit distance from the position of the object indicated by the first position information. The aerodynamic sound data indicated in this unit distance information is data indicating the aerodynamic sound (second aerodynamic sound), at a position separated by the unit distance from the position of the object, in the forward direction in which the object radiates wind W as indicated in the directivity information.

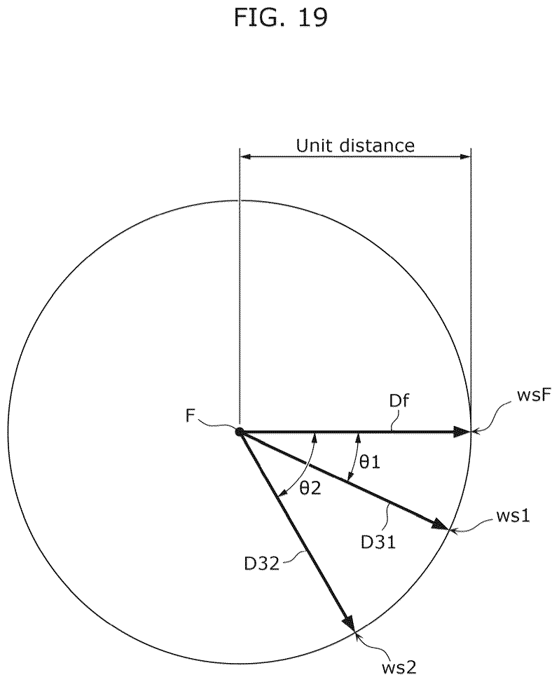

Here, the directivity information and the unit distance information will be described with reference to FIG. 19.

FIG. 19 is for illustrating directivity information and unit distance information according to the present variation. The forward direction of wind W radiated from the object (electric fan F) is defined as direction Df. Here, the direction forming angle θ1 with direction Df is defined as direction D31, and the direction forming angle θ2 with direction Df is defined as direction D32. FIG. 19 illustrates the unit distance, and a circle is illustrated at a position separated by the unit distance from the object (electric fan F). Stated differently, the radius of this circle is the unit distance.

The speed of wind W at a position separated by the unit distance from the object (electric fan F) in direction DF is defined as wsF. When the speed of wind W at a position separated by the unit distance from the object (electric fan F) in direction D31 is defined as ws1, and the speed of wind W at a position separated by the unit distance from the object (electric fan F) in direction D32 is defined as ws2, ws1 and ws2 satisfy Equation 8 and Equation 9.

$$ws 1 = wsF \times C 1 \qquad ( Equation 8 )$$

$$ws 2 = wsF \times C 2 \qquad ( Equation 9 )$$

The directivity information is, for example, a database indicating values, such as C1 and C2 (C1 and C2 are constants), for each angle, such as θ1 and θ2. Note that C1 is described as the value at angle θ1 indicated by the directivity information, and C2 is described as the value at angle θ2 indicated by the directivity information.

In the above example, directivity related to wind speed was described, but directivity related to the loudness of the sound (second aerodynamic sound) caused by wind W may be described using a similar method.

First generator 43 generates first object audio information further including flag information. The flag information indicates whether or not to, when reproducing the sound, perform processing to convolve a head-related transfer function, which depends on the direction of arrival of sound, on sound data (in this case, aerodynamic sound data) indicating sound generated from the object (electric fan F).

The directivity information, unit distance information, and flag information are, for example, preferably stored in advance in storage 45. First generator 43 may obtain the directivity information, unit distance information, and flag information from storage 45, or may obtain them by operation of input interface 41 in the same manner as the first sound data and first position information.

Outputter 44 outputs the first sound data and first position information obtained by second obtainer 42, and the first object audio information generated by first generator 43, to acoustic signal processing device 200.

Storage 45 is a storage device that stores computer programs to be executed by input interface 41, second obtainer 42, first generator 43, and outputter 44.

Further, acoustic signal processing device 200 illustrated in FIG. 17 will be described.

As illustrated in FIG. 17, acoustic signal processing device 200 includes third obtainer 210, second calculator 220, second processor 240, second outputter 250, and storage 270.

Third obtainer 210 obtains first object audio information generated by information generation device 40, first sound data obtained by information generation device 40, and second position information indicating the position of listener L for the first sound. Third obtainer 210 obtains the second position information from headphones 20 (head sensor 21, more specifically). The source is however not limited thereto.

Second calculator 220 calculates distance D between the object (electric fan F) and listener L based on the first position information included in the first object audio information obtained by third obtainer 210, and the obtained second position information. Second calculator 220 calculates distance D using the same method as first calculator 120 according to the embodiment.

Furthermore, second calculator 220 calculates the direction between two points connecting the object (electric fan F) and listener L based on the first position information included in the first object audio information obtained by third obtainer 210, and the obtained second position information.

Second processor 240 processes the first sound data such that the loudness of the first sound attenuates as distance D calculated by second calculator 220 increases. For example, second processor 240 may process the first sound data using the second processing method presented in Variation 2 of the embodiment. As described above, since the first sound is the second aerodynamic sound, β may be used as the value of x, and the first sound data may be processed. In this case, for example, β is 2.5.

In the first object audio information according to the present variation, first sound data indicating the first sound (the second aerodynamic sound) is associated with the position of the object (electric fan F). Therefore, second processor 240 processes first sound data B2 such that the loudness of first sound B2 attenuates as distance D increases, whereby the first sound (second aerodynamic sound) that listener L hears in the virtual space can be made similar to the first sound (second aerodynamic sound) that listener L hears in the real-world space.

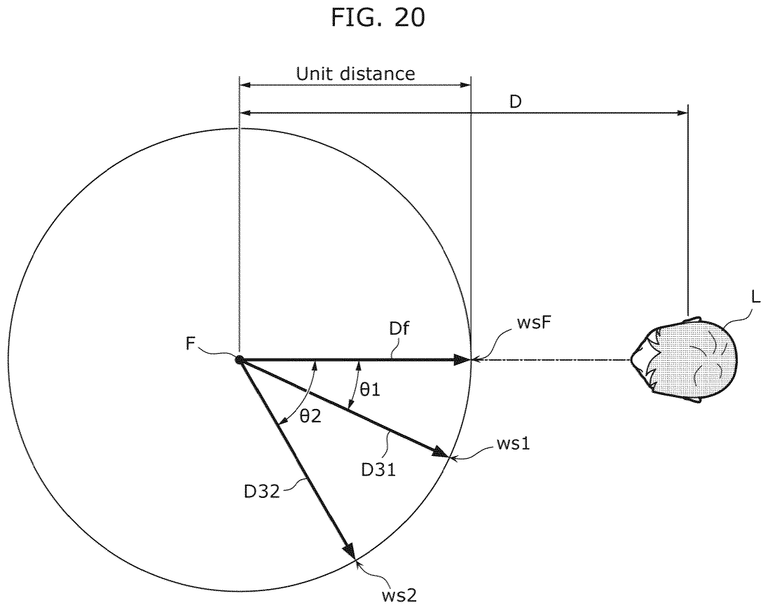

Second processor 240 may perform the following processing when calculated distance D is greater than the unit distance indicated by the unit distance information included in the first object audio information obtained by third obtainer 210. Stated differently, in this case, second processor 240 processes the first sound data such that the loudness of the first sound attenuates according to calculated distance D and the unit distance. This process will be described with reference to FIG. 20.

FIG. 20 is for illustrating processing performed by second processor 240 according to the present variation. FIG. 20 illustrates the positional relationship between the object (electric fan F) and listener L. Listener L is positioned in the forward direction of wind W radiated from the object (electric fan F). As described above, the unit distance information indicates aerodynamic sound data indicating aerodynamic sound at a position separated by the unit distance from the position of the object in the forward direction. In the example illustrated in FIG. 20, the first sound data corresponds to the aerodynamic sound data. When the calculated distance D is greater than the unit distance, second processor 240 processes the aerodynamic sound data indicating aerodynamic sound at a position separated by the unit distance from the position of the object such that the loudness of the first sound (second aerodynamic sound) attenuates as distance D increases.

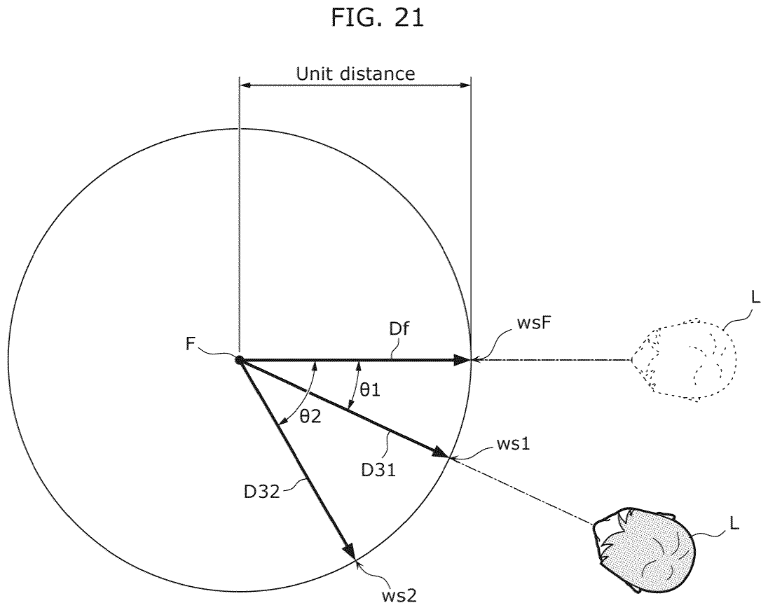

Furthermore, second processor 240 may process the first sound data such that the loudness of the first sound is controlled based on (i) the angle formed between the forward direction of wind W radiated from the object (electric fan F) and the direction between two points calculated by second calculator 220, and (ii) the characteristics indicated by the directivity information. This process will be described with reference to FIG. 21.

FIG. 21 is for illustrating other processing performed by second processor 240 according to the present variation. FIG. 21 illustrates the positional relationship between the object (electric fan F) and listener L. Listener L is positioned in direction D31 from the object (electric fan F). In such cases, the angle formed between the above-mentioned forward direction and the above-mentioned direction between two points is θ1. Compared to when listener L is at the position in the forward direction (the position of listener L indicated by the dashed line), when listener L is at the position illustrated in FIG. 21 (the position of listener L indicated by the solid line), the speed of wind W received by listener L is lower.

The wind speed that listener L at the position illustrated in FIG. 21 is subjected to is a value obtained by multiplying the wind speed that listener L at the position in the forward direction is subjected to by the above-mentioned C1. Since the loudness of the first sound (second aerodynamic sound) that listener L hears changes according to the wind speed that listener L is subjected to, second processor 240 may process the first sound data (in this case, the aerodynamic sound data indicated by the unit distance information) according to the wind speed.

Second processor 240 may perform both the processing explained with reference to FIG. 20 and the processing explained with reference to FIG. 21, and one processed item of first sound data (aerodynamic sound data) may be output to second outputter 250.

Second outputter 250 outputs the first sound data (aerodynamic sound data) processed by second processor 240. Here, second outputter 250 outputs the first sound data to headphones 20. This allows headphones 20 to reproduce the first sound indicated by the output first sound data.

Storage 270 is a storage device that stores computer programs to be executed by third obtainer 210, second calculator 220, second processor 240, and second outputter 250.

Next, Operation Example 4 of an information generation method performed by information generation device 40, and Operation Example 5 of an acoustic signal processing method performed by acoustic signal processing device 200 will be described.

### Operation Example 4

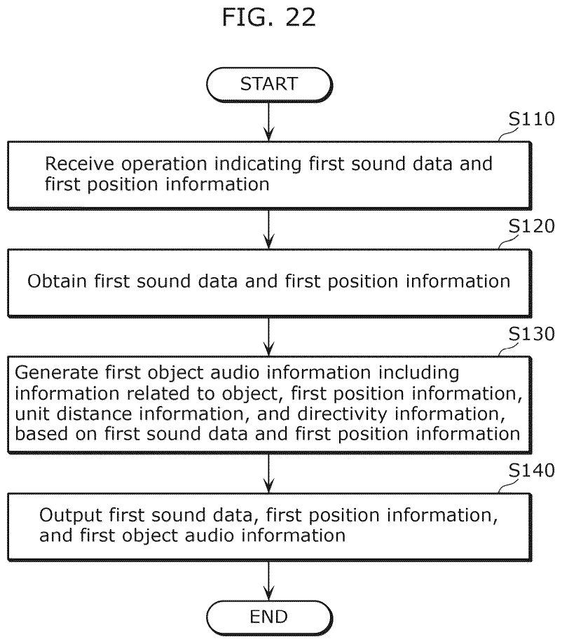

FIG. 22 is a flowchart of Operation Example 4 performed by information generation device 40 according to the present variation.

As illustrated in FIG. 22, first, input interface 41 receives an operation from a user indicating first sound data and first position information (S110). Stated differently, the user inputs the first sound data and the first position information by operating input interface 41.

Next, second obtainer 42 obtains first sound data indicating a first sound generated at a position related to the position of listener L in the virtual space, and first position information indicating the position of an object in the virtual space (S120). Here, second obtainer 42 obtains the first sound data and the first position information input in step S110. This step S120 corresponds to the obtaining step.

Next, first generator 43 generates first object audio information including information related to the object, the first position information, the unit distance information, and the directivity information, based on the first sound data and the first position information obtained by second obtainer 42 (S130). The generated first object audio information may include flag information. This step S130 corresponds to the generating step.

Furthermore, outputter 44 outputs the first sound data and first position information obtained by second obtainer 42, and the first object audio information generated by first generator 43, to acoustic signal processing device 200 (S140).

### Operation Example 5

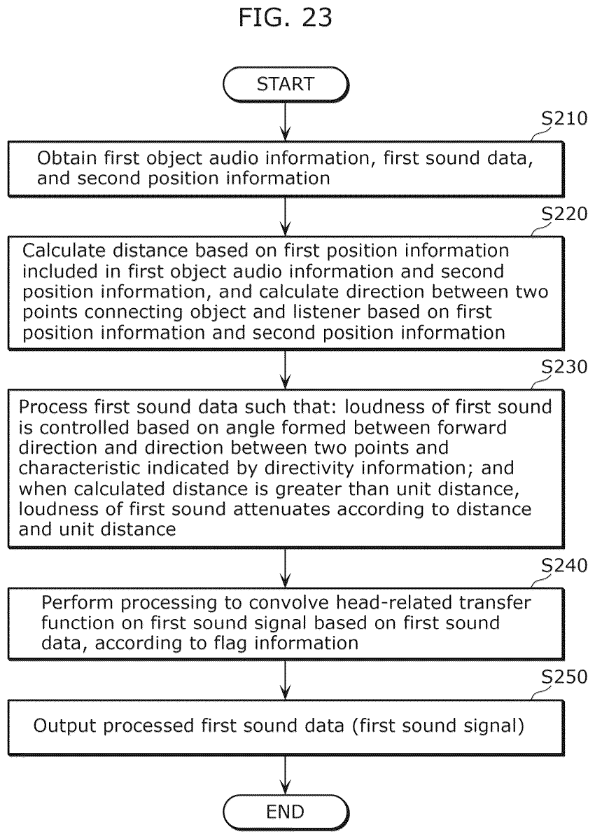

FIG. 23 is a flowchart of Operation Example 5 performed by acoustic signal processing device 200 according to the present variation.

As illustrated in FIG. 23, first, third obtainer 210 obtains first object audio information generated by information generation device 40, first sound data obtained by information generation device 40, and second position information output from headphones 20 (S210). This step S210 corresponds to the obtaining step.

Next, second calculator 220 calculates distance D between the object (electric fan F) and listener L based on (i) the first position information included in the first object audio information obtained by third obtainer 210 and (ii) the obtained second position information, and calculates the direction between two points connecting the object (electric fan F) and listener L based on the first position information included in the first object audio information obtained by third obtainer 210, and the obtained second position information (S220). This step S220 corresponds to the calculating step.

Next, second processor 240 processes the first sound data such that (i) the loudness of the first sound is controlled based on the angle formed between the above-mentioned forward direction and the direction between two points calculated by second calculator 220 and the characteristics indicated by the directivity information, and (ii) when the calculated distance D is greater than the unit distance indicated by the unit distance information included in the first object audio information obtained by third obtainer 210, the loudness of the first sound attenuates according to the calculated distance D and the unit distance (S230).

Furthermore, when the first object audio information includes flag information, second processor 240 determines, according to the flag information, whether or not to perform processing to convolve a head-related transfer function, which depends on the direction of arrival of sound, on the first sound signal based on the first sound data. Here, as one example, second processor 240 performs processing to convolve a head-related transfer function on the first sound signal based on the first sound data, according to the flag information (S240). These steps S230 and S240 correspond to the processing step.

Then, second outputter 250 outputs the first sound data (first sound signal) processed by second processor 240 (S250). This step S250 corresponds to the outputting step.

The information generation method according to the present variation can generate first object audio information in which first sound data indicating first sound (second aerodynamic sound) generated at a position related to the position of listener L due to the object is associated with the position of the object. Furthermore, the acoustic signal processing method according to the present variation processes the first sound data such that the loudness of the first sound (second aerodynamic sound) attenuates as distance D between the object and listener L increases, whereby the first sound (second aerodynamic sound) that listener L hears in the virtual space becomes similar to the first sound (second aerodynamic sound) that listener L hears in the real-world space. Stated differently, listener L can experience a sense of realism without hearing the first sound (second aerodynamic sound) that causes a sense of incongruity.

### Variation 4 of Embodiment

Hereinafter, Variation 4 of the embodiment will be described. The following description will focus on the differences from Variation 3 of the embodiment, and description of points in common will be omitted or simplified.

### Configuration

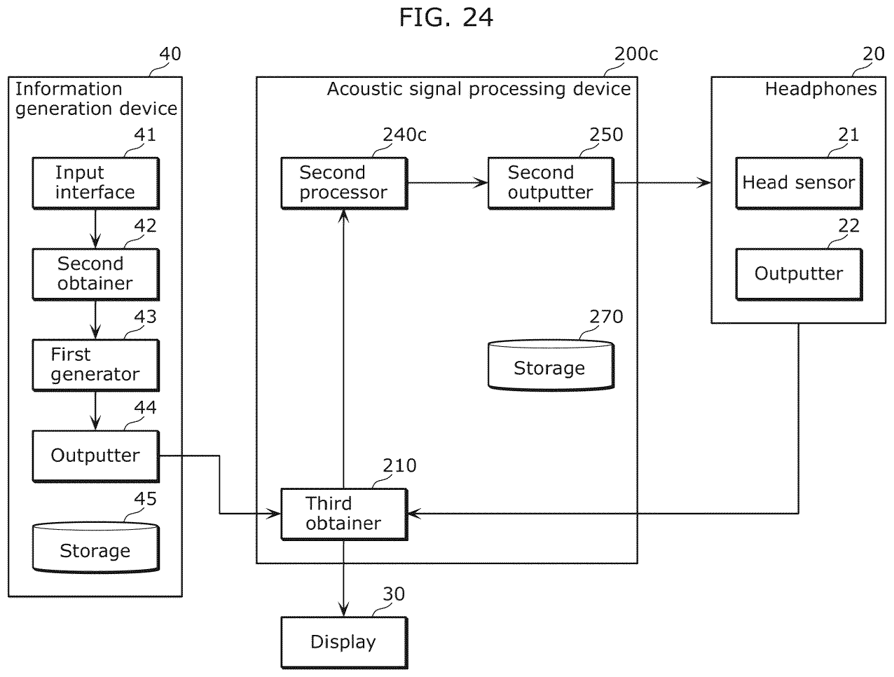

First, configurations of information generation device 40 and acoustic signal processing device 200c according to Variation 4 of the present embodiment will be described. FIG. 24 is a block diagram illustrating the functional configurations of information generation device 40 and acoustic signal processing device 200c according to the present variation.

Information generation device 40 of Variation 3 is used in the present variation. Acoustic signal processing device 200c has the same configuration as acoustic signal processing device 200 according to Variation 3, except that it does not include second calculator 220, and includes second processor 240c instead of second processor 240.

In the present variation, acoustic signal processing device 200c is a device that handles the first sound generated at a position related to the position of listener L due to the object and the second sound caused by the object. The object according to the present variation is ambulance A, the same as in Variation 2.

The first sound is the aerodynamic sound, i.e., the second aerodynamic sound, generated by wind W radiated from the object (ambulance A) reaching the ears of listener L. The second sound is the siren sound emitted from ambulance A.

As illustrated in FIG. 24, acoustic signal processing device 200c includes third obtainer 210, second processor 240c, second outputter 250, and storage 270.

Third obtainer 210 according to the present variation obtains first object audio information generated by information generation device 40, first sound data obtained by information generation device 40, and second object audio information. The second object audio information is information in which first position information indicating the position of the object (ambulance A) in the virtual space is associated with second sound data indicating a second sound caused by the object (ambulance A). Note that the second object audio information is data in which second sound data indicating the second sound is associated with first position information indicating the position where the second sound is generated, and therefore corresponds to the object audio information in conventional techniques, including the technique disclosed in PTL 1.

The second object audio information may be generated by information generation device 40 and output to acoustic signal processing device 200c. Third obtainer 210 obtains the output second object audio information.

Second processor 240c processes the first sound data obtained by third obtainer 210, and the second sound data included in the second object audio information obtained by third obtainer 210, as follows.

First, the processing applied to the second sound data will be described.

Second processor 240c performs processing to convolve a head-related transfer function, which depends on the direction of arrival of sound, on the second sound signal based on the second sound data indicated by the second object audio information obtained by third obtainer 210.

Next, the processing applied to the first sound data will be described.

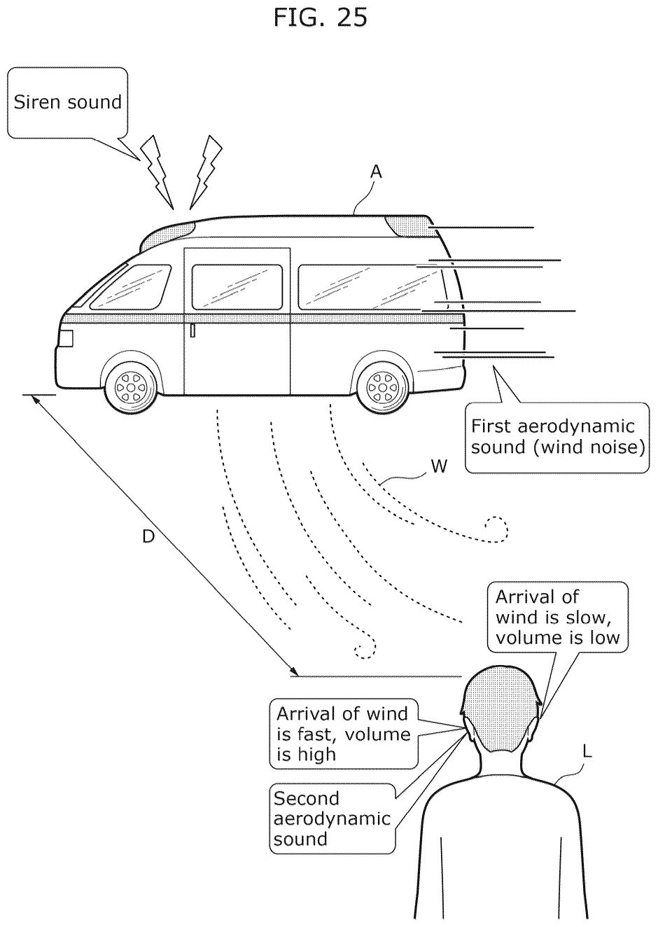

As one example, second processor 240c does not perform processing to convolve a head-related transfer function, which depends on the direction of arrival of sound, on the first sound signal based on the first sound data obtained by third obtainer 210. As another example, second processor 240c performs, on the first sound signal based on the first sound data obtained by third obtainer 210, processing dependent on the direction of arrival of wind W from ambulance A to listener L. This other example of the process will be described with reference to FIG. 25.

FIG. 25 is for illustrating processing performed by first sound data according to the present variation.

As illustrated in FIG. 25, depending on the positional relationship between the object (ambulance A) and listener L, the speed of arrival and amount of wind W may differ at the right ear and left ear of listener L. In FIG. 25, at the left ear, the arrival of wind W is faster and the amount of wind is greater, while at the right ear, the arrival of wind W is slower and the amount of wind is smaller.

Therefore, second processor 240c may perform the following processing on the first sound data as processing dependent on the direction in which wind W arrives from ambulance A to listener L. Stated differently, processing may be performed on the first sound data such that the first sound (second aerodynamic sound) heard by listener L becomes a sound that simulates the time difference in arrival and the ratio of amount of wind at both ears of listener L. This allows listener L to perceive the direction of the source of wind W.

Note that the first object audio information includes processing information indicating whether second processor 240c does not perform processing to convolve a head-related transfer function on the first sound signal, or performs processing dependent on the direction in which wind W arrives from ambulance A to listener L on the first sound signal. Second processor 240c performs processing on the first sound signal according to the processing information included in the first object audio information.

Second outputter 250 according to the present variation outputs the second sound signal processed by second processor 240c. When second processor 240c does not process the first sound signal, second outputter 250 outputs the unprocessed first sound signal. When second processor 240c does process the first sound signal, second outputter 250 outputs the processed first sound signal.

Storage 270 according to the present variation stores the head-related transfer function used by second processor 240c, and information necessary for processing that is dependent on the direction in which wind W arrives from ambulance A to listener L.

Next, Operation Examples 5 and 6 of an acoustic signal processing method performed by acoustic signal processing device 200c will be described.

### Operation Example 6

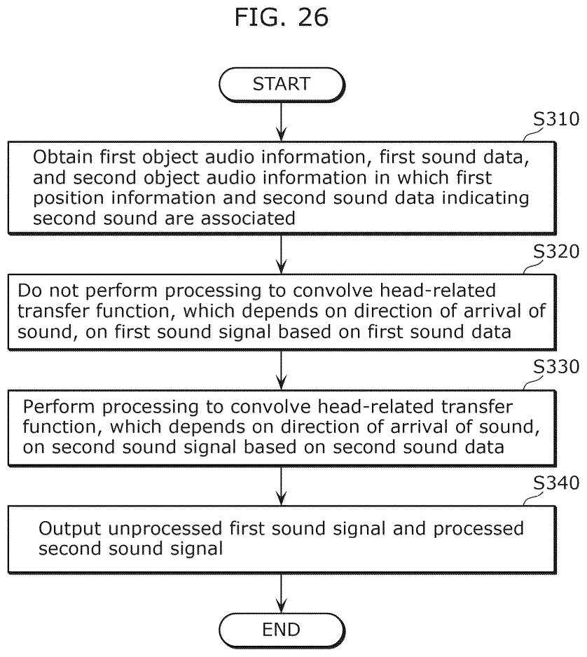

FIG. 26 is a flowchart of Operation Example 6 performed by acoustic signal processing device 200c according to the present variation. In this operation example, second processor 240c does not process the first sound signal.

As illustrated in FIG. 26, first, third obtainer 210 obtains first object audio information generated by information generation device 40, first sound data obtained by information generation device 40, and second object audio information in which first position information and second sound data are associated (S310). This step S310 corresponds to the obtaining step.

Second processor 240c does not perform processing to convolve a head-related transfer function, which depends on the direction of arrival of sound, on the first sound signal based on the first sound data obtained by third obtainer 210 (S320).

Second processor 240c performs processing to convolve a head-related transfer function, which depends on the direction of arrival of sound, on the second sound signal based on the second sound data indicated by the second object audio information obtained by third obtainer 210 (S330). These steps S320 and S330 correspond to the processing step.

Second outputter 250 outputs the first sound signal not processed by second processor 240c and the second sound signal processed by second processor 240c (S340). This step S340 corresponds to the outputting.

### Operation Example 7

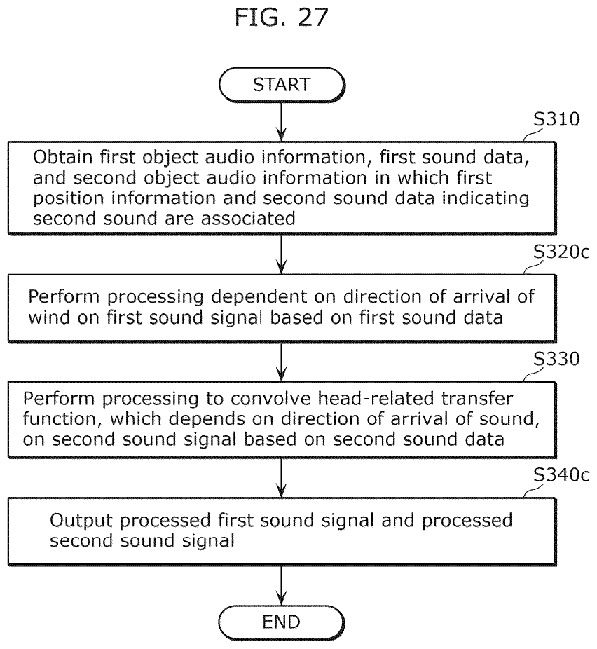

FIG. 27 is a flowchart of Operation Example 7 performed by acoustic signal processing device 200c according to the present variation. In this operation example, second processor 240c does process the first sound signal.

As illustrated in FIG. 27, first, step S310 is performed.

Second processor 240c performs, on the first sound signal based on the first sound data obtained by third obtainer 210, processing dependent on the direction of arrival of wind W from ambulance A to listener L (S320c).

Next, step S330 is performed.

Then, second outputter 250 outputs the first sound signal processed by second processor 240c and the second sound signal processed by second processor 240c (S340c).

In the present variation, the second sound that listener L hears in the virtual space becomes similar to the second sound that listener L hears in the real-world space, because a head-related transfer function is convolved with the second sound signal based on the second sound data. Therefore, listener L is even less likely to feel a sense of incongruity and can experience an even greater sense of realism.

In Operation Example 7, the first sound that listener L hears in the virtual space becomes similar to the first sound that listener L hears in the real-world space, because processing dependent on the direction of arrival of wind W is performed on the first sound signal based on the first sound data. Therefore, listener L is even less likely to feel a sense of incongruity and can experience an even greater sense of realism.

### Variation 5 of Embodiment

Hereinafter, Variation 5 of the embodiment will be described. The following description will focus on the differences from Variation 4 of the embodiment, and description of points in common will be omitted or simplified.

### Configuration

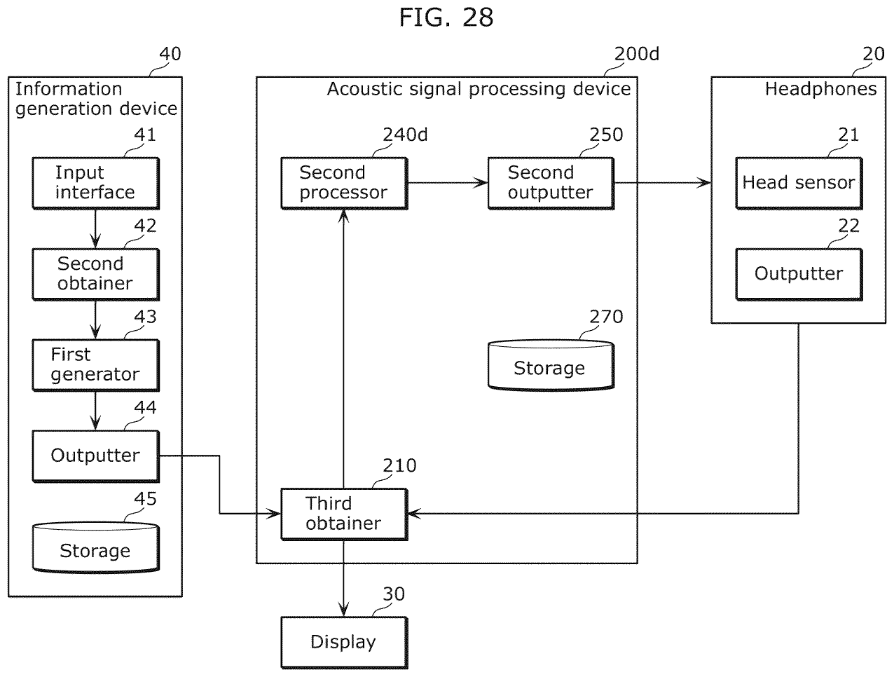

First, configurations of information generation device 40 and acoustic signal processing device 200d according to Variation 5 of the present embodiment will be described. FIG. 28 is a block diagram illustrating the functional configurations of information generation device 40 and acoustic signal processing device 200d according to the present variation.

Information generation device 40 of Variation 4 is used in the present variation. Acoustic signal processing device 200d has the same configuration as acoustic signal processing device 200c according to Variation 4, except that it includes second processor 240d instead of second processor 240c.

In Variation 4, the first sound (second aerodynamic sound) generated at a position related to the position of listener L due to a single object, ambulance A, and the second sound (siren sound) caused by the same single object, ambulance A, were handled. In Variation 5, the first sound (second aerodynamic sound) generated at a position related to the position of listener L due to a single object, ambulance A, and the third sound caused by another single object in the virtual space, which is different from the aforementioned single object, are handled.

The later other single object, like the former single object, is not particularly limited; it is sufficient if it is included in content to be displayed on display 30 that displays content (video in this example) executed in the virtual space. The former single object and the later other single object are provided in the same virtual space. Note that, for simplicity, hereinafter, the former single object may be referred to simply as the object, and the latter other single object may be referred to simply as the other object.

The third sound is a sound generated at the position of the other single object in the virtual space. Note that the third sound is a sound different from the first aerodynamic sound and the second aerodynamic sound.

In this way, in the present variation, the first sound and the third sound, or more specifically, a plurality of objects including the single object and the other single object, are handled.

Third obtainer 210 according to the present variation obtains first object audio information generated by information generation device 40, first sound data obtained by information generation device 40, and third object audio information. The third object audio information is information in which third position information indicating the position of another object in the virtual space is associated with third sound data indicating a third sound generated at the position of the other object. Note that the third object audio information is data in which third sound data indicating the third sound is associated with third position information indicating the position where the third sound is generated, and therefore corresponds to the object audio information in conventional techniques, including the technique disclosed in PTL 1.

The third object audio information may be generated by information generation device 40 and output to acoustic signal processing device 200d. Third obtainer 210 obtains the output third object audio information.

Second processor 240d processes the first sound data obtained by third obtainer 210, and the third sound data included in the third object audio information obtained by third obtainer 210, as follows.

Second processor 240d performs, on the first sound signal based on the first sound data, processing dependent on the direction of arrival of wind W from ambulance A to listener L. Second processor 240d performs processing to convolve a head-related transfer function, which depends on the direction of arrival of sound, on the third sound signal based on the third sound data indicated by the obtained third object audio information. That is, in the present variation, second processor 240d performs the same processing on the first sound signal as the processing explained with reference to FIG. 25. Moreover, second processor 240d performs the same processing on the third sound signal as the processing performed on the second sound signal according to Variation 4.

Then, second outputter 250 according to the present variation outputs the first sound signal processed by second processor 240d and the third sound signal processed by second processor 240d.

Next, Operation Example 8 of an acoustic signal processing method performed by acoustic signal processing device 200d will be described.

### Operation Example 8

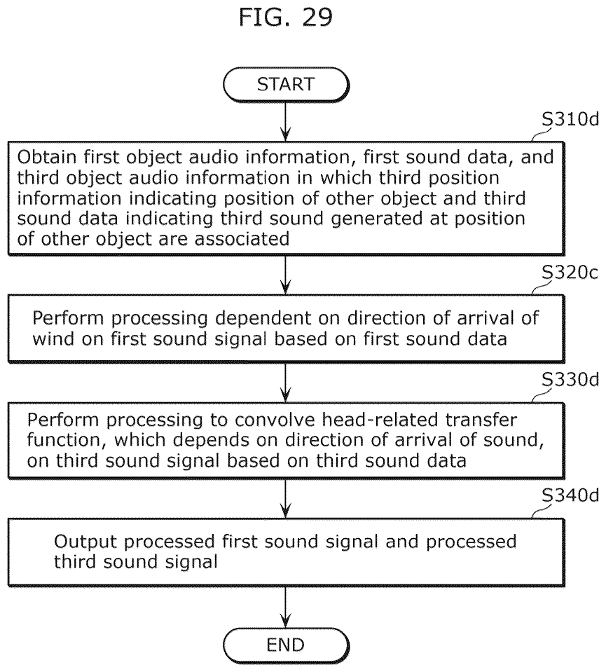

FIG. 29 is a flowchart of Operation Example 8 performed by acoustic signal processing device 200d according to the present variation.

As illustrated in FIG. 29, first, third obtainer 210 obtains first object audio information generated by information generation device 40, first sound data obtained by information generation device 40, and third object audio information in which third position information indicating the position of another object and third sound data indicating a third sound generated at the position of the other object are associated (S310d). This step S310d corresponds to the obtaining.

Second processor 240d performs, on the first sound signal based on the first sound data obtained by third obtainer 210, processing dependent on the direction of arrival of wind W from ambulance A to listener L (S320c).

Second processor 240d performs processing to convolve a head-related transfer function, which depends on the direction of arrival of sound, on the third sound signal based on the third sound data indicated by the third object audio information obtained by third obtainer 210 (S330d). This step S320c and S330d corresponds to the processing step.

Then, second outputter 250 outputs the first sound signal processed by second processor 240d and the third sound signal processed by second processor 240d (S340d). This step S340d corresponds to the outputting step.

In the present variation, when a plurality of objects including the object and the other object are provided in the virtual space, the first sound and the third sound that listener L hears in the virtual space become similar to the first sound and the third sound, respectively, that listener L hears in the real-world space. Therefore, listener L is even less likely to feel a sense of incongruity and can experience an even greater sense of realism.

### Variation 6 of Embodiment

Hereinafter, Variation 6 of the embodiment will be described. The following description will focus on the differences from Variation 3 of the embodiment, and description of points in common will be omitted or simplified.

### Configuration

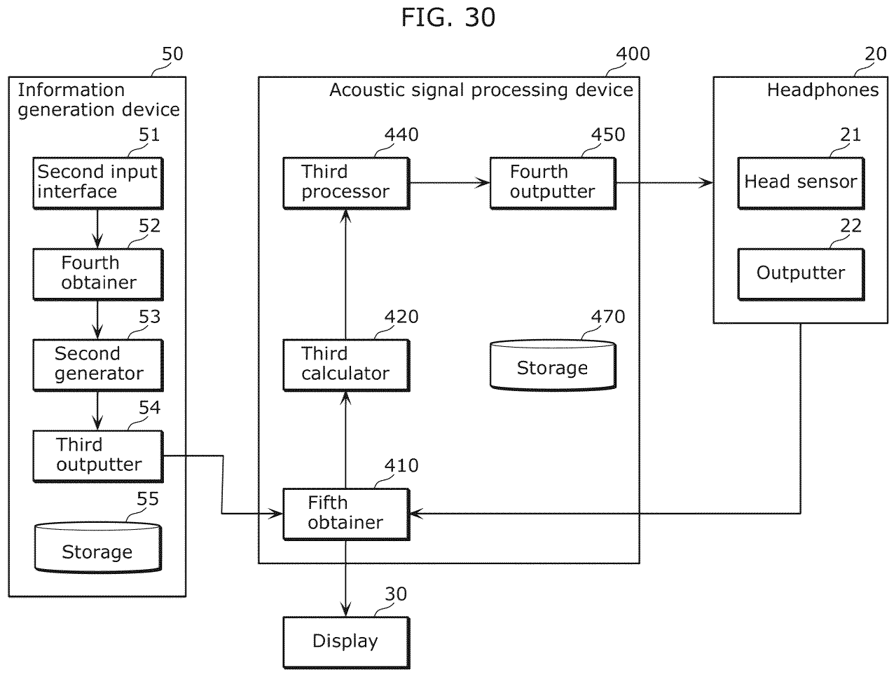

First, configurations of information generation device 50 and acoustic signal processing device 400 according to Variation 6 of the present embodiment will be described. FIG. 30 is a block diagram illustrating the functional configurations of information generation device 50 and acoustic signal processing device 400 according to the present variation.

Information generation device 50 and acoustic signal processing device 400 according to the present variation can, as in Variation 3, inhibit the occurrence of the problem explained in the Underlying Knowledge Forming Basis of the Present Disclosure section, where listener L ends up hearing the second aerodynamic sound with a sense of incongruity. In the present variation, the object is electric fan F just as in Variation 3, but the object is not limited to this example, and may be any object that can radiate wind W. Wind W radiated from the object includes wind stirred up by the movement of an object such as a moving object (ambulance A), as illustrated in FIG. 13.

Information generation device 50 is a device that generates and outputs fourth object audio information to acoustic signal processing device 400. Acoustic signal processing device 400 is a device that obtains the output fourth object audio information, and outputs sound data to headphones 20 based on the obtained fourth object audio information.

First, information generation device 50 illustrated in FIG. 30 will be described.

Information generation device 50 includes second input interface 51, fourth obtainer 52, second generator 53, third outputter 54, and storage 55.

Second input interface 51 receives operations from a user of information generation device 50 (for example, a creator of content executed in the virtual space). Second input interface 51 is specifically implemented by hardware buttons, but may also be implemented by a touch panel or the like.

Fourth obtainer 52 obtains a generation position of a first wind blowing in the virtual space, a first wind direction of the first wind, and a first assumed wind speed.

In the present variation, the first wind blowing in the virtual space is wind W radiated from electric fan F, which is the object. That is, the generation position of the first wind is the position where electric fan F is placed. In the present variation, it is sufficient that the first wind is blowing in the virtual space, and electric fan F, which is the object radiating this first wind, does not need to be placed in the virtual space (more specifically, the virtual space where listener L is located). Stated differently, electric fan F may be placed outside the virtual space where listener L is located, and it is sufficient that the first wind, which is wind W radiated from this electric fan F, reaches the virtual space. It goes without saying that, electric fan F, which is the object radiating the first wind, may be placed in the virtual space where listener L is located.

The first wind direction is the wind direction of the first wind, and is the forward direction of wind W radiated from the object (electric fan F), e.g., direction Df illustrated in FIG. 19. The first assumed wind speed may be the speed of the first wind, and here, it is the speed of the first wind at a position separated by the unit distance, which is a reference distance, from the generation position in the first wind direction. Stated differently, the first assumed wind speed is, for example, wind speed wsF illustrated in FIG. 19.

As described above, since the first wind, which is wind W radiated from the object, i.e., electric fan F, is blowing in the virtual space, listener L will hear the aerodynamic sound (second aerodynamic sound) generated by this wind W (first wind) reaching the ears of listener L.

Note that in the present variation, second input interface 51 receives an operation from a user indicating a generation position of the first wind, a first wind direction, and a first assumed wind speed. Stated differently, the user inputs the generation position of the first wind, the first wind direction, and the first assumed wind speed by operating second input interface 51, and fourth obtainer 52 obtains the input generation position of the first wind, first wind direction, and first assumed wind speed.

Second input interface 51 may receive an operation from a user specifying that the unit distance is a second specified value. Stated differently, the user sets the unit distance to be the second specified value by operating second input interface 51.

Second generator 53 generates fourth object audio information in which the generation position, the first wind direction, and the first assumed wind speed obtained by fourth obtainer 52 are associated.

Note that second input interface 51 may receive an operation from a user specifying directivity information indicating characteristics according to the direction of the first wind. The directivity information is the same as the information explained with reference to FIG. 19 and the like. When such an operation is received, second generator 53 generates fourth object audio information in which the generation position, the first wind direction, and the first assumed wind speed are associated with the directivity information indicated by the operation received by second input interface 51.

Storage 55 is a storage device that stores computer programs to be executed by second input interface 51, fourth obtainer 52, second generator 53, and third outputter 54. Note that storage 55 is assumed to store aerodynamic sound core information including a representative wind speed and aerodynamic sound data indicating aerodynamic sound (second aerodynamic sound) generated by wind blowing at the representative wind speed reaching the ears of listener L in the virtual space. However, the aerodynamic sound core information does not necessarily need to be stored in information generation device 50, and may be stored in memory independent from information generation device 50.

Note that in the present variation, second input interface 51 receives an operation from a user indicating aerodynamic sound core information. Stated differently, the user inputs the aerodynamic sound core information by operating second input interface 51, and the input aerodynamic sound core information is stored in storage 55.

The aerodynamic sound core information includes a representative wind speed indicating an example value of one wind speed, and aerodynamic sound data indicating aerodynamic sound generated by wind at this representative wind speed reaching the ears of listener L, and is a database used for information processing in acoustic signal processing device 400 to be described later. The aerodynamic sound data indicating the aerodynamic sound (second aerodynamic sound) indicates, for example, the loudness of the second aerodynamic sound. The aerodynamic sound core information may also include data indicating the distribution of frequency components of the aerodynamic sound (hereinafter this data may be referred to as frequency data). For example, the frequency data is data indicating the frequency characteristics of the aerodynamic sound (second aerodynamic sound).

Such aerodynamic sound core information can also be used in third processor 440 (to be described later) to determine, from the ear-reaching wind speed, the loudness of the second aerodynamic sound that listener L hears.

The aerodynamic sound core information may include a plurality of pairs of a representative wind speed and aerodynamic sound data at that representative wind speed. For example, as illustrated in FIG. 4C, the wind speeds at respective positions where the wind speeds differ due to different distances from the source of wind W may be set as representative wind speeds, and pairs may be formed with the representative wind speeds and the frequency data corresponding to those representative wind speeds, and the aerodynamic sound core information may include a plurality of such pairs. The aerodynamic sound core information configured in this manner can also be used in third processor 440 (to be described later) to determine the loudness of the second aerodynamic sound that listener L hears, using the ear-reaching wind speed as an index.

Third outputter 54 outputs the fourth object audio information generated by second generator 53 and the aerodynamic sound core information stored in storage 55 to acoustic signal processing device 400.

Further, acoustic signal processing device 400 illustrated in FIG. 30 will be described.

As illustrated in FIG. 30, acoustic signal processing device 400 includes fifth obtainer 410, third calculator 420, third processor 440, fourth outputter 450, and storage 470.

Fifth obtainer 410 obtains the fourth object audio information and the aerodynamic sound core information output by information generation device 50, and second position information indicating the position of listener L in the virtual space. Fifth obtainer 410 obtains the second position information from headphones 20 (head sensor 21, more specifically). The source is however not limited thereto. Here, the aerodynamic sound core information includes frequency data.

Third calculator 420 calculates distance D between the generation position (i.e., electric fan F) and listener L based on the generation position included in the fourth object audio information obtained by fifth obtainer 410, and the obtained second position information. Third calculator 420 calculates distance D using the same method as first calculator 120 according to the embodiment.

Furthermore, third calculator 420 calculates the direction between two points connecting the object (electric fan F) and listener L based on the generation position included in the fourth object audio information obtained by fifth obtainer 410, and the obtained second position information.

Third processor 440 processes the aerodynamic sound data such that the loudness of the aerodynamic sound attenuates as distance D calculated by third calculator 420 increases.

Here, third processor 440 may process the aerodynamic sound data such that the loudness of the aerodynamic sound (second aerodynamic sound) attenuates according to the y-th power of the value obtained by dividing the representative wind speed by the ear-reaching wind speed, which is the speed of the first wind when it reaches the ears of listener L. Stated differently, third processor 440 processes the aerodynamic sound data based on distance D, the representative wind speed, and the ear-reaching wind speed. Note that the ear-reaching wind speed decreases as distance D calculated by third calculator 420 increases. The ear-reaching wind speed is a value that attenuates according to the z-th power of the value obtained by dividing distance D calculated by third calculator 420 by the unit distance.

More specifically, third processor 440 performs the following processing.

First, let the angle formed between the first wind direction (for example, direction Df illustrated in FIG. 19), which is the forward direction of wind W, and the calculated direction between two points be θ. In such cases, when the ear-reaching wind speed, which is the speed of the first wind when it reaches the ears of listener L, is denoted as Se1, Se1 satisfies Equation 10.

$$Se 1 = first assumed wind speed \times value at angle θ indicated by the directivity information \times \{ ( unit distance as reference distance / distance D ) \} \hat{} z \qquad ( Equation 10 )$$

For example, if θ is θ1, the value at angle θ (angle θ1) indicated by the directivity information is C1. The value obtained by dividing the representative wind speed by ear-reaching wind speed Se1 is defined as R1. Furthermore, V3, which is the loudness of the second aerodynamic sound that listener L hears, satisfies Equation 11.

$$V 3 = loudness indicated by the aerodynamic sound data of the aerodynamic sound core information \times \{ ( 1 / R 1 ) \} \hat{} γ \qquad ( Equation 11 )$$

Moreover, z may satisfy Equation 12.

$$z = 1 \qquad ( Equation 12 )$$

Furthermore, γ and z may satisfy Equation 13.

$$γ \times z < 4 \qquad ( Equation 13 )$$

The method for determining loudness V3 of the second aerodynamic sound that listener L hears from ear-reaching wind speed Se1 is not limited to the above. For example, the aerodynamic sound core information may include a plurality of pairs of representative wind speeds and frequency data at those speeds, and third processor 440 may detect frequency data corresponding to a representative wind speed close to Se1, and generate a second aerodynamic sound having a predetermined loudness by applying that frequency data. Stated differently, instead of calculating loudness V3 from Se1 using an equation, aerodynamic sound data may be detected using Se1 as an index, and the predetermined loudness may be achieved by applying it. Since the loudness of the second aerodynamic sound decreases as the wind speed decreases, the aerodynamic sound core information should include frequency data such that when frequency data corresponding to a smaller representative wind speed is applied, the resulting loudness decreases. Since Se1 decreases as distance D increases, loudness V3 can be controlled to decrease as distance D increases.

Fourth outputter 450 outputs the aerodynamic sound data processed by third processor 440. Here, fourth outputter 450 outputs the aerodynamic sound data to headphones 20. This allows headphones 20 to reproduce the second aerodynamic sound indicated by the output aerodynamic sound data.

Storage 470 is a storage device that stores computer programs to be executed by fifth obtainer 410, third calculator 420, third processor 440, and fourth outputter 450.

Note that when the aerodynamic sound core information obtained by fifth obtainer 410 includes frequency data, third processor 440 may perform the following processing.

Third processor 440 processes the aerodynamic sound data such that the distribution of frequency components of the aerodynamic sound (second aerodynamic sound) shifts toward lower frequencies as distance D calculated by third calculator 420 increases.

Here, third processor 440 processes the aerodynamic sound data such that the distribution of frequency components of the aerodynamic sound is shifted to a frequency scaled by the reciprocal of the value (R1 mentioned above) obtained by dividing the representative wind speed by the ear-reaching wind speed. Stated differently, the distribution of frequency components included in the aerodynamic sound core information (the distribution of frequency components before processing) is processed by third processor 440, resulting in a distribution of frequency components shifted to frequencies obtained by multiplying the frequencies by the reciprocal of R1.

Thus, third processor 440 processes the aerodynamic sound data based on distance D, the representative wind speed, and the ear-reaching wind speed. The ear-reaching wind speed decreases as the calculated distance D increases. The ear-reaching wind speed is a value that attenuates according to the z-th power of the value obtained by dividing the calculated distance D by the unit distance. In this case as well, z satisfies the above Equation 12.

Next, Operation Example 9 of an information generation method performed by information generation device 50, and Operation Examples 10 and 11 of an acoustic signal processing method performed by acoustic signal processing device 400 will be described.

### Operation Example 9

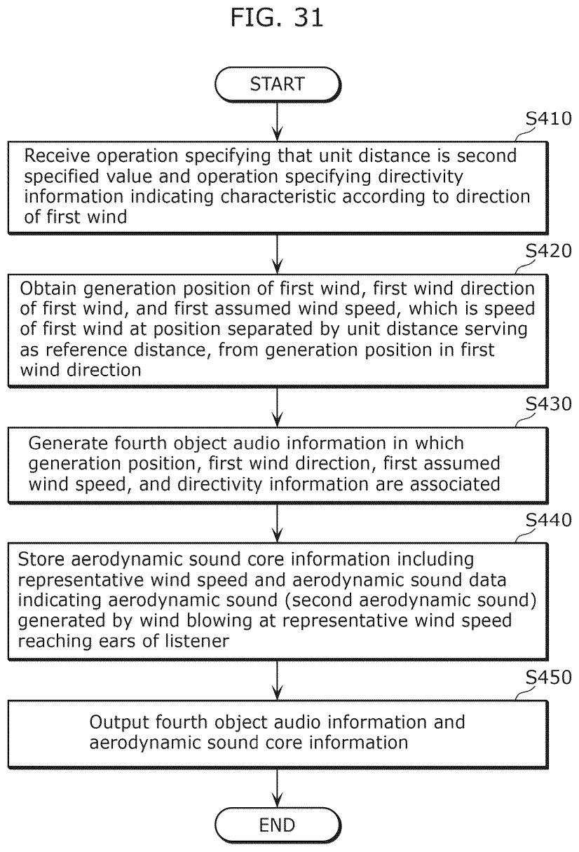

FIG. 31 is a flowchart of Operation Example 9 performed by information generation device 50 according to the present variation.

As illustrated in FIG. 31, first, second input interface 51 receives an operation from a user specifying that a unit distance is a second specified value and an operation specifying directivity information indicating characteristics according to the direction of a first wind (S410). Note that at this time, second input interface 51 may receive an operation from a user indicating a generation position of the first wind, a first wind direction, and a first assumed wind speed. Stated differently, the user inputs the unit distance, the directivity information, the generation position of the first wind, the first wind direction, and the first assumed wind speed by operating second input interface 51. This step S410 corresponds to the receiving step.

Next, fourth obtainer 52 obtains a generation position of the first wind, a first wind direction of the first wind, and a first assumed wind speed, which is the speed of the first wind at a position separated by the unit distance, which is a reference distance, from the generation position in the first wind direction (S420). Fourth obtainer 52 may also obtain directivity information. Here, fourth obtainer 52 obtains the generation position of the first wind, the first wind direction of the first wind, the first assumed wind speed, and the directivity information input in step S410. This step S420 corresponds to the obtaining step.

Next, second generator 53 generates fourth object audio information in which the generation position, the first wind direction, the first assumed wind speed, and the directivity information are associated (S430). This step S430 corresponds to the generating step.

Next, storage 55 stores aerodynamic sound core information including a representative wind speed and aerodynamic sound data indicating aerodynamic sound generated by wind blowing at the representative wind speed reaching the ears of listener L (S440). This aerodynamic sound core information may include data indicating the distribution of frequency components of the aerodynamic sound. This step S440 corresponds to the storing step.

Third outputter 54 outputs the fourth object audio information generated by second generator 53 and the aerodynamic sound core information stored in storage 55 to acoustic signal processing device 400 (S450). This step S450 corresponds to the outputting step.

### Operation Example 10

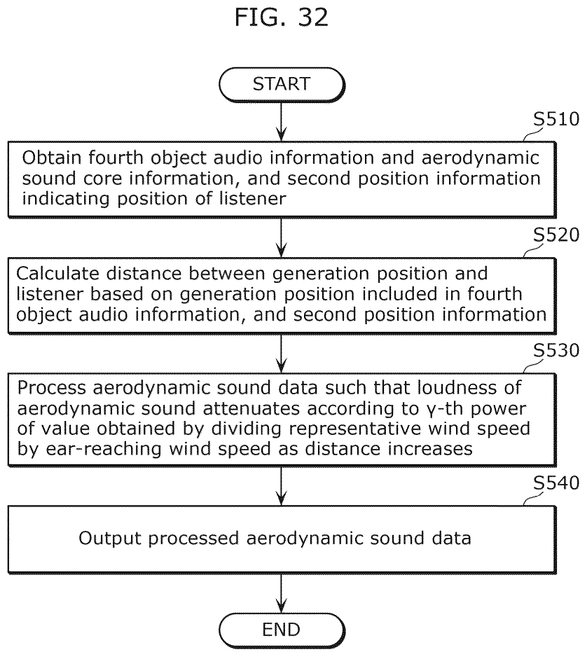

FIG. 32 is a flowchart of Operation Example 10 performed by acoustic signal processing device 400 according to the present variation. Operation Example 10 is an example in which third processor 440 controls the loudness of the aerodynamic sound.

As illustrated in FIG. 32, first, fifth obtainer 410 obtains the fourth object audio information and the aerodynamic sound core information output by information generation device 50, and second position information indicating the position of listener L in the virtual space (S510). This step S510 corresponds to the obtaining step.

Next, third calculator 420 calculates distance D between the generation position and listener L based on the generation position included in the fourth object audio information obtained by fifth obtainer 410, and the obtained second position information (S520). Note that, at this time, third calculator 420 calculates the direction between two points connecting the object (electric fan F) and listener L based on the generation position included in the fourth object audio information obtained by fifth obtainer 410, and the obtained second position information. This step S520 corresponds to the calculating step.

Next, third processor 440 processes the aerodynamic sound data such that the loudness of the aerodynamic sound attenuates as distance D calculated by third calculator 420 increases (S530). More specifically, third processor 440 processes the aerodynamic sound data such that the loudness of the aerodynamic sound attenuates according to the y-th power of the value obtained by dividing the representative wind speed by the ear-reaching wind speed. This step S530 corresponds to the processing step.

Fourth outputter 450 outputs the aerodynamic sound data processed by third processor 440 (S540). This step S540 corresponds to the outputting step.

### Operation Example 11

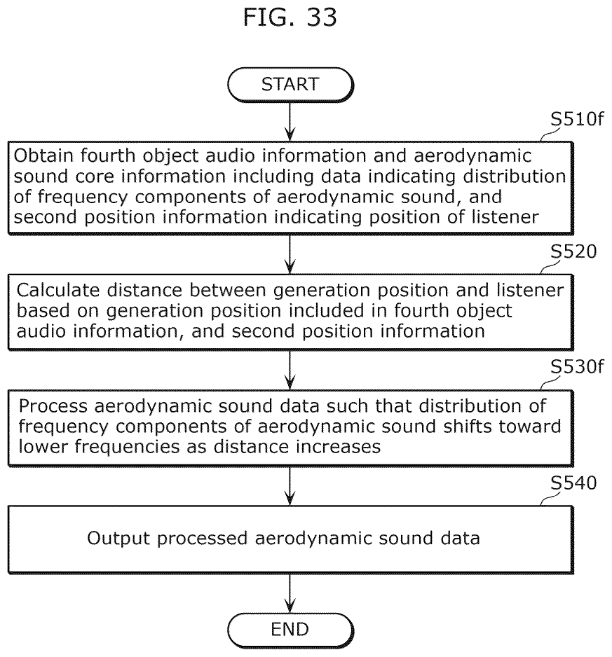

FIG. 33 is a flowchart of Operation Example 11 performed by acoustic signal processing device 400 according to the present variation. Operation Example 11 is an example in which third processor 440 controls the frequency components of the aerodynamic sound.

As illustrated in FIG. 33, first, fifth obtainer 410 obtains the fourth object audio information and the aerodynamic sound core information including data indicating a distribution of frequency components of the aerodynamic sound output by information generation device 50, and second position information indicating the position of listener L in the virtual space (S510f). This step S510f corresponds to the obtaining step.

Next, the processing in step S520 is performed.

Next, third processor 440 processes the aerodynamic sound data such that the distribution of frequency components of the aerodynamic sound shifts toward lower frequencies as distance D calculated by third calculator 420 increases (S530f). More specifically, third processor 440 processes the aerodynamic sound data such that the distribution of frequency components of the aerodynamic sound is shifted to a frequency scaled by the reciprocal of the value (R1 mentioned above) obtained by dividing the representative wind speed by the ear-reaching wind speed (S530f). This step S530f corresponds to the processing step.

Fourth outputter 450 outputs the aerodynamic sound data processed by third processor 440 (S540). This step S540 corresponds to the outputting step.

The information generation method according to the present variation can generate fourth object audio information in which the generation position, the first wind direction, and the first assumed wind speed are associated. The acoustic signal processing method according to the present variation, for example, processes the aerodynamic sound data such that the loudness of the aerodynamic sound (second aerodynamic sound) attenuates as distance D between the object and listener L increases. The acoustic signal processing method according to the present variation, for example, also processes the aerodynamic sound data such that the distribution of frequency components of the aerodynamic sound shifts toward lower frequencies as distance D between the object and listener L increases. Therefore, the aerodynamic sound (second aerodynamic sound) that listener L hears in the virtual space becomes similar to the aerodynamic sound (second aerodynamic sound) that listener L hears in the real-world space. Stated differently, listener L can experience a sense of realism without hearing the aerodynamic sound (second aerodynamic sound) that causes a sense of incongruity.

### Variation 7 of Embodiment

Hereinafter, Variation 7 of the embodiment will be described. The following description will focus on the differences from Variation 6 of the embodiment, and description of points in common will be omitted or simplified.

### Configuration

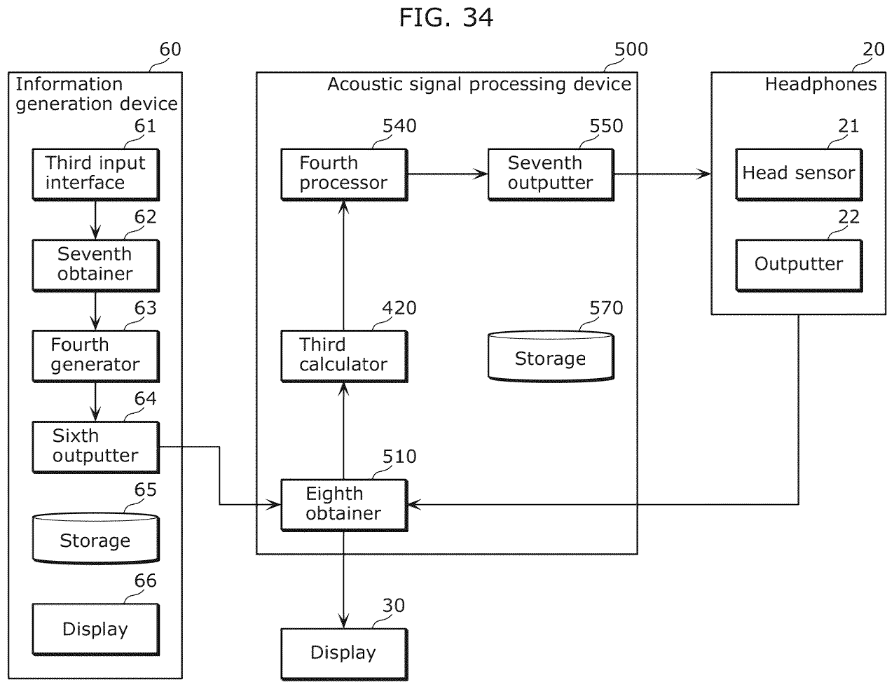

First, configurations of information generation device 60 and acoustic signal processing device 500 according to Variation 7 of the present embodiment will be described. FIG. 34 is a block diagram illustrating the functional configurations of information generation device 60 and acoustic signal processing device 500 according to the present variation.

Information generation device 60 and acoustic signal processing device 500 according to the present variation can, as in Variation 6, inhibit the occurrence of the problem explained in the Underlying Knowledge Forming Basis of the Present Disclosure section, where listener L ends up hearing the second aerodynamic sound with a sense of incongruity. In the present variation, as in Variation 6, the object is electric fan F.

In Variation 6, the first wind, which is wind W radiated from electric fan F as the object in the virtual space, was handled. In Variation 7, the first wind and the second wind, which is a wind different from the first wind, are handled. The first wind according to the present variation is, as in Variation 6, wind W radiated from electric fan F, which is the object in the virtual space. The second wind does not need to be a wind caused by an object in the virtual space. In the present variation, the second wind is a wind that occurred naturally in the real-world space and is reproduced in the virtual space (hereinafter referred to as natural wind). Since the second wind is a natural wind, its generation position cannot be specified in the virtual space.

Information generation device 60 is a device that generates and outputs fourth object audio information related to the first wind and fifth object audio information related to the second wind to acoustic signal processing device 500. Acoustic signal processing device 500 is a device that obtains the output fourth object audio information and fifth object audio information, and outputs sound data to headphones 20 based on the obtained fourth object audio information and fifth object audio information.

First, information generation device 60 illustrated in FIG. 34 will be described.

Information generation device 60 includes third input interface 61, seventh obtainer 62, fourth generator 63, sixth outputter 64, storage 65, and display 66.

Third input interface 61 receives operations from a user of information generation device 60 (for example, a creator of content executed in the virtual space). Third input interface 61 is specifically implemented by hardware buttons, but may also be implemented by a touch panel or the like.

Seventh obtainer 62 obtains a generation position of a first wind blowing in the virtual space, a first wind direction of the first wind, a first assumed wind speed, a second wind direction of a second wind blowing in the virtual space, and a second assumed wind speed.

In the present variation, the first wind blowing in the virtual space is, as in Variation 6, wind W radiated from electric fan F, which is the object. That is, the generation position of the first wind is the position where electric fan F is placed. In the present variation as well, as in Variation 6, it is sufficient that the first wind is blowing in the virtual space, and electric fan F, which is the object radiating this first wind, does not need to be placed in the virtual space (more specifically, the virtual space where listener L is located). Stated differently, as in Variation 6, electric fan F, which is the object radiating the first wind, may or may not be placed in the virtual space where listener L is located.

The first wind direction is the wind direction of the first wind, and is the forward direction of wind W radiated from the object (electric fan F), e.g., direction Df illustrated in FIG. 19. The first assumed wind speed according to the present variation may be any value that indicates the speed of the first wind. Here, the first assumed wind speed is, as in Variation 6, the speed of the first wind at a position separated by the unit distance, which is a reference distance, from the generation position in the first wind direction. Stated differently, the first assumed wind speed is, for example, wind speed wsF illustrated in FIG. 19.

As described above, since the first wind, which is wind W radiated from the object, i.e., electric fan F, is blowing in the virtual space, listener L will hear the aerodynamic sound (second aerodynamic sound) generated by this wind W (first wind) reaching the ears of listener L.

The second wind is a natural wind, and the second wind direction is the direction of the second wind. For example, when the second wind is a south-southwest wind, the second wind direction indicates south-southwest. In such cases, it goes without saying that it is necessary to predetermine the relationship between the geometric or mathematical direction indicating direction in the virtual space and the geographical direction indicating east, west, south, and north.

The second assumed wind speed is the speed of the second wind. The second wind is a natural wind, and therefore, regardless of location within the virtual space, the second assumed wind speed indicates a constant value. Stated differently, regardless of the position of listener L in the virtual space, listener L will be exposed the second wind with a constant wind speed.

Since the second wind is blowing in the virtual space, listener L will hear the aerodynamic sound (second aerodynamic sound) generated by this second wind reaching the ears of listener L.

Therefore, in the present variation, listener L will hear at least one of the second aerodynamic sound due to the first wind or the second aerodynamic sound due to the second wind.

Note that in the present variation, third input interface 61 receives an operation from a user indicating a generation position of the first wind, a first wind direction, a first assumed wind speed, a second wind direction, and a second assumed wind speed. Stated differently, the user inputs the generation position of the first wind, the first wind direction, the first assumed wind speed, the second wind direction, and the second assumed wind speed by operating third input interface 61, and seventh obtainer 62 obtains the input generation position of the first wind, first wind direction, first assumed wind speed, second wind direction, and second assumed wind speed. Third input interface 61 receives an operation from a user indicating the first assumed wind speed and the second assumed wind speed. Details of this process will be described later when discussing the processes performed by display 66.

Third input interface 61 may receive an operation from a user specifying that the unit distance is a second specified value. Stated differently, the user sets the unit distance to be the second specified value by operating third input interface 61.

Fourth generator 63 generates fourth object audio information in which the generation position, the first wind direction, and the first assumed wind speed obtained by seventh obtainer 62 are associated. Fourth generator 63 generates fifth object audio information in which the second wind direction and the second assumed wind speed obtained by seventh obtainer 62 are associated.

Note that third input interface 61 may receive an operation from a user specifying directivity information indicating characteristics according to the direction of the first wind. The directivity information is the same as the information explained with reference to FIG. 19 and the like. When such an operation is received, fourth generator 63 generates fourth object audio information in which the generation position, the first wind direction, and the first assumed wind speed are associated with the directivity information indicated by the operation received by third input interface 61.

Storage 65 is a storage device that stores computer programs to be executed by third input interface 61, seventh obtainer 62, fourth generator 63, sixth outputter 64, and display 66. Storage 65 stores aerodynamic sound core information including a representative wind speed and aerodynamic sound data indicating aerodynamic sound (second aerodynamic sound) generated by wind blowing at the representative wind speed reaching the ears of listener L in the virtual space.

Note that in the present variation, third input interface 61 receives an operation from a user indicating aerodynamic sound core information. Stated differently, the user inputs the aerodynamic sound core information by operating third input interface 61, and the input aerodynamic sound core information is stored in storage 65.

The aerodynamic sound core information includes a representative wind speed indicating an example value of one wind speed, and aerodynamic sound data indicating aerodynamic sound generated by wind at this representative wind speed reaching the ears of listener L, and is a database used for information processing in acoustic signal processing device 500 to be described later. The aerodynamic sound data indicating the aerodynamic sound (second aerodynamic sound) indicates, for example, the loudness of the second aerodynamic sound.

Sixth outputter 64 outputs the fourth object audio information generated by fourth generator 63 and the fifth object audio information generated by fourth generator 63. More specifically, when the first wind generation position is in the virtual space (more specifically, the virtual space where listener L is located), sixth outputter 64 outputs the fourth object audio information generated by fourth generator 63. When the first wind generation position is not in the virtual space, sixth outputter 64 outputs the fifth object audio information generated by fourth generator 63. Sixth outputter 64 outputs the fourth object audio information or the fifth object audio information to acoustic signal processing device 500. Sixth outputter 64 outputs the aerodynamic sound core information stored in storage 65 to acoustic signal processing device 500.

Display 66 is a display device that displays an image in which wind speeds are associated with words expressing those wind speeds. Display 30 is, for example, a display panel, such as a liquid crystal panel or an organic electroluminescence (EL) panel.

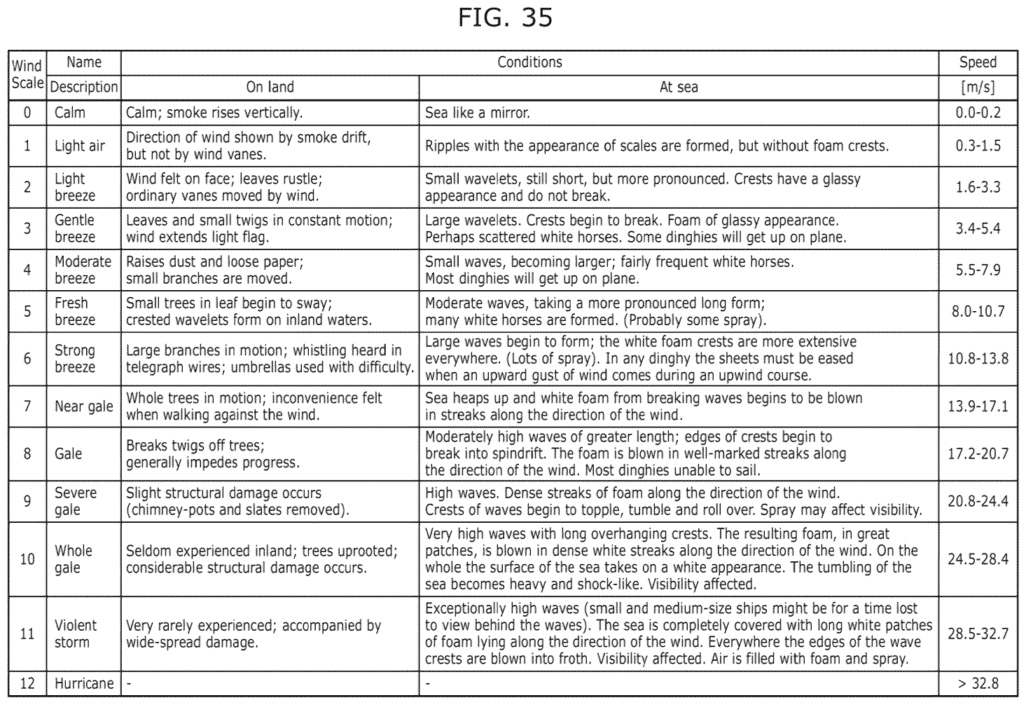

FIG. 35 illustrates one example of an image displayed on display 66 according to the present variation. The image is an image in which wind speeds are associated with words expressing those wind speeds. The image indicates, for example, that when the wind speed is 0.0-0.2 m/s, the word expressing this wind speed is “calm”. FIG. 35 also gives explanations for when wind of that wind speed is blowing under the wind conditions “on land” and “at sea”. The image may include characters, figures, and illustrations.

The user visually recognizes the image displayed on display 66. Third input interface 61 receives a first operation from the user specifying a wind speed indicated by the image displayed as the first assumed wind speed, and a second operation specifying a wind speed indicated by the image displayed as the second assumed wind speed. Stated differently, the user inputs the first assumed wind speed and the second assumed wind speed by operating third input interface 61, and seventh obtainer 62 obtains the input first assumed wind speed and second assumed wind speed.

Further, acoustic signal processing device 500 illustrated in FIG. 34 will be described.

Acoustic signal processing device 500 performs processing on the second aerodynamic sound due to the first wind related to the fourth object audio information when the fourth object audio information is output by information generation device 60. Acoustic signal processing device 500 performs processing on the second aerodynamic sound due to the second wind related to the fifth object audio information when the fifth object audio information is output by information generation device 60.

As illustrated in FIG. 34, acoustic signal processing device 500 includes eighth obtainer 510, third calculator 420, fourth processor 540, seventh outputter 550, and storage 570.

Eighth obtainer 510 obtains the fourth object audio information or the fifth object audio information output by information generation device 60. Eighth obtainer 510 obtains second position information indicating the position of listener L in the virtual space, and aerodynamic sound core information output by information generation device 60. Eighth obtainer 510 obtains the second position information from headphones 20 (head sensor 21, more specifically). The source is however not limited thereto.

When eighth obtainer 510 obtains the fourth object audio information, that is, when the generation position of the first wind is in the virtual space (more specifically, the virtual space where listener L is located), third calculator 420 performs the following processing. That is, third calculator 420 calculates distance D between the generation position (i.e., electric fan F) and listener L based on the generation position included in the fourth object audio information obtained by eighth obtainer 510, and the obtained second position information. Third calculator 420 calculates distance D using the same method as first calculator 120 according to the embodiment.

Furthermore, third calculator 420 calculates the direction between two points connecting the object (electric fan F) and listener L based on the generation position included in the fourth object audio information obtained by eighth obtainer 510, and the obtained second position information.

When the fourth object audio information is obtained by eighth obtainer 510, fourth processor 540 processes the aerodynamic sound data included in the aerodynamic sound core information based on the position indicated by the second position information obtained by eighth obtainer 510. That is, in this case, processing for the second aerodynamic sound due to the first wind is performed. More specifically, fourth processor 540 may, like third processor 440 according to Variation 6, process the aerodynamic sound data such that the loudness of the aerodynamic sound attenuates as distance D calculated by third calculator 420 increases. Distance D calculated by third calculator 420 is a value that depends on the position indicated by the second position information. In this case, the aerodynamic sound data processed by fourth processor 540 is data indicating the second aerodynamic sound due to the first wind.

When the fifth object audio information is obtained by eighth obtainer 510, fourth processor 540 processes the aerodynamic sound data included in the aerodynamic sound core information irrespective of the position indicated by the second position information obtained by eighth obtainer 510. The second wind is a natural wind, and therefore, the second assumed wind speed of the second wind indicates a constant value regardless of the position of listener L indicated by the second position information. Therefore, fourth processor 540 processes the aerodynamic sound data regardless of the position indicated by the second position information.

For example, when the fifth object audio information is obtained, fourth processor 540 performs the following processing.

When the ear-reaching wind speed, which is the speed of the second wind when it reaches the ears of listener L, is denoted as Se2, Se2 satisfies Equation 14.

$$Se 2 = second assumed wind speed \qquad ( Equation 14 )$$

The value obtained by dividing the representative wind speed by ear-reaching wind speed Se2 is defined as R2. Furthermore, V5, which is the loudness of the second aerodynamic sound that listener L hears, satisfies Equation 15.

$$V 5 = loudness indicated by the aerodynamic sound data of the aerodynamic sound core information \times \{ ( 1 / R 2 ) \} \hat{} γ \qquad ( Equation 15 )$$

Storage 570 is a storage device that stores computer programs to be executed by eighth obtainer 510, third calculator 420, fourth processor 540, and seventh outputter 550.

Stated differently, in the present variation, for the first wind, which is wind W radiated from the object, processing is performed according to the position of listener L. However, for the second wind, which is natural wind, processing is performed that does not depend on the position of listener L, rather than processing according to the position of listener L.

Next, Operation Example 12 of an information generation method performed by information generation device 60, and Operation Example 13 of an acoustic signal processing method performed by acoustic signal processing device 500 will be described.

### Operation Example 12

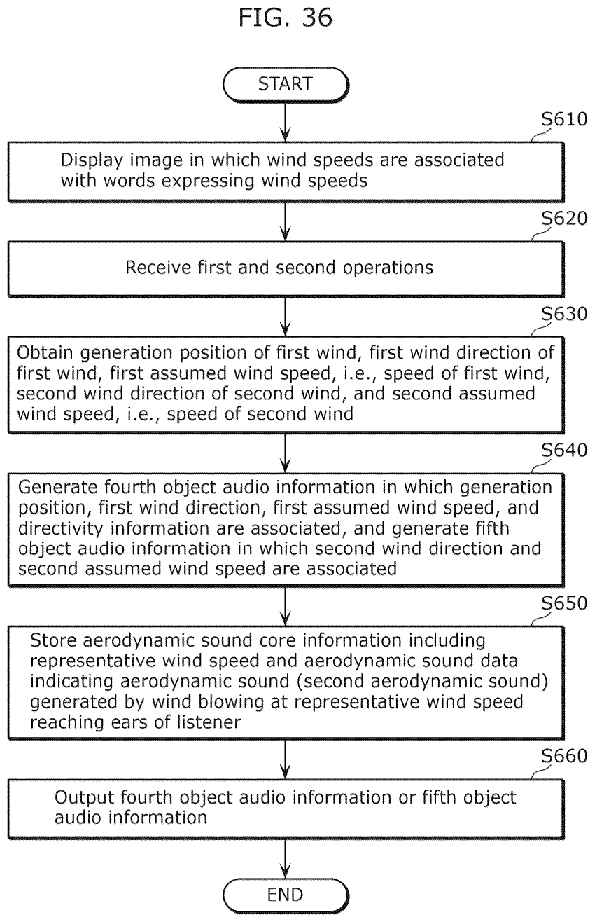

FIG. 36 is a flowchart of Operation Example 12 performed by information generation device 60 according to the present variation. As illustrated in FIG. 36, first, display 66 displays an image in which wind speeds are associated with words expressing those wind speeds (S610).

Next, third input interface 61 receives a first operation from the user specifying a wind speed indicated by the image displayed as the first assumed wind speed, and a second operation specifying a wind speed indicated by the image displayed as the second assumed wind speed (S620). Note that at this time, third input interface 61 may receive an operation from a user indicating a generation position of the first wind, a first wind direction, and a second wind direction. Stated differently, the user inputs the generation position of the first wind, the first wind direction, the first assumed wind speed, the second wind direction, and the second assumed wind speed by operating third input interface 61. This step S620 corresponds to the receiving step.

Next, seventh obtainer 62 obtains a generation position of the first wind, a first wind direction of the first wind, a first assumed wind speed which is the speed of the first wind, a second wind direction of the second wind, and a second assumed wind speed which is the speed of the second wind (S630). Here, seventh obtainer 62 obtains the generation position of the first wind, the first wind direction, the first assumed wind speed, the second wind direction, and the second assumed wind speed input in step S620. This step S630 corresponds to the obtaining step.

Next, fourth generator 63 generates fourth object audio information in which the generation position, the first wind direction, and the first assumed wind speed are associated, and generates fifth object audio information in which the second wind direction and the second assumed wind speed are associated (S640). This step S640 corresponds to the generating step.

Next, storage 65 stores aerodynamic sound core information including a representative wind speed and aerodynamic sound data indicating aerodynamic sound (second aerodynamic sound) generated by wind blowing at the representative wind speed reaching the ears of listener L (S650). This step S650 corresponds to the storing step.

Sixth outputter 64 outputs the fourth object audio information generated by fourth generator 63 when the first wind generation position is in the virtual space, and outputs the fifth object audio information generated by fourth generator 63 when the first wind generation position is not in the virtual space (S660). Here, sixth outputter 64 may also output the aerodynamic sound core information stored in storage 65. This step S660 corresponds to the outputting step.

### Operation Example 13

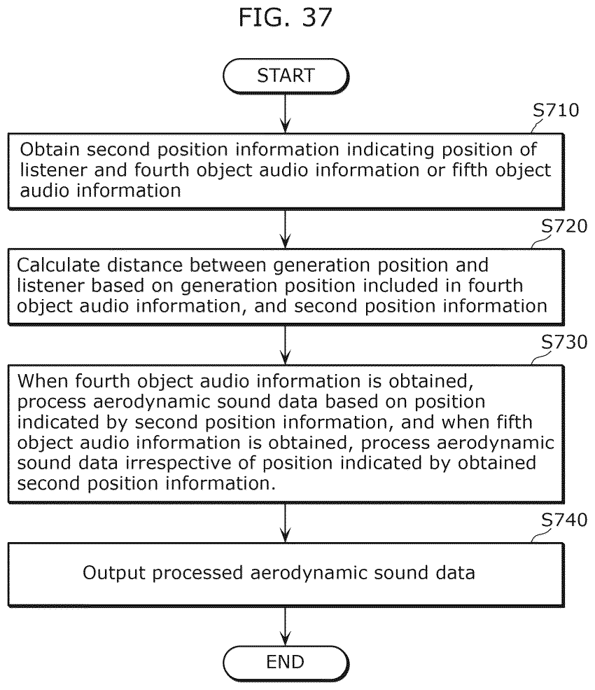

FIG. 37 is a flowchart of Operation Example 13 performed by acoustic signal processing device 500 according to the present variation.

As illustrated in FIG. 37, first, eighth obtainer 510 obtains second position information indicating the position of listener L in the virtual space, and the fourth object audio information or the fifth object audio information output by information generation device 60 (S710). Eighth obtainer 510 may also obtain aerodynamic sound core information at this time. This step S710 corresponds to the obtaining step.

Next, when eighth obtainer 510 obtains the fourth object audio information, third calculator 420 performs the following processing. That is, third calculator 420 calculates distance D between the generation position and listener L based on the generation position included in the fourth object audio information obtained by eighth obtainer 510, and the obtained second position information (S720). Note that, at this time, third calculator 420 calculates the direction between two points connecting the object (electric fan F) and listener L based on the generation position included in the fourth object audio information obtained by eighth obtainer 510, and the obtained second position information.

Next, fourth processor 540 processes the aerodynamic sound data included in the aerodynamic sound core information based on the position indicated by the obtained second position information when the fourth object audio information is obtained, and processes the aerodynamic sound data included in the aerodynamic sound core information irrespective of the position indicated by the obtained second position information when the fifth object audio information is obtained (S730). This step S730 corresponds to the processing step.

Seventh outputter 550 outputs the aerodynamic sound data processed by fourth processor 540 (S740). This step S740 corresponds to the outputting step.

The information generation method according to the present variation can generate fourth object audio information in which the generation position, the first wind direction, and the first assumed wind speed are associated, and fifth object audio information in which the second wind direction and the second assumed wind speed are associated. The acoustic signal processing method according to the present variation processes the aerodynamic sound data based on the position indicated by the second position information, so that the aerodynamic sound (second aerodynamic sound) caused by the first wind that listener L hears in the virtual space becomes similar to the aerodynamic sound (second aerodynamic sound) caused by the first wind that listener L hears in the real-world space. Furthermore, the acoustic signal processing method according to the present variation processes the aerodynamic sound data irrespective of the position indicated by the second position information, so that the aerodynamic sound (second aerodynamic sound) caused by the second wind that listener L hears in the virtual space becomes similar to the aerodynamic sound (second aerodynamic sound) caused by the second wind that listener L hears in the real-world space. Stated differently, listener L can experience a sense of realism without hearing the aerodynamic sound (second aerodynamic sound) that causes a sense of incongruity.

### Variation 8 of Embodiment

Hereinafter, Variation 8 of the embodiment will be described. The following description will focus on the differences from Variation 7 of the embodiment, and description of points in common will be omitted or simplified.

### Configuration

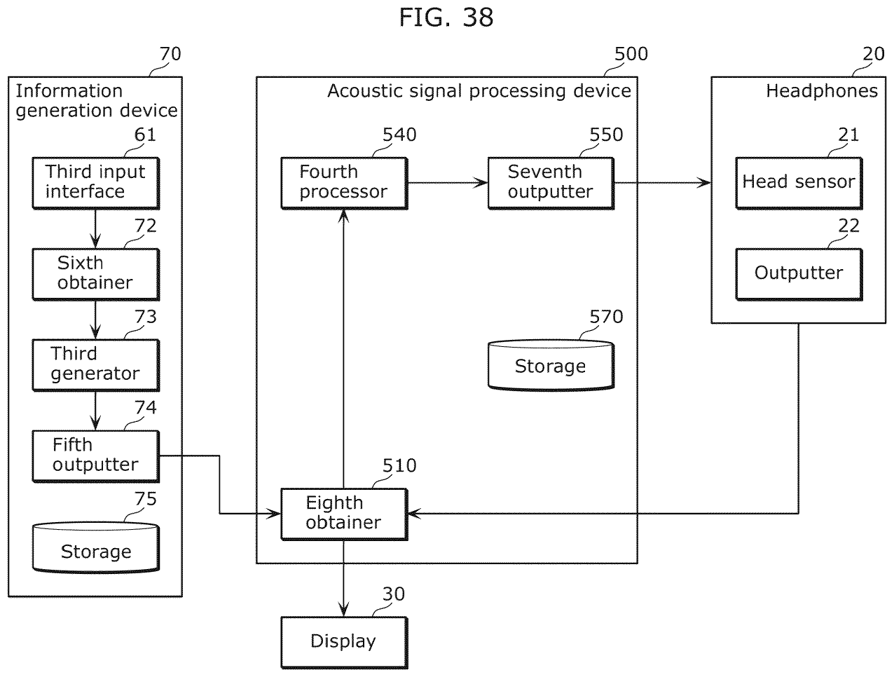

First, configurations of information generation device 70 and acoustic signal processing device 500 according to Variation 8 of the present embodiment will be described. FIG. 38 is a block diagram illustrating the functional configurations of information generation device 70 and acoustic signal processing device 500 according to the present variation.

Acoustic signal processing device 500 of Variation 7 is used in the present variation. Information generation device 70 according to the present variation has the same configuration as information generation device 70 according to Variation 7, except that it includes sixth obtainer 72, third generator 73, and fifth outputter 74 instead of seventh obtainer 62, fourth generator 63, and sixth outputter 64, and that it does not include display 66.

In Variation 7, the first wind and the second wind, which is a natural wind, were handled. In the present variation, the first wind is not handled, and the second wind, which is a natural wind, is handled.

Information generation device 70 is a device that generates and outputs fifth object audio information related to the second wind to acoustic signal processing device 500. Acoustic signal processing device 500 is a device that obtains the output fifth object audio information, and outputs sound data to headphones 20 based on the obtained fifth object audio information.

First, information generation device 70 illustrated in FIG. 38 will be described.

Information generation device 70 includes third input interface 61, sixth obtainer 72, third generator 73, fifth outputter 74, and storage 75.

Third input interface 61 receives operations from a user of information generation device 70 (for example, a creator of content executed in the virtual space). Third input interface 61 is specifically implemented by hardware buttons, but may also be implemented by a touch panel or the like.

Sixth obtainer 72 obtains a second wind direction of a second wind blowing in the virtual space and a second assumed wind speed.

In the present variation as well, since the second wind is blowing in the virtual space, listener L will hear the aerodynamic sound (second aerodynamic sound) generated by this second wind reaching the ears of listener L.

Note that third input interface 61 receives an operation from a user indicating a second wind direction and a second assumed wind speed. Stated differently, the user inputs the second wind direction and the second assumed wind speed by operating third input interface 61, and sixth obtainer 72 obtains the input second wind direction and second assumed wind speed.

Third generator 73 generates fifth object audio information in which the second wind direction and the second assumed wind speed obtained by sixth obtainer 72 are associated.

Storage 75 is a storage device that stores computer programs to be executed by third input interface 61, sixth obtainer 72, third generator 73, and fifth outputter 74. Storage 75 stores aerodynamic sound core information including a representative wind speed and aerodynamic sound data indicating aerodynamic sound (second aerodynamic sound) generated by wind blowing at the representative wind speed reaching the ears of listener L in the virtual space.

Fifth outputter 74 outputs the fifth object audio information generated by third generator 73 and the aerodynamic sound core information stored in storage 75 to acoustic signal processing device 500.

Further, acoustic signal processing device 500 illustrated in FIG. 38 will be described.

Acoustic signal processing device 500 according to the present variation performs processing on the second aerodynamic sound due to the second wind related to the fifth object audio information.

Eighth obtainer 510 obtains the fifth object audio information and the aerodynamic sound core information output by information generation device 70.

Fourth processor 540 processes the aerodynamic sound data included in the aerodynamic sound core information irrespective of the position indicated by the second position information obtained by eighth obtainer 510. Fourth processor 540 performs the same processing as when the fifth object audio information is obtained in Variation 7.

Next, Operation Example 14 of an information generation method performed by information generation device 70 will be described.

### Operation Example 14

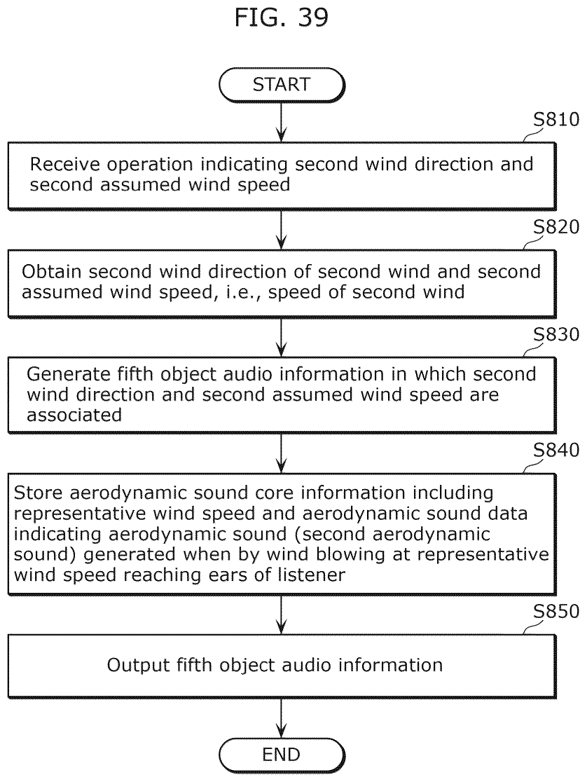

FIG. 39 is a flowchart of Operation Example 14 performed by information generation device 70 according to the present variation.

As illustrated in FIG. 39, first, third input interface 61 receives an operation from a user indicating a second wind direction and a second assumed wind speed (S810).

Next, sixth obtainer 72 obtains a second wind direction of the second wind and a second assumed wind speed which is the speed of the second wind (S820). Here, sixth obtainer 72 obtains the second wind direction and the second assumed wind speed input in step S810. This step S820 corresponds to the obtaining step.

Next, third generator 73 generates fifth object audio information in which the second wind direction and the second assumed wind speed are associated (S830). This step S830 corresponds to the generating step.

Next, storage 75 stores aerodynamic sound core information including a representative wind speed and aerodynamic sound data indicating aerodynamic sound generated by wind blowing at the representative wind speed reaching the ears of listener L (S840). This step S840 corresponds to the storing step.

Fifth outputter 74 outputs the fifth object audio information generated by third generator 73 (S850). Here, fifth outputter 74 may also output the aerodynamic sound core information stored in storage 75. This step S850 corresponds to the outputting step.

Furthermore, processing is performed by acoustic signal processing device 500, and listener L ends up hearing the second aerodynamic sound due to the second wind.

It should be noted that in all the above-described embodiments, the assumed wind speed was processed as being always constant at a given value; however, in real-world space, the wind speed, particularly the speed of natural wind, fluctuates gradually. Therefore, in virtual space, if aerodynamic sound is generated with the assumed wind speed always being constant, it is somewhat unnatural from the perspective of everyday experience. In view of this, for example, when an assumed wind speed is given as S, realism can be enhanced by gradually and irregularly fluctuating the assumed wind speed centered around S. In such cases, the process of generating the aerodynamic sound should follow the method shown in the above-described embodiments, treating the wind speed that fluctuates from moment to moment as the assumed wind speed at that instant. The same applies to wind direction as well. Particularly with regard to natural wind, a constant wind direction also becomes a factor contributing to unnaturalness. Therefore, control may be implemented to express fluctuations in wind direction by applying differences in loudness ratio, phase difference, or time difference between the aerodynamic sound signal output for the left ear and the aerodynamic sound signal output for the right ear.

Next, pipeline processing will be described.

Some or all of the processing performed by acoustic signal processing device 100 described above may be carried out as part of pipeline processing as described in, for example, PTL 2. FIG. 40 illustrates one example of a functional block diagram and steps for explaining a case where renderers A0203 and A0213 of FIG. 5G and FIG. 5H perform pipeline processing. Renderer 900, which is one example of renderers A0203 and A0213 of FIG. 5G and FIG. 5H, will be used for the explanation of FIG. 40.

Pipeline processing refers to dividing the processing for applying sound effects into a plurality of processes and executing each process one by one in order. The divided processes include, for example, signal processing on the audio signal, generation of parameters used for signal processing, etc.

Renderer 900 according to the present embodiment includes, as pipeline processing, processes that apply effects such as reverberation effect, early reflections, distance attenuation effect, and binaural processing. However, the above-described processing is one example, and may include other processes, or may omit some of the processes. For example, renderer 900 may include diffraction processing or occlusion processing as pipeline processing, or reverberation processing may be omitted if it is unnecessary. Each process may be expressed as a stage, and the audio signals such as reflected sounds generated as a result of each process may be expressed as rendering items. The order of each stage in the pipeline processing and the stages included in the pipeline processing are not limited to the example illustrated in FIG. 40.

Note that renderer 900 need not include all stages illustrated in FIG. 40, and some stages may be omitted or other stages may be outside of renderer 900.

As one example of pipeline processing, processing performed in each of reverberation processing, early reflection processing, distance attenuation processing, selection processing, generation processing, and binaural processing will be described. In each processing, the metadata included in the input signal is analyzed, and parameters necessary for generating reflected sounds are calculated.

In FIG. 40, renderer 900 includes reverberation processor 901, early reflection processor 902, distance attenuation processor 903, selector 904, calculator 906, generator 907, and binaural processor 905. Here, an example will be described in which reverberation processor 901 performs a reverberation processing step, early reflection processor 902 performs an early reflection processing step, distance attenuation processor 903 performs a distance attenuation processing step, selector 904 performs a selection processing step, and binaural processor 905 performs a binaural processing step.

In the reverberation processing step, reverberation processor 901 generates an audio signal indicating reverberation sound or parameters necessary for generating the audio signal. Reverberation sound is a sound that includes reverberation sound reaching the listener as reverberation after the direct sound. As one example, the reverberation sound is reverberation sound that reaches the listener at a relatively late stage (for example, approximately 100 to 200 ms after the arrival of the direct sound) after the early reflected sound (to be described later) reaches the listener, and after undergoing more reflections (for example, several tens of times) than the early reflected sound. Reverberation processor 901 refers to the audio signal and spatial information included in the input signal, and performs calculations using a prepared, predetermined function for generating reverberation sound.

Reverberation processor 901 may generate reverberation by applying a known reverberation generation method to the sound signal. One example of a known reverberation generation method is the Schroeder method, but the method used is not limited to this example. Reverberation processor 901 uses the shape and an acoustic property of a sound reproduction space indicated by the spatial information when the known reverberation generation processing is applied. Accordingly, reverberation processor 901 can calculate parameters for generating an audio signal that indicates reverberation.

In the early reflection processing step, early reflection processor 902 calculates parameters for generating early reflection sounds based on the spatial information. The early reflected sound is reflected sound that reaches the listener at a relatively early stage (for example, approximately several tens of ms after the arrival of the direct sound) after the direct sound from the sound source object reaches the listener, and after undergoing one or more reflections. Early reflection processor 902 references, for example, the sound signal and metadata, and calculates the path of reflected sound that reaches the listener after being reflected by objects, using the shape and size of the three-dimensional sound field (space), the positions of objects such as structures, and the reflectance of objects, from the sound source object. Early reflection processor 902 may calculate the path of the direct sound. The information of said path may be used as a parameter for generating the early reflected sound, as well as a parameter for selection processing of reflected sound in selector 904.

In the distance attenuation processing step, distance attenuation processor 903 calculates the loudness of sound reaching the listener based on the difference between the length of the direct sound path and the length of the reflected sound path calculated by early reflection processor 902. The loudness of sound reaching the listener attenuates in proportion to the distance to the listener (inversely proportional to the distance) relative to the loudness of the sound source. Therefore, the loudness of the direct sound can be obtained by dividing the loudness of the sound source by the length of the direct sound path, and the loudness of the reflected sound can be calculated by dividing the loudness of the sound source by the length of the reflected sound path.

In the selection processing step, selector 904 selects the sound to be generated. The selection processing may be executed based on parameters calculated in previous steps.

When the selection processing is executed as part of the pipeline processing, sounds that were not selected in the selection processing need not be subjected to processing subsequent to the selection processing in the pipeline processing. Not executing processing subsequent to the selection processing for sounds that were not selected enables a reduction in the computational load of acoustic signal processing device 100 more so than when it is decided to only not execute binaural processing for the sounds that were not selected.

When the selection processing described in the present embodiment is executed as part of the pipeline processing, if the selection processing is set to be executed earlier in the order of the plurality of processes in the pipeline processing, more processing subsequent to the selection processing can be omitted, thereby enabling a greater reduction in the amount of computation. For example, if the selection processing is executed in an prior to the processing by calculator 906 and generator 907, processing for aerodynamic sound related to objects determined not to be selected can be omitted, enabling a further reduction in the amount of computation in acoustic signal processing device 100.

Parameters calculated as part of the pipeline processing for generating rendering items may be used by selector 904 or calculator 906.

In the binaural processing step, binaural processor 905 performs signal processing on the audio signal of the direct sound so that it is perceived as sound reaching the listener from the direction of the sound source object. Furthermore, binaural processor 905 performs signal processing so that the reflected sound is perceived as sound reaching the listener from the obstacle object involved in the reflection. Based on the coordinates and orientation of the listener in the sound space (i.e., the position and orientation of the listening point), processing is executed to apply an HRIR

(Head-Related Impulse Response) DB (Database) so that sound reaches the listener from the position of the sound source object or the position of the obstacle object. The position and direction of the listening point may be changed according to the movement of the listener's head, for example. Information indicating the position of the listener may be obtained from a sensor.

The program used for pipeline processing and binaural processing, spatial information necessary for acoustic processing, the HRIR DB, and other parameters such as threshold data are obtained from memory included in acoustic signal processing device 100 or from an external source. Head-Related Impulse Response (HRIR) is the response characteristic when one impulse is generated. Stated differently, HRIR is the response characteristic that is converted from an expression in the frequency domain to an expression in the time domain by Fourier transforming the head-related transfer function, which represents the change in sound caused by surrounding objects including the auricle, the head, and the shoulders as a transfer function. The HRIR DB is a database including such information.

As one example of pipeline processing, renderer 900 may include a processor (not illustrated). For example, renderer 900 may include a diffraction processor or an occlusion processor.

The diffraction processor executes processing to generate an audio signal indicating sound including diffracted sound caused by an obstacle between the listener and the sound source object in a three-dimensional sound field (space). Diffracted sound is sound that, when there is an obstacle between the sound source object and the listener, reaches the listener from the sound source object by going around the obstacle.

The diffraction processor references, for example, the sound signal and metadata, and calculates the path by which sound reaches the listener from the sound source object by detouring around the obstacle, using the position of the sound source object in the three-dimensional sound field (space), the position of the listener, and the position, shape, and size of the obstacle, etc., and generates diffracted sound based on the calculated path.

The occlusion processor generates an audio signal that seeps through when a sound source object is on the other side of an obstacle object, based on spatial information obtained in any step and information such as the material of the obstacle object.

In the above embodiment, the position information assigned to the sound source object is defined as a “point” in the virtual space, and the details of the invention are described as being a so-called “point sound source”. However, as a method for defining a sound source in the virtual space, a spatially extended sound source that is not a point sound source may be defined as an object having length, size, or shape. In such cases, since the distance between the listener and the sound source or the direction of sound arrival is not determined, the resulting reflected sound may be limited to the “selected” processing by selector 904 mentioned above, without analysis being performed, or regardless of the analysis results. This is because by doing so, it is possible to avoid the sound quality degradation that might occur by not selecting the reflected sound. Alternatively, a representative point such as the center of gravity of the object may be determined, and the processing of the present disclosure may be applied as if sound is generated from that representative point. In such cases, the processing of the present disclosure may be applied after adjusting a threshold in accordance with the information on the spatial extension of the sound source.

Next, an example structure of the bitstream will be described.

The bitstream includes, for example, an audio signal and metadata. The audio signal is sound data representing sound, indicating information such as the frequency and intensity of the sound. The spatial information included in the metadata is information related to the space in which the listener of the sound that is based on the audio signal is positioned. More specifically, the spatial information is information about a predetermined position (localization position) in the sound space (for example, within a three-dimensional sound field) when localizing the sound image of the sound at that predetermined position, that is, when causing the listener to perceive the sound as reaching from a predetermined direction. The spatial information includes, for example, sound source object information and position information indicating the position of the listener.

The sound source object information is information about an object indicating a physical object that generates sound based on the audio signal, i.e., reproduces the audio signal, and is information related to a virtual object (sound source object) placed in a sound space, which is a virtual space corresponding to the real-world space in which the physical object is placed. The sound source object information includes, for example, information indicating the position of the sound source object located in the sound space, information about the orientation of the sound source object, information about the directivity of the sound emitted by the sound source object, information indicating whether the sound source object belongs to an animate thing, and information indicating whether the sound source object is a mobile body. For example, the audio signal corresponds to one or more sound source objects indicated by the sound source object information.

As one example of the data structure of the bitstream, the bitstream includes, for example, metadata (control information) and an audio signal.

The audio signal and metadata may be stored in a single bitstream or may be separately stored in plural bitstreams. Similarly, the audio signal and metadata may be stored in a single file or may be separately stored in plural files.

The bitstream may exist for each sound source or may exist for each playback time. When bitstreams exist for each playback time, a plurality of bitstreams may be processed in parallel simultaneously.

Metadata may be assigned to each bitstream, or may be collectively assigned as information for controlling a plurality of bitstreams. The metadata may be assigned for each playback time.

When the audio signal and metadata are stored separately in a plurality of bitstreams or a plurality of files, information indicating another bitstream or file relevant to one or some of the bitstreams or files may be included, or information indicating another bitstream or file relevant to each of all the bitstreams or files may be included. Here, the relevant bitstream or file is, for example, a bitstream or file that may be used simultaneously during acoustic processing. The relevant bitstream or file may include a bitstream or file that collectively describes information indicating other relevant bitstreams or files. Here, information indicating other relevant bitstreams or files is, for example, an identifier indicating the other bitstream, a file name indicating the other file, a uniform resource locator (URL), or a uniform resource identifier (URI). In such cases, first obtainer 110 identifies or obtains a bitstream or file based on information indicating other relevant bitstreams or files. The bitstream may include information indicating another bitstream relevant to the bitstream as well as information indicating a bitstream or file relevant to another bitstream or file within the bitstream. Here, the file including information indicating the relevant bitstream or file may be, for example, a control file such as a manifest file used for content distribution.

Note that the entire metadata or part of the metadata may be obtained from somewhere other than a bitstream of the audio signal. For example, metadata for controlling an acoustic sound or metadata for controlling a video may be obtained from somewhere other than from a bitstream or both may be obtained from somewhere other than from a bitstream. When metadata for controlling a video is included in a bitstream obtained by the audio signal reproduction system, the audio signal reproduction system may have a function of outputting metadata that can be used for controlling a video to a display device that displays images or to a stereoscopic video reproduction device that reproduces stereoscopic videos.

Next, examples of information included in the metadata will be described further.

The metadata may be information used to describe a scene expressed in the sound space. As used herein, the term “scene” refers to a collection of all elements that represent three-dimensional video and acoustic events in the sound space, which are modeled in the audio signal reproduction system using metadata. Thus, metadata as used herein may include not only information for controlling acoustic processing, but also information for controlling video processing. Of course, the metadata may include information for controlling only acoustic processing or video processing, or may include information for use in controlling both.

The audio signal reproduction system generates virtual acoustic effects by performing acoustic processing on the audio signal using the metadata included in the bitstream and additionally obtained interactive listener position information. Although the present embodiment describes a case where early reflection processing, obstacle processing, diffraction processing, occlusion processing, and reverberation processing are performed as sound effects, other acoustic processing may be performed using the metadata. For example, the audio signal reproduction system may add acoustic effects such as distance decay effect, localization, and Doppler effect. In addition, information for switching between on and off of all or one or more of the acoustic effects, and priority information may be added as metadata.

As an example, encoded metadata includes information about a sound space including a sound source object and an obstacle object and information about a localization position when the sound image of the sound is localized at a predetermined position in the sound space (i.e. the sound is perceived as reaching from a predetermined direction). Here, an obstacle object is an object that can influence a sound emitted by a sound source object and perceived by the listener, by, for example, blocking or reflecting the sound between the sound source object and the listener. An obstacle object can include an animal such as a person or a movable body such as a machine, in addition to a stationary object. When a plurality of sound source objects are present in a sound space, another sound source object may be an obstacle object for a certain sound source object. Non-sound-emitting objects such as building materials or inanimate objects, and sound source objects that emit sound can both be obstacle objects.

The metadata includes all or part of information indicating the shape of the sound space, geometry information and position information of obstacle objects present in the sound space, geometry information and position information of sound source objects present in the sound space, and the position and orientation of the listener in the sound space.

The sound space may be either a closed space or an open space. The metadata includes information indicating the reflectance of each structure that can reflect sound in the sound space, such as floors, walls, and ceilings, and the reflectance of each obstacle object present in the sound space. Here, the reflectance is an energy ratio between a reflected sound and an incident sound, and is set for each sound frequency band. Of course, the reflectance may be uniformly set, irrespective of the sound frequency band. When the sound space is an open space, for example, parameters such as a uniformly set attenuation rate, diffracted sound, and early reflected sound may be used.

In the above description, reflectance is mentioned as a parameter with regard to an obstacle object or a sound source object included in metadata, but the metadata may include information other than reflectance.

For example, information other than reflectance may include information on the material of an object as metadata related to both of a sound source object and a non-sound-emitting object. More specifically, the information other than reflectance may include parameters such as diffusivity, transmittance, and sound absorption rate.

For example, information on a sound source object may include information for designating the loudness, a radiation property (directivity), a reproduction condition, the number and types of sound sources emitted by one object, and a sound source region of an object. The reproduction condition may determine that a sound is, for example, a sound that is continuously being emitted or is emitted at an event. The sound source region in the object may be determined based on the relative relationship between the position of the listener and the position of the object, or determined with respect to the object. When the sound source region in the object is determined based on the relative relationship between the position of the listener and the position of the object, with respect to the plane along which the listener is looking at the object, the listener can be made to perceive that sound C is emitted from the right side of the object and sound E is emitted from the left side of the object as seen from the listener. When the sound source region in the object is determined based on the object as a reference, which sound is emitted from which region of the object can be fixed, irrespective of the direction in which the listener is viewing. For example, the listener can be made to perceive that high-pitched sound comes from the right side and low-pitched sound comes from the left side when looking at the object from the front. In such cases, if the listener goes around to the back of the object, the listener can be made to perceive that low-pitched sound comes from the right side and high-pitched sound comes from the left side when looking at the object from the back.

Metadata related to the space may include, for example, the time until early reflected sound, the reverberation time, and the ratio of direct sound to diffuse sound. When the ratio between a direct sound and a diffused sound is zero, the listener can be caused to perceive only a direct sound.

### Advantageous Effects, etc.

An acoustic signal processing method according to the present embodiment includes: obtaining object information and second position information, the object information including first position information indicating a position of an object in a virtual space, first sound data indicating a first sound caused by the object, and first identification information indicating a processing method for the first sound data, the second position information indicating a position of listener L of the first sound in the virtual space; calculating distance D between the object and listener L based on the first position information included in the object information obtained and the second position information obtained; determining, based on the first identification information included in the object information obtained, a processing method among a first processing method and a second processing method to use to process the first sound data, the first processing method for processing a loudness according to distance D calculated, the second processing method for processing the loudness according to distance D calculated in a manner different from the first processing method; processing the first sound data using the processing method determined; and outputting the first sound data processed.

Accordingly, since the processing method for the loudness of the first sound can be changed according to the first identification information, the first sound that listener L hears in the virtual space becomes similar to the first sound that listener L hears in the real-world space, and more specifically, becomes a sound that reproduces the first sound in the real-world space. Therefore, listener L is less likely to feel a sense of incongruity and can experience a sense of realism. Stated differently, the acoustic signal processing method is capable of providing listener L with a sense of realism.

In the acoustic signal processing method according to the present embodiment, the first processing method is for processing the first sound data to attenuate the loudness inversely proportional with respect to an increase in the calculated distance D, and the second processing method is for processing the first sound data to increase or decrease the loudness in a manner different from the first processing method as the calculated distance D increases.

Accordingly, since either the first processing method for processing the first sound data such that the loudness attenuates inversely proportional with increasing distance D, or the second processing method for processing the first sound data such that the loudness increases or decreases in a manner different from the first processing method as distance D increases, is used according to the first identification information, the first sound that listener L hears in the virtual space becomes more similar to the first sound that listener L hears in the real-world space. Therefore, listener L is even less likely to feel a sense of incongruity and can experience an even greater sense of realism. Stated differently, the acoustic signal processing method is capable of providing listener L with a greater sense of realism.

In the acoustic signal processing method according to the present embodiment, the object information obtained includes: second sound data indicating a second sound that is caused by the object and different from the first sound; and second identification information indicating a processing method for the second sound data, the determining includes determining, based on the second identification information included in the object information obtained, a processing method among the first processing method and the second processing method to use to process the second sound data, the processing includes processing the second sound data using the processing method determined, the outputting includes outputting the second sound data processed, and the object is an object associated with a plurality of items of sound data including the first sound data and the second sound data.

Accordingly, since the processing method for the loudness of the second sound can be changed according to the second identification information, the second sound that listener L hears in the virtual space also becomes similar to the second sound that listener L hears in the real-world space, and more specifically, the loudness balance between the first sound and the second sound fluctuates like the loudness balance does in the real-world space according to calculated distance D. Therefore, listener L is even less likely to feel a sense of incongruity and can experience an even greater sense of realism. Stated differently, the acoustic signal processing method is capable of providing listener L with a greater sense of realism.

In the acoustic signal processing method according to the present embodiment, the second processing method is a processing method for processing the first sound data to attenuate the loudness according to the x-th power of distance D (where x≠1). Stated differently, the second processing method is a processing method for processing the first sound data such that the loudness attenuates according to the x-th power of distance D (where x≠1), and more specifically, it is a processing method for processing the first sound data such that the loudness attenuates according to the x-th power of distance D (where x≠1) as distance D increases.

With this, in the processing, the second processing method for processing the first sound data such that the loudness attenuates according to the x-th power of distance D can be used.

In the acoustic signal processing method according to the present embodiment, the first identification information indicates that the processing method for the first sound data is the second processing method, and indicates the value of x.

With this, the first identification information can indicate that the processing method is the second processing method, and in the processing, the first sound data can be processed according to the value of x indicated by the first identification information.

In the acoustic signal processing method according to the present embodiment, when the first sound is an aerodynamic sound generated accompanying movement of the object, the first identification information indicates that the processing method for the first sound data is the second processing method, and that x is α, where α is real number and a satisfies the following relation.
α>1

With this, in the processing, when the first sound is an aerodynamic sound (first aerodynamic sound), the first sound data can be processed according to α, which is the value of x indicated by the first identification information.

In the acoustic signal processing method according to Variation 2 of the embodiment, when the first sound is an aerodynamic sound generated by wind radiated from the object reaching an ear of listener L, the first identification information indicates that the processing method for the first sound data is the second processing method, and that x is β, where β is real number and β satisfies the following relation.
>2

With this, in the processing, when the first sound is an aerodynamic sound (second aerodynamic sound) generated by wind W radiated from the object reaching the ear of listener L, the first sound data can be processed according to β, which is the value of x indicated by the first identification information.

In the acoustic signal processing method according to Variation 2 of the embodiment, α and β satisfy the following equation.
α<β

With this, in the processing, the first sound data can be processed using α or β that satisfies α<β.

The acoustic signal processing method according to the present embodiment includes receiving an operation from a user specifying a value of α or β.

With this, in the processing, the first sound data can be processed using the value of α or β specified by the user.

In the acoustic signal processing method according to Variation 1 of the embodiment, the first identification information indicates whether to execute the first processing method, the determining includes: determining whether to execute the first processing method based on the first identification information obtained; and determining to execute the second processing method regardless of whether the first processing method is to be executed, and the second processing method is for processing the first sound data to bring the loudness to a predetermined value when the calculated distance D is within a predetermined threshold.

With this, in the processing, the second processing method can be used that processes the first sound data such that the loudness becomes a predetermined value only when distance D is within a predetermined threshold, thereby creating a surreal effect, while also imparting a natural distance attenuation effect that occurs realistically.

In the acoustic signal processing method according to Variation 1 of the embodiment, the predetermined threshold is a value dependent on personal space.

With this, in the processing, the first sound data can be processed using a predetermined threshold value that corresponds to personal space, thereby enabling the expression of a psychological sense of distance that cannot be represented by the distance attenuation effect based on physical distance.

The acoustic signal processing method according to Variation 1 of the embodiment includes receiving an operation from a user specifying that the predetermined threshold is a first specified value. With this, in the processing, the first sound data can be processed using the first specified value specified by the user.

The information generation method according to Variation 3 of the embodiment includes: obtaining first sound data and first position information, the first sound data indicating a first sound generated at a position related to a position of listener L in a virtual space, the first position information indicating a position of an object in the virtual space; and generating, from the first sound data obtained and the first position information obtained, first object audio information including (i) information related to the object that reproduces the first sound at the position related to the position of listener L due to the object, and (ii) the first position information.

With this, first object audio information in which first sound data indicating first sound generated at a position related to the position of listener L due to the object is associated with the position of the object can be generated. When this first object audio information is used in the acoustic signal processing method, as the first sound data is processed such that the loudness of the first sound attenuates as distance D between the object and listener L increases, the first sound that listener L hears in the virtual space becomes similar to the first sound that listener L hears in the real-world space, and more specifically, becomes a sound that reproduces the first sound in the real-world space. Therefore, listener L is less likely to feel a sense of incongruity and can experience a sense of realism. Stated differently, the information generation method is capable of providing listener L with a sense of realism.

In the information generation method according to Variation 3 of the embodiment, the object radiates wind W, listener L is exposed to the radiated wind W, and the first sound is an aerodynamic sound generated by the wind W radiated from the object reaching an ear of listener L.

With this, an information generation method is realized that can make the first sound an aerodynamic sound (second aerodynamic sound) that is generated by wind W radiated from the object reaching the ears of listener L.

In the information generation method according to Variation 3 of the embodiment, the generating includes generating the first object audio information further including unit distance information, and the unit distance information includes a unit distance serving as a reference distance, and aerodynamic sound data indicating the aerodynamic sound at a position separated by the unit distance from the position of the object.

With this, first object audio information including unit distance information can be generated. When this first object audio information is used in the acoustic signal processing method, the first sound (second aerodynamic sound) that listener L hears in the virtual space becomes more similar to the first sound (second aerodynamic sound) that listener L hears in the real-world space, based on the unit distance and aerodynamic sound data. Therefore, listener L is even less likely to feel a sense of incongruity and can experience an even greater sense of realism. Stated differently, the information generation method is capable of providing listener L with a greater sense of realism.

In the information generation method according to Variation 3 of the embodiment, the generating includes generating the first object audio information further including directivity information, the directivity information indicates a characteristic according to a direction of the wind radiated, and the aerodynamic sound data indicated in the unit distance information is data indicating the aerodynamic sound at a position separated by the unit distance from the position of the object, in a forward direction in which the object radiates the wind as indicated in the directivity information.

With this, first object audio information including directivity information can be generated. When this first object audio information is used in the acoustic signal processing method, the first sound (second aerodynamic sound) that listener L hears in the virtual space becomes more similar to the first sound (second aerodynamic sound) that listener L hears in the real-world space, based on the unit distance, aerodynamic sound data, and directivity information. Therefore, listener L is even less likely to feel a sense of incongruity and can experience an even greater sense of realism. Stated differently, the information generation method is capable of providing listener L with a greater sense of realism.

In the information generation method according to Variation 3 of the embodiment, the generating includes generating the first object audio information further including flag information indicating whether to, when reproducing the first sound, perform processing to convolve a head-related transfer function that depends on a direction of arrival of sound, on a first sound signal that is based on the first sound data indicating the first sound generated from the object.

With this, first object audio information including flag information can be generated. When this first object audio information is used in the acoustic signal processing method, the first sound that listener L hears in the virtual space becomes more similar to the first sound that listener L hears in the real-world space, because a head-related transfer function may be convolved with the first sound signal based on the first sound data. Therefore, listener L is even less likely to feel a sense of incongruity and can experience an even greater sense of realism. Stated differently, the information generation method is capable of providing listener L with a greater sense of realism.

An acoustic signal processing method according to Variation 3 of the embodiment includes: obtaining the first object audio information generated by an information generation method described above, the first sound data obtained, and second position information indicating the position of listener L of the first sound; calculating distance D between the object and listener L based on the first position information included in the first object audio information obtained and the second position information obtained; processing the first sound data to attenuate a loudness of the first sound as the calculated distance D increases; and outputting the first sound data processed.

With this, in the obtaining, first object audio information in which first sound data indicating first sound generated at a position related to the position of listener L due to the object is associated with the position of the object can be obtained. Accordingly, as the first sound data is processed such that the loudness of the first sound attenuates as distance D between the object and listener L increases, the first sound that listener L hears in the virtual space becomes similar to the first sound that listener L hears in the real-world space, and more specifically, becomes a sound that reproduces the first sound in the real-world space. Therefore, listener L is less likely to feel a sense of incongruity and can experience a sense of realism. Stated differently, the acoustic signal processing method is capable of providing listener L with a sense of realism.

An acoustic signal processing method according to Variation 3 of the embodiment includes: obtaining the first object audio information generated by an information generation method described above, the first sound data obtained, and second position information indicating the position of listener L of the first sound; calculating distance D between the object that radiates wind W and listener L based on the first position information included in the first object audio information obtained and the second position information obtained; processing the first sound data to attenuate a loudness of the first sound as calculated distance D increases; and outputting the first sound data processed.

With this, an acoustic signal processing method is realized that can make the first sound an aerodynamic sound (second aerodynamic sound) that is generated by wind W radiated from the object reaching the ears of listener L.

The acoustic signal processing method according to Variation 3 of the embodiment includes: obtaining the first object audio information generated by an information generation method described above, the first sound data obtained, and second position information indicating the position of listener L of the first sound; calculating distance D between the object that radiates wind W and listener L based on the first position information included in the first object audio information obtained and the second position information obtained; when the calculated distance D is greater than the unit distance indicated by the unit distance information included in the first object audio information obtained, processing the first sound data to attenuate a loudness of the first sound according to the calculated distance D and the unit distance; and outputting the first sound data processed.

With this, in the obtaining, first object audio information including unit distance information can be obtained. Therefore, the first sound (second aerodynamic sound) that listener L hears in the virtual space becomes more similar to the first sound (second aerodynamic sound) that listener L hears in the real-world space, based on the unit distance and aerodynamic sound data. Therefore, listener L is even less likely to feel a sense of incongruity and can experience an even greater sense of realism. Stated differently, the acoustic signal processing method is capable of providing listener L with a greater sense of realism.

The acoustic signal processing method according to Variation 3 of the embodiment includes: obtaining the first object audio information generated by an information generation method described above, the first sound data obtained, and second position information indicating the position of listener L of the first sound; calculating distance D between the object that radiates wind W and listener L, and a direction between two points connecting the object and listener L, based on the first position information included in the first object audio information obtained and the second position information obtained; processing the first sound data to: control a loudness of the first sound based on (i) an angle formed between the forward direction and the direction between two points calculated and (ii) the characteristic indicated by the directivity information; and when the calculated distance D is greater than the unit distance indicated by the unit distance information included in the first object audio information obtained, attenuate the loudness of the first sound according to the calculated distance D and the unit distance; and outputting the first sound data processed.

With this, in the obtaining, first object audio information including directivity information can be obtained. Therefore, the first sound (second aerodynamic sound) that listener L hears in the virtual space becomes more similar to the first sound (second aerodynamic sound) that listener L hears in the real-world space, based on the unit distance, aerodynamic sound data, and directivity information. Therefore, listener L is even less likely to feel a sense of incongruity and can experience an even greater sense of realism. Stated differently, the acoustic signal processing method is capable of providing listener L with a greater sense of realism.

The acoustic signal processing method according to Variation 4 of the embodiment includes: obtaining the first object audio information generated by an information generation method described above, the first sound data obtained, and second object audio information in which the first position information and second sound data indicating a second sound caused by the object are associated; processing including: not processing a first sound signal that is based on the first sound data obtained with processing to convolve a head-related transfer function that depends on a direction of arrival of sound; and processing a second sound signal that is based on the second sound data indicated by the second object audio information obtained with processing to convolve the head-related transfer function that depends on the direction of arrival of sound; and outputting the first sound signal not processed and the second sound signal processed.

Accordingly, the second sound that listener L hears in the virtual space becomes similar to the second sound that listener L hears in the real-world space, because a head-related transfer function is convolved with the second sound signal based on the second sound data, and more specifically, becomes a sound that reproduces the second sound in the real-world space. Therefore, listener L is even less likely to feel a sense of incongruity and can experience an even greater sense of realism. Stated differently, the acoustic signal processing method is capable of providing listener L with a greater sense of realism.

The acoustic signal processing method according to Variation 4 of the embodiment includes: obtaining the first object audio information generated by an information generation method described above, the first sound data obtained, and second object audio information in which the first position information and second sound data indicating a second sound caused by the object are associated; processing including: not processing a first sound signal that is based on the first sound data obtained with processing to convolve a head-related transfer function that depends on a direction of arrival of sound; and processing a second sound signal that is based on the second sound data indicated by the second object audio information obtained with processing to convolve the head-related transfer function that depends on the direction of arrival of sound; and outputting the first sound signal not processed and the second sound signal processed.

Accordingly, the first sound (second aerodynamic sound) that listener L hears in the virtual space becomes similar to the first sound (second aerodynamic sound) that listener L hears in the real-world space, because processing dependent on the direction of arrival of wind W is performed on the first sound signal based on the first sound data, and more specifically, becomes a sound that reproduces the first sound (second aerodynamic sound) in the real-world space. Furthermore, the second sound that listener L hears in the virtual space becomes similar to the second sound that listener L hears in the real-world space, because a head-related transfer function is convolved with the second sound signal based on the second sound data, and more specifically, becomes a sound that reproduces the second sound in the real-world space. Therefore, listener L is even less likely to feel a sense of incongruity and can experience an even greater sense of realism. Stated differently, the acoustic signal processing method is capable of providing listener L with a greater sense of realism.

The acoustic signal processing method according to Variation 5 of the embodiment includes: obtaining the first object audio information generated by an information generation method described above, the first sound data obtained, and third object audio information in which third position information indicating a position of an other object in the virtual space and third sound data indicating a third sound generated at the position of the other object are associated, the other object being different from the object; processing including: processing a first sound signal that is based on the first sound data obtained with processing dependent on a direction of arrival of wind W; and processing a third sound signal that is based on the third sound data indicated by the third object audio information obtained with processing to convolve a head-related transfer function that depends on a direction of arrival of sound; and outputting the first sound signal processed and the third sound signal processed.

Accordingly, when a plurality of objects including the object and the other object are provided in the virtual space, the first sound (second aerodynamic sound) and the third sound that listener L hears in the virtual space become similar to the first sound (second aerodynamic sound) and the third sound, respectively, that listener L hears in the real-world space. Therefore, listener L is even less likely to feel a sense of incongruity and can experience an even greater sense of realism. Stated differently, the acoustic signal processing method is capable of providing listener L with a greater sense of realism.

The information generation method according to Variation 6 of the embodiment includes: obtaining a generation position of a first wind blowing in a virtual space, a first wind direction of the first wind, and a first assumed wind speed which is a speed of the first wind; generating fourth object audio information in which the generation position, the first wind direction, and the first assumed wind speed obtained are associated; storing aerodynamic sound core information including a representative wind speed and aerodynamic sound data indicating aerodynamic sound generated by wind blowing at the representative wind speed reaching an ear of listener L in the virtual space; and outputting the fourth object audio information generated and the aerodynamic sound core information stored.

With this, fourth object audio information in which the generation position, the first wind direction, and the first assumed wind speed are associated can be generated. When this fourth object audio information is used in the acoustic signal processing method, as the aerodynamic sound data is processed such that the loudness of the aerodynamic sound (second aerodynamic sound) attenuates as distance D between the object and listener L increases, the aerodynamic sound (second aerodynamic sound) that listener L hears in the virtual space becomes similar to the aerodynamic sound (second aerodynamic sound) that listener L hears in the real-world space, and more specifically, becomes a sound that reproduces the aerodynamic sound (second aerodynamic sound) in the real-world space. Therefore, listener L is less likely to feel a sense of incongruity and can experience a sense of realism. Stated differently, the information generation method is capable of providing listener L with a sense of realism.

In the information generation method according to Variation 6 of the embodiment, the first assumed wind speed is the speed of the first wind at a position separated by the unit distance, serving as a reference distance, from the generation position in the first wind direction.

With this, the speed of the first wind at a position separated by the unit distance can be used as the first assumed wind speed.

The information generation method according to Variation 6 of the embodiment includes receiving an operation from a user specifying that the unit distance is a second specified value.

With this, fourth object audio information can be generated using the unit distance, which is the second specified value specified by the user.

The information generation method according to Variation 6 of the embodiment includes receiving an operation from a user directivity information indicating a characteristic specifying according to a direction of the first wind, wherein the generating includes generating the fourth object audio information in which the generation position, the first wind direction, and the first assumed wind speed obtained are associated with the directivity information indicated by the operation received.

With this, fourth object audio information in which the generation position, the first wind direction, the first assumed wind speed, and directivity information specified by the user are associated can be generated.

The acoustic signal processing method according to Variation 6 of the embodiment includes: obtaining the fourth object audio information and the aerodynamic sound core information output by an information generation method described above, and second position information indicating a position of listener L in the virtual space; calculating, based on the generation position included in the fourth object audio information obtained and the second position information obtained, distance D between the generation position and listener L; processing the aerodynamic sound data to attenuate a loudness of the aerodynamic sound as the calculated distance D increases; and outputting the aerodynamic sound data processed.

With this, in the obtaining, fourth object audio information in which the generation position, the first wind direction, and the first assumed wind speed are associated can be obtained. Accordingly, as the aerodynamic sound data is processed such that the loudness of the aerodynamic sound (second aerodynamic sound) attenuates as distance D between the object and listener L increases, the aerodynamic sound (second aerodynamic sound) that listener L hears in the virtual space becomes similar to the aerodynamic sound (second aerodynamic sound) that listener L hears in the real-world space, and more specifically, becomes a sound that reproduces the aerodynamic sound (second aerodynamic sound) in the real-world space. Therefore, listener L is less likely to feel a sense of incongruity and can experience a sense of realism. Stated differently, the acoustic signal processing method is capable of providing listener L with a sense of realism.

In the acoustic signal processing method according to Variation 6 of the embodiment, the processing includes processing the aerodynamic sound data based on an ear-reaching wind speed, the ear-reaching wind speed being a speed of the first wind upon reaching the ear of listener L, and the ear-reaching wind speed decreases as the calculated distance D increases.

Accordingly, since the aerodynamic sound data is processed based on the ear-reaching wind speed, the aerodynamic sound (second aerodynamic sound) that listener L hears in the virtual space becomes more similar to the aerodynamic sound (second aerodynamic sound) that listener L hears in the real-world space. Therefore, listener L is even less likely to feel a sense of incongruity and can experience an even greater sense of realism. Stated differently, the acoustic signal processing method is capable of providing listener L with a greater sense of realism.

In the acoustic signal processing method according to Variation 6 of the embodiment, the ear-reaching wind speed is a value that attenuates according to the z-th power of the value obtained by dividing the calculated distance D by the unit distance.

Accordingly, since a more accurate ear-reaching wind speed is calculated, the aerodynamic sound (second aerodynamic sound) that listener L hears in the virtual space becomes more similar to the aerodynamic sound (second aerodynamic sound) that listener L hears in the real-world space. Therefore, listener L is even less likely to feel a sense of incongruity and can experience an even greater sense of realism. Stated differently, the acoustic signal processing method is capable of providing listener L with a greater sense of realism.

In the acoustic signal processing method according to Variation 6 of the embodiment, z satisfies the following relation.
z=1

Accordingly, since a more accurate ear-reaching wind speed is calculated, the aerodynamic sound (second aerodynamic sound) that listener L hears in the virtual space becomes more similar to the aerodynamic sound (second aerodynamic sound) that listener L hears in the real-world space. Therefore, listener L is even less likely to feel a sense of incongruity and can experience an even greater sense of realism. Stated differently, the acoustic signal processing method is capable of providing listener L with a greater sense of realism.

In the acoustic signal processing method according to Variation 6 of the embodiment, the processing includes processing the aerodynamic sound data to attenuate the loudness of the aerodynamic sound according to y-th power of a value obtained by dividing the representative wind speed by the ear-reaching wind speed.

Accordingly, since the aerodynamic sound data is processed so that the loudness of the aerodynamic sound (second aerodynamic sound) becomes more accurate, the aerodynamic sound (second aerodynamic sound) that listener L hears in the virtual space becomes more similar to the aerodynamic sound (second aerodynamic sound) that listener L hears in the real-world space. Therefore, listener L is even less likely to feel a sense of incongruity and can experience an even greater sense of realism. Stated differently, the acoustic signal processing method is capable of providing listener L with a greater sense of realism.

In the acoustic signal processing method according to Variation 6 of the embodiment, γ and z satisfy the following relation.

$$γ \times z < 4$$

Accordingly, since a more accurate ear-reaching wind speed is calculated, the aerodynamic sound (second aerodynamic sound) that listener L hears in the virtual space becomes more similar to the aerodynamic sound (second aerodynamic sound) that listener L hears in the real-world space. Therefore, listener L is even less likely to feel a sense of incongruity and can experience an even greater sense of realism. Stated differently, the acoustic signal processing method is capable of providing listener L with a greater sense of realism.

The acoustic signal processing method according to Variation 6 of the embodiment includes: obtaining the fourth object audio information and the aerodynamic sound core information output by an information generation method described above, and second position information indicating a position of listener L in the virtual space, the aerodynamic sound core information including data indicating a distribution of frequency components of the aerodynamic sound; calculating, based on the generation position included in the fourth object audio information obtained and the second position information obtained, distance D between the generation position and listener L; processing the aerodynamic sound data to shift the distribution of the frequency components of the aerodynamic sound toward lower frequencies as the calculated distance D increases; and outputting the aerodynamic sound data processed.

With this, in the obtaining, fourth object audio information in which the generation position, the first wind direction, and the first assumed wind speed are associated can be obtained. Accordingly, as the aerodynamic sound data is processed such that the distribution of frequency components of the aerodynamic sound (second aerodynamic sound) shifts toward lower frequencies as distance D between the object and listener L increases, the aerodynamic sound (second aerodynamic sound) that listener L hears in the virtual space becomes similar to the aerodynamic sound (second aerodynamic sound) that listener L hears in the real-world space, and more specifically, becomes a sound that reproduces the aerodynamic sound (second aerodynamic sound) in the real-world space. Therefore, listener L is less likely to feel a sense of incongruity and can experience a sense of realism. Stated differently, the acoustic signal processing method is capable of providing listener L with a sense of realism.

In the acoustic signal processing method according to Variation 6 of the embodiment, the processing includes processing the aerodynamic sound data based on an ear-reaching wind speed, the ear-reaching wind speed being a speed of the first wind upon reaching the ear of listener L, and the ear-reaching wind speed decreases as the calculated distance D increases.

Accordingly, since the aerodynamic sound data is processed based on the ear-reaching wind speed, the aerodynamic sound (second aerodynamic sound) that listener L hears in the virtual space becomes more similar to the aerodynamic sound (second aerodynamic sound) that listener L hears in the real-world space. Therefore, listener L is even less likely to feel a sense of incongruity and can experience an even greater sense of realism. Stated differently, the acoustic signal processing method is capable of providing listener L with a greater sense of realism.

In the acoustic signal processing method according to Variation 6 of the embodiment, the ear-reaching wind speed is a value that attenuates according to the z-th power of the value obtained by dividing the calculated distance D by the unit distance.

Accordingly, since a more accurate ear-reaching wind speed is calculated, the aerodynamic sound (second aerodynamic sound) that listener L hears in the virtual space becomes more similar to the aerodynamic sound (second aerodynamic sound) that listener L hears in the real-world space. Therefore, listener L is even less likely to feel a sense of incongruity and can experience an even greater sense of realism. Stated differently, the acoustic signal processing method is capable of providing listener L with a greater sense of realism.

In the acoustic signal processing method according to Variation 6 of the embodiment, z satisfies the following relation.
z=1

Accordingly, since a more accurate ear-reaching wind speed is calculated, the aerodynamic sound (second aerodynamic sound) that listener L hears in the virtual space becomes more similar to the aerodynamic sound (second aerodynamic sound) that listener L hears in the real-world space. Therefore, listener L is even less likely to feel a sense of incongruity and can experience an even greater sense of realism. Stated differently, the acoustic signal processing method is capable of providing listener L with a greater sense of realism.

In the acoustic signal processing method according to Variation 6 of the embodiment, the processing includes processing the aerodynamic sound data to shift the distribution of the frequency components of the aerodynamic sound to a frequency scaled by a reciprocal of a value obtained by dividing the representative wind speed by the ear-reaching wind speed.

Accordingly, since a more accurate ear-reaching wind speed is calculated, the aerodynamic sound (second aerodynamic sound) that listener L hears in the virtual space becomes more similar to the aerodynamic sound (second aerodynamic sound) that listener L hears in the real-world space. Therefore, listener L is even less likely to feel a sense of incongruity and can experience an even greater sense of realism. Stated differently, the acoustic signal processing method is capable of providing listener L with a greater sense of realism.

The information generation method according to Variation 8 of the embodiment includes: obtaining a second wind direction of a second wind blowing in a virtual space and a second assumed wind speed which is a speed of the second wind; generating fifth object audio information in which the second wind direction and the second assumed wind speed obtained are associated; storing aerodynamic sound core information including a representative wind speed and aerodynamic sound data indicating aerodynamic sound generated by wind blowing at the representative wind speed reaching an ear of listener L in the virtual space; and outputting the fifth object audio information generated and the aerodynamic sound core information stored.

With this, fifth object audio information in which the second wind direction and the second assumed wind speed are associated can be generated. When this fifth object audio information is used in the acoustic signal processing method, it can reproduce wind W (natural wind blowing outdoors) whose source is not fixed, and as the aerodynamic sound data is processed irrespective of the position indicated by the second position information, the aerodynamic sound (second aerodynamic sound) caused by the second wind that listener L hears in the virtual space becomes similar to the aerodynamic sound (second aerodynamic sound) caused by the second wind that listener L hears in the real-world space, and more specifically, becomes a sound that reproduces the aerodynamic sound (second aerodynamic sound) caused by the second wind in the real-world space. Therefore, listener L is less likely to feel a sense of incongruity and can experience a sense of realism. Stated differently, the information generation method is capable of providing listener L with a sense of realism.

The information generation method according to Variation 7 of the embodiment includes: obtaining a generation position of a first wind blowing in a virtual space, a first wind direction of the first wind, a first assumed wind speed which is a speed of the first wind, a second wind direction of a second wind blowing in the virtual space, and a second assumed wind speed which is a speed of the second wind; generating fourth object audio information in which the generation position, the first wind direction, and the first assumed wind speed obtained are associated, and generating fifth object audio information in which the second wind direction and the second assumed wind speed obtained are associated; and outputting the fourth object audio information generated and the fifth object audio information generated.

With this, fourth object audio information in which the generation position, the first wind direction, and the first assumed wind speed are associated, and fifth object audio information in which the second wind direction and the second assumed wind speed are associated can be generated, thereby enabling the generation of two types of wind in the same virtual space: wind W whose source can be identified (such as electric fan F, exhaust vents, wind holes, etc.) and wind W whose source cannot be identified (such as naturally occurring breezes, storms, etc.). Furthermore, when this fourth object audio information is used in the acoustic signal processing method, as the aerodynamic sound data is processed based on the position indicated by the second position information, the aerodynamic sound (second aerodynamic sound) caused by the first wind that listener L hears in the virtual space becomes similar to the aerodynamic sound (second aerodynamic sound) caused by the first wind that listener L hears in the real-world space, and more specifically, becomes a sound that reproduces the aerodynamic sound (second aerodynamic sound) caused by the first wind in the real-world space. Furthermore, when this fifth object audio information is used in the acoustic signal processing method, as the aerodynamic sound data is processed irrespective of the position indicated by the second position information, the aerodynamic sound (second aerodynamic sound) caused by the second wind that listener L hears in the virtual space becomes similar to the aerodynamic sound (second aerodynamic sound) caused by the second wind that listener L hears in the real-world space, and more specifically, becomes a sound that reproduces the aerodynamic sound (second aerodynamic sound) caused by the second wind in the real-world space. Therefore, listener L is less likely to feel a sense of incongruity and can experience a sense of realism. Stated differently, the information generation method is capable of providing listener L with a sense of realism.

In the information generation method according to Variation 7 of the embodiment, in the outputting, the fourth object audio information generated is output when the generation position of the first wind is in the virtual space.

With this, the information generation method can determine whether or not to output the fourth object audio information based on the generation position.

In the information generation method according to Variation 7 of the embodiment, in the outputting, the fifth object audio information generated is output when the generation position of the first wind is not in the virtual space.

With this, the information generation method can determine whether or not to output the fifth object audio information based on the generation position.

The information generation method according to Variation 7 of the embodiment includes: storing aerodynamic sound core information including a representative wind speed and aerodynamic sound data indicating aerodynamic sound generated by wind blowing at the representative wind speed reaching an ear of listener L in the virtual space, wherein the outputting includes outputting the aerodynamic sound core information stored.

Accordingly, when the aerodynamic sound data included in the output aerodynamic sound core information is used in the acoustic signal processing method, the aerodynamic sound core information can be commonly applied to the first wind and the second wind, thereby reducing the memory footprint for storing the aerodynamic sound core information. Moreover, the aerodynamic sound (second aerodynamic sound) caused by the first wind that listener L hears in the virtual space becomes similar to the aerodynamic sound (second aerodynamic sound) caused by the first wind that listener L hears in the real-world space, and the aerodynamic sound (second aerodynamic sound) caused by the second wind that listener L hears in the virtual space becomes similar to the aerodynamic sound (second aerodynamic sound) caused by the second wind that listener L hears in the real-world space. Therefore, listener L is less likely to feel a sense of incongruity and can experience a sense of realism. Stated differently, the information generation method is capable of providing listener L with a sense of realism.

The information generation method according to Variation 7 of the embodiment further includes: displaying an image in which wind speeds are associated with words expressing the wind speeds; and receiving, as the first assumed wind speed, a first operation specifying a wind speed included in the wind speeds indicated in the image displayed, and receiving, as the second assumed wind speed, a second operation specifying a wind speed included in the wind speeds indicated in the image displayed.

With this, the wind speed specified by the user can be utilized as the first assumed wind speed, and the wind speed specified by the user can be utilized as the second assumed wind speed.

The acoustic signal processing method according to Variation 7 of the embodiment includes: obtaining second position information indicating a position of listener L in the virtual space, and the fourth object audio information or the fifth object audio information output by an information generation method described above; when the fourth object audio information is obtained, processing the aerodynamic sound data included in the aerodynamic sound core information based on the position indicated by the second position information obtained, and when the fifth object audio information is obtained, processing the aerodynamic sound data included in the aerodynamic sound core information irrespective of the position indicated by the second position information obtained; and outputting the aerodynamic sound data processed.

With this, in the obtaining, fourth object audio information or fifth object audio information can be obtained. Accordingly, as the aerodynamic sound data is processed based on the position indicated by the second position information, the aerodynamic sound (second aerodynamic sound) caused by the first wind that listener L hears in the virtual space becomes similar to the aerodynamic sound (second aerodynamic sound) caused by the first wind that listener L hears in the real-world space, and more specifically, becomes a sound that reproduces the aerodynamic sound (second aerodynamic sound) caused by the first wind in the real-world space. Furthermore, as the aerodynamic sound data is processed irrespective of the position indicated by the second position information, the aerodynamic sound (second aerodynamic sound) caused by the second wind that listener L hears in the virtual space becomes similar to the aerodynamic sound (second aerodynamic sound) caused by the second wind that listener L hears in the real-world space, and more specifically, becomes a sound that reproduces the aerodynamic sound (second aerodynamic sound) caused by the second wind in the real-world space. Therefore, listener L is less likely to feel a sense of incongruity and can experience a sense of realism. Stated differently, the acoustic signal processing method is capable of providing listener L with a sense of realism.

The computer program according to the present embodiment and Variations 1 to 8 is for causing a computer to execute an acoustic signal processing method described above.

Accordingly, the computer can execute the acoustic signal processing method described above in accordance with the computer program.

The computer program according to the present embodiment and Variations 1 to 8 is for causing a computer to execute an information generation method described above.

Accordingly, the computer can execute the information generation method described above in accordance with the computer program.

Acoustic signal processing device 100 according to the present embodiment includes: first obtainer 110 that obtains object information and second position information, the object information including first position information indicating a position of an object in a virtual space, first sound data indicating a first sound caused by the object, and first identification information indicating a processing method for the first sound data, the second position information indicating a position of listener L of the first sound in the virtual space; first calculator 120 that calculates distance D between the object and listener L based on the first position information included in the object information obtained and the second position information obtained; determiner 130 that determines, based on the first identification information included in the object information obtained, a processing method among a first processing method and a second processing method to use to process the first sound data, the first processing method for processing a loudness according to distance D calculated, the second processing method for processing the loudness according to distance D calculated in a manner different from the first processing method; first processor 140 that processes the first sound data using the processing method determined; and first outputter 150 that outputs the first sound data processed.

Accordingly, since the processing method for the loudness of the first sound can be changed according to the first identification information, the first sound that listener L hears in the virtual space becomes similar to the first sound that listener L hears in the real-world space, and more specifically, becomes a sound that reproduces the first sound in the real-world space. Therefore, listener L is less likely to feel a sense of incongruity and can experience a sense of realism. Stated differently, acoustic signal processing device 100 is capable of providing listener L with a sense of realism.

### Other Embodiments

While acoustic signal processing method, acoustic signal processing device, information generation method, and information generation device according to the present disclosure have been described above based on embodiments and variations, the present disclosure is not limited to these embodiments and variations. For example, other embodiments resulting from freely combining the elements described in the present specification or excluding some of the elements may be included as embodiments of the present disclosure. The present disclosure also encompasses variations that result from applying, to the embodiments and variations, various modifications that may be conceived by those skilled in the art without departing from the spirit of the present disclosure, that is, within a range that does not depart from the scope of the language of the claims.

The information generation method according to a fiftieth aspect of the present disclosure includes: obtaining a generation position of a first wind blowing in a virtual space, a first wind direction of the first wind, a first assumed wind speed which is a speed of the first wind, a second wind direction of a second wind blowing in the virtual space, and a second assumed wind speed which is a speed of the second wind; generating fourth object audio information in which the generation position, the first wind direction, and the first assumed wind speed obtained are associated, and generating fifth object audio information in which the second wind direction and the second assumed wind speed obtained are associated; and determining which of the fourth object audio information and the fifth object audio information generated in the generating to output based on at least one of the generation position, the first wind direction, the first assumed wind speed, the second wind direction, and the second assumed wind speed obtained in the obtaining.

For example, the information generation method according to a fifty-first aspect of the present disclosure is the information generation method according to the fiftieth aspect, wherein the determining includes determining which of the fourth object audio information or the fifth object audio information generated in the generating to output according to the generation position of the first wind, and the information generation method further includes outputting the object audio information determined.

For example, the information generation method according to a fifty-second aspect of the present disclosure is the information generation method according to the fifty-first aspect, wherein the determining includes determining to output the fourth object audio information generated when the generation position of the first wind is in the virtual space, and in the outputting, the fourth object audio information is output.

For example, the information generation method according to a fifty-third aspect of the present disclosure is the information generation method according to the fiftieth aspect, wherein the determining includes determining not to output the fourth object audio information generated when the generation position of the first wind is not in the virtual space.

For example, the information generation method according to a fifty-fourth aspect of the present disclosure is the information generation method according to the fiftieth aspect, wherein the determining includes determining not to output either the fourth object audio information or the fifth object audio information generated in the generating when the generation position of the first wind is not in the virtual space.

For example, the information generation method according to a fifty-fifth aspect of the present disclosure is the information generation method according to the fifty-first aspect, wherein the determining includes determining to output the fifth object audio information generated when the generation position of the first wind is not in the virtual space, and in the outputting, the fifth object audio information is output.

The embodiments shown below may be included in the scope of one or more aspects of the present disclosure.

(1) One or more of the elements included in the acoustic signal processing device and the information generation device may be a computer system that includes a microprocessor, a ROM, a random access memory (RAM), a hard disk unit, a display unit, a keyboard, and a mouse, for instance. A computer program is stored in the RAM or the hard disk unit. The microprocessor achieves its functionality by operating in accordance with the computer program. Here, the computer program includes a combination of instruction codes indicating instructions to a computer in order to achieve predetermined functionality.

(2) One or more of the elements included in the acoustic signal processing device and the information generation device described above may include a single system large scale integration (LSI) circuit. A system LSI circuit is ultra-multifunctional LSI circuit manufactured by integrating a plurality of processing units on a single chip, and specifically, is a computer system including a microprocessor, ROM, RAM and the like. The RAM stores a computer program. The microprocessor operates according to the computer program, thereby enabling the system LSI circuit to achieve its functionality.

(3) One or more of elements included in the acoustic signal processing device and the information generation device described above may include an IC card or a standalone module which can be attached to or detached from the device. The IC card or the module is a computer system including a microprocessor, ROM, RAM, and any other suitable elements. The IC card or the module may be included in the above-described ultra-multifunctional LSI circuit. The IC card or the module achieves its functionality by the microprocessor operating in accordance with the computer program. The IC card or the module may be tamper resistant.

(4) One or more of the elements of the acoustic signal processing device and the information generation device described above may be a computer program or digital signal stored on a non-transitory computer-readable recording medium, examples of which include a flexible disk, a hard disk, a CD-ROM, an MO, a DVD, a DVD-ROM, a DVD-RAM, a Blu-ray (registered trademark) disc (BD), semiconductor memory, and other media. Alternatively, one or more of the elements may be realized as a digital signal stored in such a recording medium.

One or more of the elements of the acoustic signal processing device and the information generation device described above may be realized by transmitting the computer program or digital signal over an electrical communication line, a wireless or wired communication line, a network typified by the Internet, or via data broadcasting, for instance.

(5) The present disclosure may be a method described above. The present disclosure may be a computer program that realizes such a method using a computer or a digital signal that includes the computer program.

(6) The present disclosure may be a computer system that includes a microprocessor and memory, the memory may store the computer program, and the microprocessor may operate in accordance with the computer program.

(7) The present disclosure may be implemented by another independent computer system by recording the program or the digital signal on the recording medium and transferring it, or by transferring the program or the digital signal via the network or the like.

### INDUSTRIAL APPLICABILITY

The present disclosure is applicable to an acoustic signal processing method, an acoustic signal processing device, an information generation method, and an information generation device, and is particularly applicable to acoustic systems and the like.

1. An information generation method comprising:
obtaining a second wind direction of a second wind blowing in a virtual space and a second assumed wind speed which is a speed of the second wind;
generating fifth object audio information in which the second wind direction and the second assumed wind speed obtained are associated;
storing aerodynamic sound core information including a representative wind speed and aerodynamic sound data indicating aerodynamic sound generated by wind blowing at the representative wind speed reaching an ear of a listener in the virtual space; and
outputting the fifth object audio information generated and the aerodynamic sound core information stored.

2. An information generation method comprising:
obtaining a generation position of a first wind blowing in a virtual space, a first wind direction of the first wind, a first assumed wind speed which is a speed of the first wind, a second wind direction of a second wind blowing in the virtual space, and a second assumed wind speed which is a speed of the second wind;
generating fourth object audio information in which the generation position, the first wind direction, and the first assumed wind speed obtained are associated, and generating fifth object audio information in which the second wind direction and the second assumed wind speed obtained are associated; and
outputting the fourth object audio information generated and the fifth object audio information generated.

3. The information generation method according to claim 2, wherein
in the outputting, the fourth object audio information generated is output when the generation position of the first wind is in the virtual space.

4. The information generation method according to claim 3, wherein
in the outputting, the fifth object audio information generated is output when the generation position of the first wind is not in the virtual space.

5. The information generation method according to claim 2, further comprising:
storing aerodynamic sound core information including a representative wind speed and aerodynamic sound data indicating aerodynamic sound generated by wind blowing at the representative wind speed reaching an ear of a listener in the virtual space, wherein
the outputting includes outputting the aerodynamic sound core information stored.

6. The information generation method according to claim 5, further comprising:
displaying an image in which wind speeds are associated with words expressing the wind speeds; and
receiving, as the first assumed wind speed, a first operation specifying a wind speed included in the wind speeds indicated in the image displayed, and receiving, as the second assumed wind speed, a second operation specifying a wind speed included in the wind speeds indicated in the image displayed.

7. An acoustic signal processing method comprising:
obtaining second position information indicating a position of the listener in the virtual space, and the fourth object audio information or the fifth object audio information output by the information generation method according to claim 5;
when the fourth object audio information is obtained, processing the aerodynamic sound data included in the aerodynamic sound core information based on the position indicated by the second position information obtained, and when the fifth object audio information is obtained, processing the aerodynamic sound data included in the aerodynamic sound core information irrespective of the position indicated by the second position information obtained; and
outputting the aerodynamic sound data processed.

8. An information generation device comprising:
a sixth obtainer that obtains a second wind direction of a second wind blowing in a virtual space and a second assumed wind speed which is a speed of the second wind;
a third generator that generates fifth object audio information in which the second wind direction and the second assumed wind speed obtained are associated;
storage that stores aerodynamic sound core information including a representative wind speed and aerodynamic sound data indicating aerodynamic sound generated by wind blowing at the representative wind speed reaching an ear of a listener in the virtual space; and
a fifth outputter that outputs the fifth object audio information generated and the aerodynamic sound core information stored.

9. A non-transitory computer-readable recording medium for use in a computer, the recording medium having recorded thereon a computer program for causing the computer to execute the information generation method according to claim 1.
